(19) United States
(12) Patent Application Publication
(10) Pub. No.: US 2026/0002361 A1
(43) Pub. Date: Jan. 1, 2026

(54) ORGANIC COMPOSITE INSULATED WALLS AND ROOF MEMBERS

(71) Applicant: NUtech Ventures, Lincoln, NE (US)

(72) Inventors: Joel Foderberg, Edwards, CO (US); Marc Maguire, Lincoln, NE (US); Davis Foderberg, Edwards, CO (US)

(21) Appl. No.: 19/179,622

(22) Filed: Apr. 15, 2025

Related U.S. Application Data
(63) Continuation-in-part of application No. 18/959,185, filed on Nov. 25, 2024.
(60) Provisional application No. 63/605,278, filed on Dec. 1, 2023.
(60) Provisional application No. 63/549,952, filed on Feb. 5, 2024.

(51) Int. Cl. E04C 2/288; B32B 3/08; B32B 7/022; B32B 7/027; B32B 13/02; B32B 13/04; E04B 2/00; E04B 5/02; E04C 2/04

(52) U.S. Cl. CPC E04C 2/288; B32B 3/08; B32B 7/022; B32B 7/027; B32B 13/02; B32B 13/04; E04C 2/044; E04C 2/46; E04C 2/50; B32B 2307/304; B32B 2307/54; B32B 2607/00

(57) ABSTRACT

A composite panel may be a three-layer composite panel including a bottom concrete layer, a middle insulation layer, and a top concrete layer. The middle insulation layer may include an insulation material which is selected to insulate the bottom concrete layer from the top concrete layer. The insulation material may include organic materials to reduce or eliminate the carbon footprint of the composite panel. The composite panel may include trusses which connect between the bottom concrete layer and top concrete layer through the middle insulation layer. The trusses may include resin blocks to provide a thermal discontinuity within the trusses.

### CROSS-REFERENCE TO RELATED APPLICATIONS

The present application is a continuation-in-part of and claims the benefit under 35 U.S.C. § 120 of U.S. Nonprovisional application Ser. No. 18/959,185, filed Nov. 25, 2024, titled “ORGANIC COMPOSITE INSULATED WALLS AND ROOF MEMBERS”, said U.S. Nonprovisional application Ser. No. 18/959,185 claims the benefit under 35 U.S.C. § 119(e) of U.S. Provisional Application Ser. No. 63/605,278, filed Dec. 1, 2023, titled “ORGANIC COMPOSITE INSULATED WALLS AND ROOF MEMBERS”, and U.S. Provisional Application Ser. No. 63/549,952, filed Feb. 5, 2024, titled “ORGANIC COMPOSITE INSULATED WALLS AND ROOF MEMBERS”, which are incorporated herein by reference in the entirety.

### TECHNICAL FIELD

The present invention generally relates to the field of elements of relatively thin form for the construction of parts of buildings, and more specifically to sheet materials, slabs, or panels.

### BACKGROUND

Insulated concrete walls are rapidly gaining popularity. The insulated concrete walls have superior insulation capabilities when compared to other wall systems. Fabrication of these systems is currently highly customized and labor intensive. The rigid insulation materials that are normally used (e.g., expanded polystyrene (EPS), extruded polystyrene (XPS), polyisocyanurate (POLYISO), etc.) require labor to prepare and their fabrication process is harmful to the environment due to chemical blowing agents and energy use. Insulated concrete walls, floor and roof members are sustainable but not generally considered environmentally friendly.

Glass-fiber reinforced parts are often used in truss members of composite panels to make the truss members thermally non-conductive. As the size of the glass-fiber reinforced parts increases, expenses and complications associated with the parts increase, leading to parts not being scalable. Demand for composite panel in the residential and commercial construction industry are driven by new building codes to have better insulated buildings necessitating a thermally nonconductive connector. Therefore, it would be advantageous to provide a device, system, and method that cures the shortcomings described above.

### SUMMARY

A composite panel is described, in accordance with one or more embodiments of the present disclosure. The composite panel may include a bottom concrete layer, a middle insulation layer, a top concrete layer, and a plurality of trusses. The plurality of trusses may include a plurality of longitudinal reinforcement members. The plurality of longitudinal reinforcement members may be disposed in the bottom concrete layer and the top concrete layer. The plurality of trusses may include a plurality of bisected truss webs and a plurality of resin blocks. The plurality of resin blocks may join the plurality of bisected truss webs.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A depicts a perspective view of a composite panel, in accordance with one or more embodiments of the present disclosure.

FIG. 1B depicts a perspective view of the composite panel with a top concrete layer and a middle insulation layer which are hidden to illustrate trusses of the composite panel, in accordance with one or more embodiments of the present disclosure.

FIGS. 1C-1D depict a partial cross-section view of a longitudinal span of the composite panel, in accordance with one or more embodiments of the present disclosure.

FIG. 1E depicts a cross-section view of a longitudinal span of the composite panel, in accordance with one or more embodiments of the present disclosure.

FIG. 2 depicts a perspective view of a truss of the composite panel including a continuous truss web, in accordance with one or more embodiments of the present disclosure.

FIGS. 3A-3B depict perspective views of the truss of the composite panel including an open-looped segmented truss web, in accordance with one or more embodiments of the present disclosure.

FIGS. 3C-3D depict a front view of an open-looped segmented truss web, in accordance with one or more embodiments of the present disclosure.

FIG. 4A depicts a perspective view of the truss of the composite panel including a double-looped segmented truss web, in accordance with one or more embodiments of the present disclosure.

FIGS. 4B-4E depict a front view of a double-looped segment of a double-looped segmented truss web, in accordance with one or more embodiments of the present disclosure.

FIGS. 5-6 depict a partial cross-section view of a width of the composite panel including a double-ended hook joint, in accordance with one or more embodiments of the present disclosure.

FIG. 7A depict a partial cross-section view of a longitudinal span of the composite panel including a truss lock joint, in accordance with one or more embodiments of the present disclosure.

FIG. 7B depict a partial cross-section view of FIG. 7A, in accordance with one or more embodiments of the present disclosure.

FIG. 8A depict a partial cross-section view of a longitudinal span of the composite panel including a hanger lock joint, in accordance with one or more embodiments of the present disclosure.

FIGS. 8B-8D depict a partial cross-section view of a width of the composite panel including a hanger lock joint, in accordance with one or more embodiments of the present disclosure.

FIG. 8E depicts a side view of a hub of a hanger lock joint, in accordance with one or more embodiments of the present disclosure.

FIG. 9A depicts a partial side view of a longitudinal span of the composite panel including a double-ended hook lock joint, in accordance with one or more embodiments of the present disclosure.

FIG. 9B depicts a partial cross-section view of a width of the composite panel including a double-ended hook lock joint, in accordance with one or more embodiments of the present disclosure.

FIG. 9C depicts a top view a double-ended hook lock joint, in accordance with one or more embodiments of the present disclosure.

FIG. 10 depicts a partial cross-section view of a width of the composite panel including a middle insulation layer defining a void space, in accordance with one or more embodiments of the present disclosure.

FIG. 11 depicts a partial cross-section view of a width of the composite panel including an embed plate and headed studs, in accordance with one or more embodiments of the present disclosure.

FIG. 12A depicts an elevation view of a system including composite panels, windows, doors, fasteners, and frames, in accordance with one or more embodiments of the present disclosure.

FIGS. 12B-12D depict a cross-section views of FIG. 12A, in accordance with one or more embodiments of the present disclosure.

FIGS. 13A-13B depict a cross-section view of corner joints of composite panels which are orthogonal, in accordance with one or more embodiments of the present disclosure.

FIG. 14 depicts a cross-section view of corner joints of composite panels which are coincident, in accordance with one or more embodiments of the present disclosure.

FIG. 15 depicts a flow diagram of a method, in accordance with one or more embodiments of the present disclosure.

FIGS. 16A-16B depict extruding a bottom concrete layer, in accordance with one or more embodiments of the present disclosure.

FIG. 16C depicts extruding a middle insulation layer, in accordance with one or more embodiments of the present disclosure.

FIG. 16D depicts extruding a top concrete layer, in accordance with one or more embodiments of the present disclosure.

FIG. 17A depicts a perspective view of the composite panel with a top concrete layer and a middle insulation layer which are hidden to illustrate trusses of the composite panel, in accordance with one or more embodiments of the present disclosure.

FIG. 17B depicts a depicts a perspective view of the truss, in accordance with one or more embodiments of the present disclosure.

FIG. 18 depicts a perspective view of the composite panel, in accordance with one or more embodiments of the present disclosure.

FIG. 19A depicts a top plan view of the composite panel, in accordance with one or more embodiments of the present disclosure.

FIG. 19B depicts a cross-section view of the longitudinal span of the composite panel, in accordance with one or more embodiments of the present disclosure.

FIG. 19C depicts a partial cross-section view taken from the dashed lines of FIG. 19B, in accordance with one or more embodiments of the present disclosure.

FIGS. 20A-20J depicts a partial side view of end sections of segments of the truss embedded within resin blocks of the composite panel, in accordance with one or more embodiments of the present disclosure.

FIG. 21A depicts a top plan view of the composite panel, in accordance with one or more embodiments of the present disclosure.

FIG. 21B depicts a cross-section view of the longitudinal span of the composite panel, in accordance with one or more embodiments of the present disclosure.

FIG. 21C depicts a partial cross-section view taken from the dashed lines of FIG. 21B, in accordance with one or more embodiments of the present disclosure.

FIGS. 21D-21E depict partial side views of loop sections of the truss embedded within resin blocks of the composite panel, in accordance with one or more embodiments of the present disclosure.

FIG. 22A depicts a cross-section view of the longitudinal span of the composite panel, in accordance with one or more embodiments of the present disclosure.

FIG. 22B depicts a partial cross-section view taken from the dashed lines of FIG. 22A, in accordance with one or more embodiments of the present disclosure.

FIG. 23-25 depict partial cross-section views of the longitudinal span of the composite panel, in accordance with one or more embodiments of the present disclosure.

FIG. 26 depicts a flow diagram of a method of manufacturing the composite panel, in accordance with one or more embodiments of the present disclosure.

FIGS. 27A-27C depict one or more steps of the method of FIG. 26, in accordance with one or more embodiments of the present disclosure.

### DETAILED DESCRIPTION OF THE INVENTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are generally directed to a composite panel. The composite panel may be a three-layer composite panel including a bottom concrete layer, a middle insulation layer, and a top concrete layer. The middle insulation layer may include an insulation material which is selected to insulate the bottom concrete layer from the top concrete layer. The insulation material may include organic materials to reduce or eliminate the carbon footprint of the composite panel. The composite panel may include trusses which connect between the bottom concrete layer and top concrete layer through the middle insulation layer. The trusses may include resin blocks to provide a thermal discontinuity within the trusses.

U.S. Pat. No. 10,309,105B2, titled “System for insulated concrete composite wall panels”; U.S. Pat. No. 9,493,946B2, titled “Tie system for insulated concrete panels”; U.S. Patent Publication No. US20150167303A1, titled “Tie system for insulated concrete panels”; U.S. Pat. No. 6,837,013B2, titled “Lightweight precast concrete wall panel system”; U.S. Patent Publication No. US20230047807A1, titled “Hemp based geopolymer compositions and methods of use thereof”; are each incorporated herein by reference in the entirety.

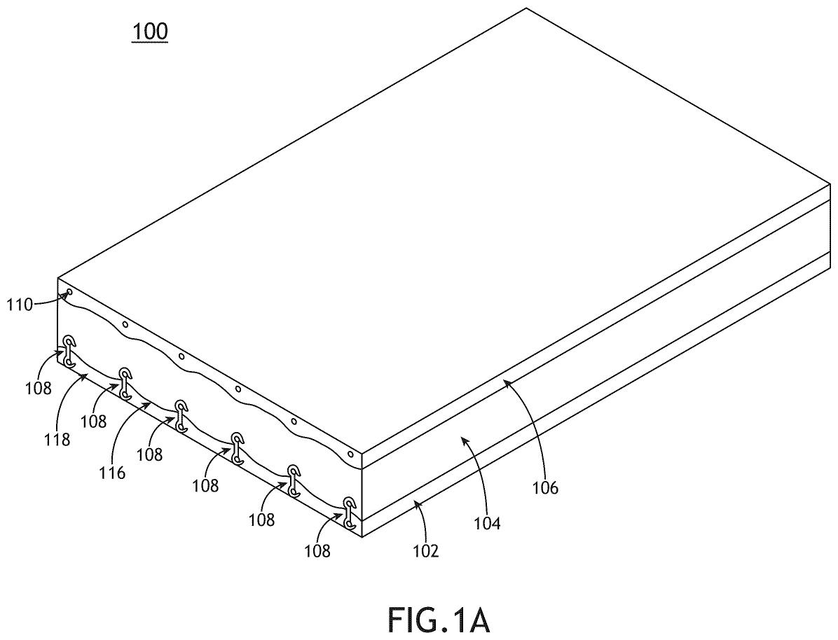

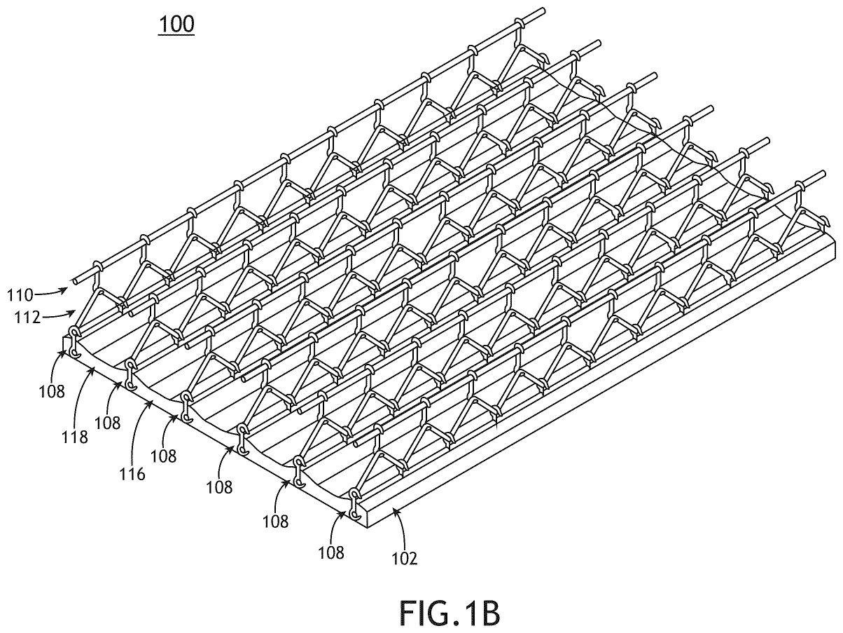

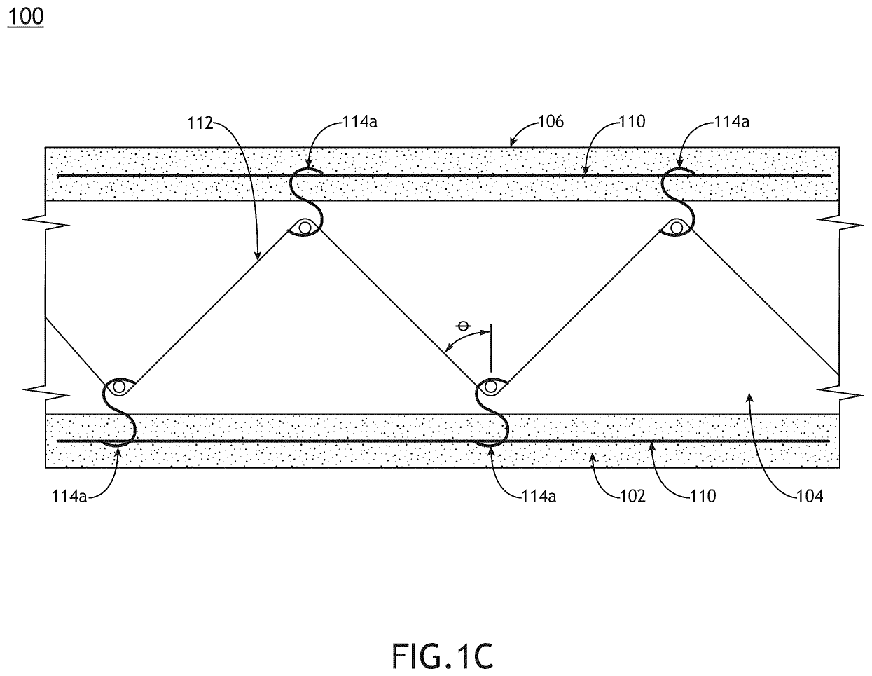

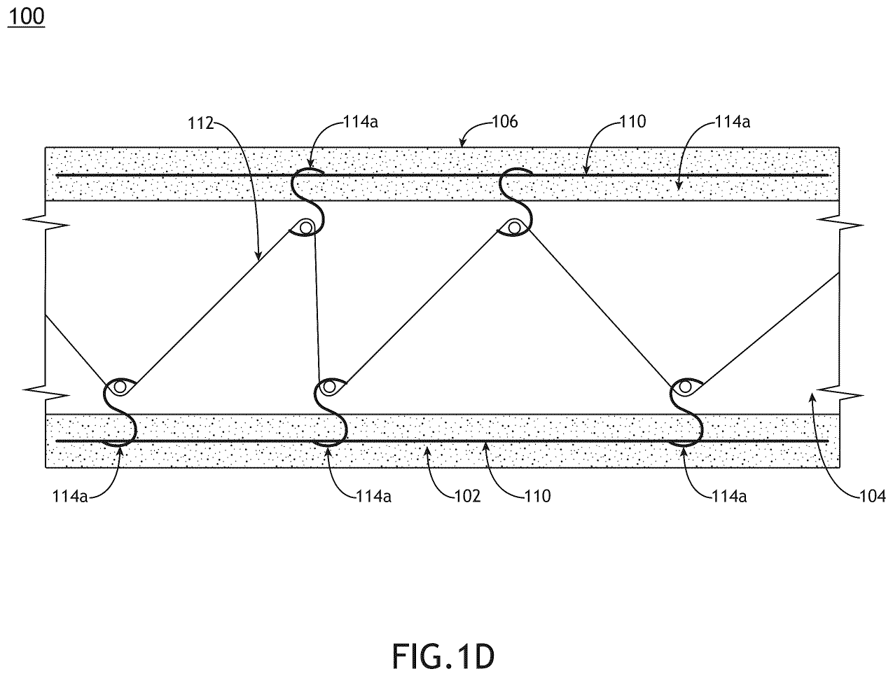

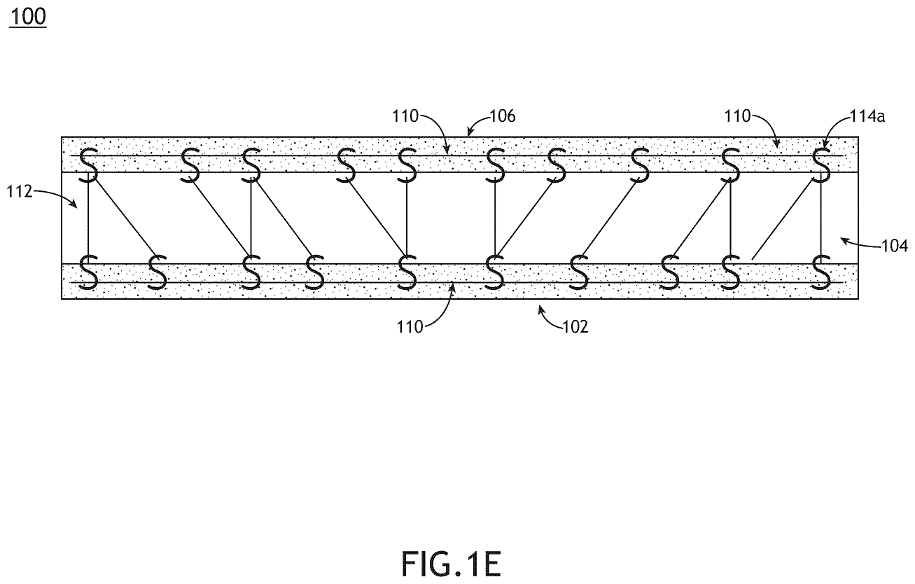

FIGS. 1A-11, depict a composite panel 100, in accordance with one or more embodiments of the present disclosure. The composite panel 100 may be structural or non-structural. The composite panel 100 may include a bottom concrete layer 102, middle insulation layer 104, top concrete layer 106, and/or trusses 108. The bottom concrete layer 102, the middle insulation layer 104, the top concrete layer 106, and/or the trusses 108 may extend along the longitudinal span of the composite panel 100.

The composite panel 100 may be a three-layer composite panel. For example, the composite panel 100 may include the bottom concrete layer 102, middle insulation layer 104, and top concrete layer 106. The bottom concrete layer 102, middle insulation layer 104, and top concrete layer 106 may be collectively referred to as the layers. The layers may be described in the order that the layers may be manufactured. The middle insulation layer 104 may be disposed between the bottom concrete layer 102 and the top concrete layer 106.

It is contemplated that the composite panel 100 may be used in several orientations, such as, but not limited to, a horizontal orientation, a vertical orientation, or an orientation therebetween. The bottom concrete layer 102 and top concrete layer 106 may also be outside concrete layers and/or wythes. The composite panel 100 may be a composite member, a composite slab panel, a composite wall panel, a composite roof slab, slab-on-grade, suspended slabs, or any other flat element. The bottom concrete layer 102 and top concrete layer 106 may be used as the outside and inside of the composite wall panel, respectively, but could also be used as the inside and outside of the composite wall panel, respectively. The bottom concrete layer 102 and top concrete layer 106 of a composite slab panel or composite roof panel may be used as the bottom of the composite slab panel or composite roof panel, respectively.

The bottom concrete layer 102 and top concrete layer 106 may be made of a concrete material. The concrete material may include a zero- or low-slump concrete. The concrete material may be able to be slip formed or extruded. The concrete material may include a composition of cements, water, aggregates, admixtures, and the like. The composition of the concrete material may be based on a mix design and is not intended to be limiting. Technologies to reduce a carbon footprint of the concrete material may be employed, such as, but not limited to, recycled supplementary cementitious materials or other carbon capturing/reduction methods. The concrete material may include other properties that increases the sustainability of the concrete material, such as, but not limited to, the inclusion of waste products (fly ash, slag, etc.) or other carbon capturing methods to increase sustainability.

The bottom surface of the bottom concrete layer 102 and the top surface of the top concrete layer 106 may be flat. For example, the bottom surface of the bottom concrete layer 102 and the top surface of the top concrete layer 106 may be planar with a smooth or even surface. The planar surfaces may be oriented horizontal, angled, or vertical relative to ground, depending upon the orientation of the composite panel 100.

The top surface of the bottom concrete layer 102 and the bottom surface of the top concrete layer 106 may include ridge portions 116 and/or ditch portions 118. The ridge portions 116 and/or the ditch portions 118 may extend along the longitudinal span (e.g., a length) of the composite panel 100. The ditch portions 118 may connect between the ridge portions 116. For example, the ditch portions 118 may span between of the ridge portions 116 along the width.

The bottom concrete layer 102 and the top concrete layer 106 may be thicker along the ridge portions 116 than along the ditch portions 118. The bottom concrete layer 102 may include bottom thicknesses defined by the thickness between the ridge portions 116 and/or the ditch portions 118 and the bottom surface of the bottom concrete layer 102. For example, a first bottom thickness of the bottom concrete layer 102 between the ridge portions 116 and the bottom surface of the bottom concrete layer 102 may be more than a second bottom thickness of the bottom concrete layer 102 between the ditch portions 118 and the bottom surface of the bottom concrete layer 102. The top concrete layer 106 may include top thicknesses defined by the thickness between the ridge portions 116 and/or the ditch portions 118 and the top surface of the top concrete layer 106. A first top thickness of the top concrete layer 106 between the ridge portions 116 and the top surface of the top concrete layer 106 may be more than a second top thickness of the top concrete layer 106 between the ditch portions 118 and the top surface of the bottom concrete layer 102.

The bottom thicknesses of the bottom concrete layer 102 and the top thicknesses of the top concrete layer 106 may be a same thickness or different thicknesses. It is further contemplated that the bottom thicknesses and/or top thicknesses may be thicker and/or thinner. For example, the bottom thicknesses and/or top thicknesses may be thicker and/or thinner to accommodate embedded items, create camber in the composite panel 100, and the like.

The bottom concrete layer 102 and top concrete layer 106 may include a linear array of the ridge portions 116 and/or the ditch portions 118 along the width of the composite panel 100. The ridge portions 116 of the bottom concrete layer 102 may align with the ridge portions 116 of the top concrete layer 106. Similarly, the ditch portions 118 of the bottom concrete layer 102 may align with the ditch portions 118 of the top concrete layer 106.

The ditch portions 118 may include a select shape. For example, the ditch portions may include a flat shape, a round shape (e.g., concave), a polygon shape (e.g., isosceles trapezoid), or a combination of arc shapes and polygon shapes. The ditch portions 118 of the bottom concrete layer 102 may or may not be the same shape as the ditch portions 118 of the top concrete layer 106.

The middle insulation layer 104 may be disposed between the bottom concrete layer 102 and the top concrete layer 106. For example, the middle insulation layer 104 may be disposed between the ridge portions 116 and/or the ditch portions 118 of the bottom concrete layer 102 and the ridge portions 116 and/or the ditch portions 118 of the top concrete layer 106. The middle insulation layer 104 may fill the space between the bottom concrete layer 102 and top concrete layer 106. For example, the middle insulation layer 104 may abut the top surface of the bottom concrete layer 102 and the bottom surface of the top concrete layer 106. For instance, the middle insulation layer 104 may abut the ridge portions 116 and the ditch portions 118 of the bottom concrete layer 102 and top concrete layer 106.

A density of the middle insulation layer 104 may be less than densities of the bottom concrete layer 102 and/or the top concrete layer 106. In this regard, the middle insulation layer 104 may serve to reduce a weight of the composite panel 100.

The middle insulation layer 104 may be made of an insulation material. The insulation material may be slip formed (i.e., flowable during forming), but not slump or sag while curing. The insulation material may include a hemp-based insulation material, an aerated zero-slump concrete, a cellular concrete, a pervious concrete, a Styrofoam aggregate concrete, or the like. For example, the hemp-based insulation material may include hempcrete. The hempcrete of the middle insulation layer 104 may be zero-slump hempcrete. The hempcrete may be beneficial to reduce carbon emissions produced when manufacturing the composite panel 100. For example, the hempcrete may cause the composite panel 100 to be carbon neutral and/or carbon negative.

The composition of the insulation material may include granular materials with insulating properties bonded together with a cementitious or polymer binder material formed and compressed in the extrusion process. The insulation material may be organic or non-organic. The insulation material may be a waste by-product or a virgin material. The granular materials may include, but are not limited to, hemp hurds, rice husks, hay straw, waste or virgin foam pieces, foam beads (e.g., polystyrene foam beams), or other similar materials. In embodiments, the granular materials may include hemp hurds (also called shiv or shive) which is the woody part of the hemp plant. The hemp hurds may not easily decompose in mineral binder, may have a good compressive strength, and may be used in various iterations of hempcrete. The cementitious material may include Portland cement, calcium sulfoaluminate (CSA), fly ash, lime, gypsum, geopolymer, alkali-activated polymer, acid activated polymer or a combination of these and other materials. The cementitious material may be cured to bind the granular materials (e.g., hemp hurds). The composition of the insulation material may be based on a mix design and is not intended to be limiting. The insulation material may include a limited use of Portland cement along with the possibility of the use of organic material (like hemp), may allow the potential for carbon reduction, carbon neutral, or even carbon negative members. The insulative material may dictate the amount of carbon reduction. The composite panels 100 may be considered organic composite panels when the insulation material includes the organic material.

The middle insulation layer 104 may insulate the bottom concrete layer 102 from the top concrete layer 106. In this regard, the composite panel 100 may be an insulated panel. For example, the middle insulation layer 104 may insulate the bottom concrete layer 102 from transferring heat, sound, and the like to the top concrete layer 106. The insulation material may define the R-value per unit length of the middle insulation layer 104. The middle insulation layer 104 may include a select R-value per unit length. For example, the insulation material may include an R-value per unit length of between 0.67 and 1.2 per cm, where the insulation material is hempcrete. The R-value per unit length of the middle insulation layer 104 may be higher than the R-value per unit length of the concrete material. In this regard, the middle insulation layer 104 may insulate the bottom concrete layer 102 from the top concrete layer 106. The R-value per unit length of the middle insulation layer 104 may be more than the R-values per unit length of the bottom concrete layer 102 and/or the top concrete layer 106.

The insulation material may define the compressive strength of the middle insulation layer 104. The middle insulation layer 104 may have a select compressive strength. For example, the middle insulation layer 104 may have a compressive strength of 0.069 MPa (e.g., 10 psi) or greater. For example, the middle insulation layer 104 may have a compressive strength of between 0.069 and 25 MPa. The compressive strength of the middle insulation layer 104 may be less than the compressive strengths of the bottom concrete layer 102 and/or the top concrete layer 106. The middle insulation layer 104 may reduce a weight of the composite panel 100, as compared to using concrete materials between the bottom concrete layer 102 and the top concrete layer 106. However, reducing the weight of the composite panel 100 may come at the cost of the reduced compressive strength. One challenge with the use of hempcrete or other insulation materials is the reduced compressive strength of the composite panel 100.

The middle insulation layer 104 may be disposed between the bottom concrete layer 102 and the top concrete layer 106 along the longitudinal span of and across the width of the composite panel 100. Thus, the middle insulation layer 104 may carry shear and delamination forces between the bottom concrete layer 102 and the top concrete layer 106. The shear forces may be along the longitudinal span of the composite panel 100. The delamination forces may be across the width of the composite panel 100. The compressive strength of the middle insulation layer 104 being less than the compressive strengths of the bottom concrete layer 102 and/or the top concrete layer 106 may raise challenges with transferring the shear and delamination forces through the middle insulation layer 104 without additional support.

In embodiments, the composite panel 100 may include the trusses 108. For example, the composite panel 100 may include a plurality of the trusses 108. The trusses 108 may be in a linear array along the width of the composite panel 100. The linear array may include consistent spacing between adjacent of the trusses 108 along the width.

The trusses 108 may be formed of one or more truss members. For example, the trusses 108 may include prestress strands 110, truss webs 112, and/or joints 114. The truss members of the trusses 108 may be any size, strength, and material that meets the structural, design or code requirements for the composite panel 100.

The trusses 108 may provide a composite behavior between the bottom concrete layer 102 and the top concrete layer 106. The trusses 108 may transfer forces bidirectionally between the bottom concrete layer 102 and the top concrete layer 106 through tensile force (e.g., axial and/or shear forces). The actions between the bottom concrete layer 102 and the top concrete layer 106 that are resisted may include shear and delamination forces. The trusses 108 may transfer the shear and delamination forces between the bottom concrete layer 102 and the top concrete layer 106, thereby remedying the relatively low compressive strength associated with the middle insulation layer 104. The trusses 108 may also transfer other forces, but the shear and delamination forces may be the primary loads that are carried by the trusses 108. In embodiments, the trusses 108 provide little or no compressive strength between the bottom concrete layer 102 and the top concrete layer 106. For example, the truss webs 112 may be made of wires which provide no compressive strength between the bottom concrete layer 102 and the top concrete layer 106. Instead, the compression strength between the bottom concrete layer 102 and the top concrete layer 106 may be derived from the middle insulation layer 104. For example, compressive forces may be transferred between the bottom concrete layer 102 and the top concrete layer 106 via the middle insulation layer 104. The middle insulation layer 104 may transfer the compressive forces and the trusses 108 may transfer the shear and delamination forces. Thus, the bottom concrete layer 102, middle insulation layer 104, and top concrete layer 106 may be made to act together (compositely) via the trusses 108.

The prestress strands 110 may extend along the longitudinal span of the composite panel 100. The prestress strands 110 may be disposed within the bottom concrete layer 102 and the top concrete layer 106. The composite panel 100 may include a matching number of the prestress strands 110 in the bottom concrete layer 102 and in the top concrete layer 106. For example, the trusses 108 may include half of the prestress strands 110 disposed within the bottom concrete layer 102 and half disposed within the top concrete layer 106. The prestress strands 110 may be disposed within the bottom concrete layer 102 and the top concrete layer 106 and extend along the longitudinal span of the composite panel 100. Each of the trusses 108 may include a pair of the prestress strands 110. One of the pair of prestress strands 110 may be in the bottom concrete layer 102 and another of the pair of prestress strands 110 may be in the top concrete layer 106.

The prestress strands 110 may be chords of the trusses 108. The prestress strands 110 in the bottom concrete layer 102 and the top concrete layer 106 may define a bottom chord and a top chord, respectively, of the truss webs 112. The prestress strands 110 in the bottom concrete layer 102 and the top concrete layer 106 may be horizontal members that define the lower edge and upper edge, respectively, of the truss webs 112.

The prestress strands 110 may include a select material, such as, but not limited to, prestressed concrete steel strand (PC strand). The prestress strands 110 may include a strand diameter. For example, the prestress strands 110 may include a strand diameter of 9.5 mm (e.g., ⅜″), 12.7 mm (e.g., ½″), 15.2 mm (e.g., 0.6″), smaller than 9.5 mm, or larger than 15.2 mm. The prestress strands 110 may include a wire structure, such as, but not limited to a 1×2, 1×3, 1×7, and the like.

The prestress strands 110 may tension the bottom concrete layer 102 and the top concrete layer 106 along the longitudinal span of the composite panel 100. The tension of the bottom concrete layer 102 and the top concrete layer 106 along the longitudinal span of the composite panel 100 may improve a strength of the bottom concrete layer 102 and the top concrete layer 106 in flexure. In this regard, the prestress strands 110 may be a main component for the reinforcement of the composite panel 100. In embodiments, the composite panel 100 may include camber. The camber may keep the composite panel 100 from sagging due to dead load (e.g., the weight of the composite panel 100 and any additional concrete topping added to level the composite panel 100). The camber may be built into the composite panel 100. The camber may be built into the composite panel 100 by increasing a diameter of the prestress strands 110 in the bottom concrete layer 102, thereby imparting a larger precompression force in the bottom concrete layer 102 than the top concrete layer 106. The camber may also be built into the composite panel 100 by tensioning the prestress strands 110 in the bottom concrete layer 102 more than the prestress strands 110 in the top concrete layer 106.

The truss webs 112 may extend along the longitudinal span of the composite panel 100. The truss webs 112 may be disposed in the middle insulation layer 104.

In embodiments, the truss webs 112 may be made of one or more members, such as, but not limited to, a solid member, a wire member (e.g., a braided wire), or the like. The truss webs 112 may be made of a material, as, but not limited to, solid steel, braided steel, hollow steel, galvanized steel, stainless steel, or other metal, fiber infused resin (e.g., glass fiber, carbon fiber, basalt fiber and resin), nylon, polypropylene and other synthetic or natural fibers woven or spun into a rope or cord. The truss webs 112 may include a select diameter. The diameter of the truss webs 112 may be 1 mm, 1.58 mm (e.g., 1/16″), 2 mm, 3 mm, 3.18 mm (e.g., ⅛″), 4.76 mm (e.g., 3/16″), 6.35 mm (e.g., ¼″), a diameter therebetween, or a larger diameter.

The truss webs 112 may be tension wires. The tensions wires may carry tension forces but may not carry compressive forces between the bottom concrete layer 102 and the top concrete layer 106.

The truss webs 112 may be set at one or more angles (theta). The angles of the truss webs 112 may vary depending on the truss design, dimensions, and loads. The truss webs 112 may take the form of diagonal and/or vertical webs of various angles. The vertical webs may include a vertical angle which is normal to the plane of the bottom concrete layer 102 and the top concrete layer 106. The vertical webs may be used throughout the trusses 108 to prevent delamination. The vertical webs may be important to prevent delamination because the interface between the concrete layers and the middle insulation layer 104 may have minimal or no bond. The vertical webs, if of sufficient size, may transfer shear forces through bending and shear deformation as in a Vierendeel style truss.

In embodiments, the trusses 108 may include a truss design. The arrangement of the truss webs 112 may define the truss design. The truss design may include, but is not limited to, a Warren truss, a Pratt truss, a Vierendeel truss, a Mansard truss, or the like. It is contemplated that the truss webs 112 may include any suitable truss design. In embodiments, the truss design may be selected based on the orientation of the composite panel 100 when in use. For example, FIGS. 1B-1E depict examples of the truss designs.

In embodiments, the trusses 108 may be “closed web” trusses. For example, the space between the truss webs 112 may be filled with the insulation material of the middle insulation layer 104. The insulation material of the middle insulation layer 104 may thus close the spaces between the truss webs 112.

The joints 114 may join the truss webs 112 to the prestress strands 110. The joints 114 may be disposed in the bottom concrete layer 102 and/or the top concrete layer 106. For example, the joints 114 which join the truss webs 112 to the prestress strands 110 of the bottom concrete layer 102 may be disposed in the bottom concrete layer 102 and optionally in the middle insulation layer 104. By way of another example, the joints 114 which join the truss webs 112 to the prestress strands 110 of the top concrete layer 106 may be disposed in the top concrete layer 106 and optionally in the middle insulation layer 104.

The truss webs 112 and joints 114 may cooperatively span between and connect to the prestress strands 110 in the bottom concrete layer 102 and the top concrete layer 106, through the middle insulation layer 104. The truss webs 112 and joints 114 may be layer connectors between the bottom concrete layer 102 and the top concrete layer 106. The truss webs 112 and joints 114 may be members which spans between and connects the prestress strands 110 in the bottom concrete layer 102 and the prestress strands 110 in the top concrete layer 106. The truss webs 112 and joints 114 may transfer the tension loads between the prestress strands 110 in the bottom concrete layer 102 and the top concrete layer 106. The tension loads may be induced by environmental or dead loads imposed on the composite panel 100.

Either the truss webs 112 or the joints 114 may extend through the bottom surface of the bottom concrete layer 102 and the top surface of the top concrete layer 106. The truss webs 112 or the joints 114 may join the concrete layers (i.e., the bottom concrete layer 102 and/or the top concrete layer 106) to the middle insulation layer 104 by extending through the bottom surface of the bottom concrete layer 102 and the top surface of the top concrete layer 106 into the middle insulation layer 104.

In embodiments, the joints 114 may extend through the bottom surface of the bottom concrete layer 102 and the top surface of the top concrete layer 106 into the middle insulation layer 104. The truss webs 112 may be disposed in the middle insulation layer 104 and may not extend into the bottom concrete layer 102 and/or the top concrete layer 106. The truss webs 112 may be coupled to the joints 114 in the middle insulation layer 104. In this regard, the trusses 108 may be considered to include long joints with short truss webs. The joints 114 may be made from a non-thermally conductive materially such that extending the joints 114 through the concrete layers into the middle insulation layer 104 may minimize the thermal transfer between the bottom concrete layer 102 and the top concrete layer 106. For example, the thermal conductivity of the joints 114 may be less than the thermal conductivity of the truss webs 112.

In embodiments, the truss webs 112 may extend from the middle insulation layer 104 through the bottom surface of the bottom concrete layer 102 and the top surface of the top concrete layer 106. The joints 114 may be disposed in the bottom concrete layer 102 and the top concrete layer 106 and may not extend into the middle insulation layer 104. The truss webs 112 may be coupled to the joints 114 in the bottom concrete layer 102 and the top concrete layer 106. In this regard, the trusses 108 may be considered to include short joints with long truss webs. The joints 114 may not extend into the middle insulation layer 104 if the thermal properties of the composite panel 100 is not a priority. The short joints with long truss webs may increase structural design properties and may be used in floor or structural members where strength is the priority. For example, the thermal conductivity of the truss webs 112 may be less than the thermal conductivity of the joints 114.

The truss webs 112 and/or joints 114 may be made of a material, such as, but not limited to, steel, carbon fiber, polymer, fiber reinforced polymer, or the like. The steel may include plain steel, stainless steel, galvanized steel, carbon steel, stainless steel, or the like. The polymer may include resins, vinyl ester, polyester, nylon, polypropylene, or the like. The fiber may include glass fiber, carbon fiber, organic fiber, steel fiber, basalt fiber, hemp fiber, organic fiber, non-organic fibers, synthetic fiber, natural fiber, or the like. In embodiments, the joints 114 may be made from a combination of materials, such as steel hooks surrounded by fiber resins, insulative or protective coating on the hook material. In embodiments, the joints 114 may be made from composite materials, such as glass fiber and resins, and the truss webs 112 may be made from a steel wire. The materials of the truss webs 112 and/or joints 114 may be selected such that the trusses 108 may include low thermal conductivity. The trusses 108 may include low thermal conductivity such that the composite panel 100 may be used for insulation purposes. The low thermal conductivity for insulation purposes may not be necessary if the composite panel 100 is not required to have insulation properties. In embodiments, both the truss webs 112 and/or joints 114 may be steel (e.g., galvanized steel, stainless steel, and the like). Where both the truss webs 112 and/or joints 114 are steel, the trusses 108 may include a relatively high thermal conductivity as heat may transfer between the bottom concrete layer 102 and the top concrete layer 106 through the middle insulation layer 104 via the trusses 108.

The truss webs 112 and/or joints 114 may be formed by bending, casting, stamping, forging, molding (e.g., injection, compression, or other molding techniques), or another suitable manufacturing process.

The truss webs 112 may be continuous truss webs 112a or segmented truss webs 112b.

In embodiments, the truss webs 112 may be a continuous truss webs 112a. The continuous truss webs 112a may extend along the longitudinal span of the composite panel 100 without a break. The continuous truss webs 112a may be considered continuous by being formed form a single member which does not include any breaks along the longitudinal span. The continuous truss webs 112a may include a continuous length of wire along the longitudinal span.

In embodiments, the truss webs 112 may be segmented truss webs 112b. The segmented truss webs 112b may include segments 113. Individual of the segments 113 do not extend along the longitudinal span of the composite panel 100. However, multiple of the segments 113 may connect to form the segmented truss webs 112b and cooperatively extend along the longitudinal span of the composite panel 100.

The segments 113 may connect directly between two of the joints 114 which are immediately adjacent. The segments 113 may connect from at least one of the joints 114 in the bottom concrete layer 102 to at least one of the joints 114 in the top concrete layer 106. The segments 113 may connect between two of the joints 114 which are immediately adjacent (e.g., one in the bottom concrete layer 102 and one in the top concrete layer 106). The segments 113 may also connect between three or more of joints 114 which are immediately adjacent. The segments 113 may also connect between three or more of joints before terminating and locking to avoid slippage. The segments 113 may connect to first, second, and third joints, where the first and third joints are on opposing sides to the second joint and where the second joint is disposed between the first and third joints.

The segmented truss webs 112b may include one or more loops for connecting to the joints 114. The segmented truss webs 112b may include open-looped segmented truss webs 112b-1 where the segments 113 are open-looped segments 113-1 and/or double-looped segmented truss webs 112b-2 where the segments 113 are double-looped segments 113-2.

In embodiments, the segmented truss webs 112b are open-looped segmented truss webs 112b-1 including the open-looped segments 113-1. The open-looped segments 113-1 may be formed from a wire which is welded, swaged, clamped, crimped, or the like. The open-looped segments 113-1 may be joined to at least two of the joints 114. For example, the open-looped segments 113-1 may be joined to at least one of a bottom of the joints 114 which is joined to the prestress strands 110 in the bottom concrete layer 102 and at least one of a top of the joints 114 which is joined to the prestress strands 110 in the top concrete layer 106. In some instances, the open-looped segments 113-1 may be joined to three or more of the joints 114. For example, the open-looped segments 113-1 may be joined to two of the bottom of the joints 114 which is joined to the prestress strands 110 in the bottom concrete layer 102 and one of the top of the joints 114 which is joined to the prestress strands 110 in the top concrete layer 106. By way of another example, the open-looped segments 113-1 may be joined to one of the bottom of the joints 114 which is joined to the prestress strands 110 in the bottom concrete layer 102 and two of the top of the joints 114 which is joined to the prestress strands 110 in the top concrete layer 106.

In embodiments, the segmented truss webs 112b are double-looped segmented truss webs 112b-2 and include the double-looped segments 113-2. The double-looped segments 113-2 may include a shank connecting between opposing loop ends (e.g., eyelets). The double-looped segments 113-2 may be formed from a wire which may be welded, clamped, crimped, twisting the wires about itself with one or more wraps, a simple bend or hook, or the like to form the opposing loop ends. The double-looped segments 113-2 may be joined to two of the joints 114. For example, the double-looped segments 113-2 may be joined to one of the bottom of the joints 114 which is joined to the prestress strands 110 in the bottom concrete layer 102 and one of the top of the joints 114 which is joined to the prestress strands 110 in the top concrete layer 106.

The joints 114 may include any suitable design for joining the truss webs 112 to the prestress strands 110. For example, the joints 114 may be double-ended hook joints 114a, lock joints 114b, and the like.

In embodiments, the joints 114 may be double-ended hook joints 114a. For example, the double-ended hook joints 114a may include a first hook end and a second hook end. The first hook end may join to the prestress strands 110 and the second hook end may join to the truss webs 112. It is contemplated that the double-ended hook joints 114a may include ε-shaped hooks (i.e., where the first and second hook ends open in a same direction) or S-shaped hooks (i.e., where the first and second hook ends open in opposing directions).

It is contemplated that the double-ended hook joints 114a may or may not lock to the prestress strands 110 and/or the truss webs 112. It is contemplated that one disadvantage with the double-ended hook joints 114a is that the prestress strands 110 and/or the truss webs 112 may slip past the hook ends of the joints 114. For example, the prestress strands 110 and/or the truss webs 112 may slip past the hook ends of the joints 114 where the truss webs 112 are continuous lengths of wire. If the prestress strands 110 and/or the truss webs 112 slips past the joints 114 then the shear load transfer by the trusses 108 may be reduced.

In embodiments, the lock joints 114b may lock to the prestress strands 110 and/or the truss webs 112. Locking the joints 114 to the prestress strands 110 and/or the truss webs 112 may prevent the prestress strands 110 and/or the truss webs 112, respectively, from slipping past the lock joints 114b. The lock joints 114b may reduce or eliminate slippage of the prestress strands 110 and/or the truss webs 112. The lock joints 114b may be used for any of the joints 114 to prevent slippage. In embodiments, the lock joints 114b may be used at each of the joints 114. Although the lock joints 114b have been described as used at each of the joints 114, this is not intended as a limitation of the present disclosure. In embodiments, the lock joints 114b disposed at the ends of the composite panels 100. In embodiments, the lock joints 114b may be used at locations with higher design loads.

The lock joints 114b may lock to the prestress strands 110 and/or the truss webs 112 by a variety of methods. The lock joints 114b may lock to the truss webs 112 by twisting the truss webs 112 around the joints 114, passing the truss webs 112 over and under hub-type members of the joints 114, cam locks, twisting of the hook, knots, crimp ring, welding or a combination of these methods could be used to accomplish the goal of minimal slippage. The lock joints 114b may include truss lock joints 114b-1, hanger lock joints 114b-2, double-ended hook lock joints 114b-3, and the like.

In embodiments, the ridge portions 116 and the trusses 108 may be aligned. For example, the prestress strands 110 within the bottom concrete layer 102 may be aligned with and disposed below the ridge portions 116 of the bottom concrete layer 102. The prestress strands 110 within the top concrete layer 106 may be aligned with and disposed above the ridge portions 116 of the top concrete layer 106. The truss webs 112 may be aligned with and disposed between the ridge portions 116. The joints 114 may be aligned with the ridge portions 116. Either the truss webs 112 or the joints 114 may extend through the ridge portions 116.

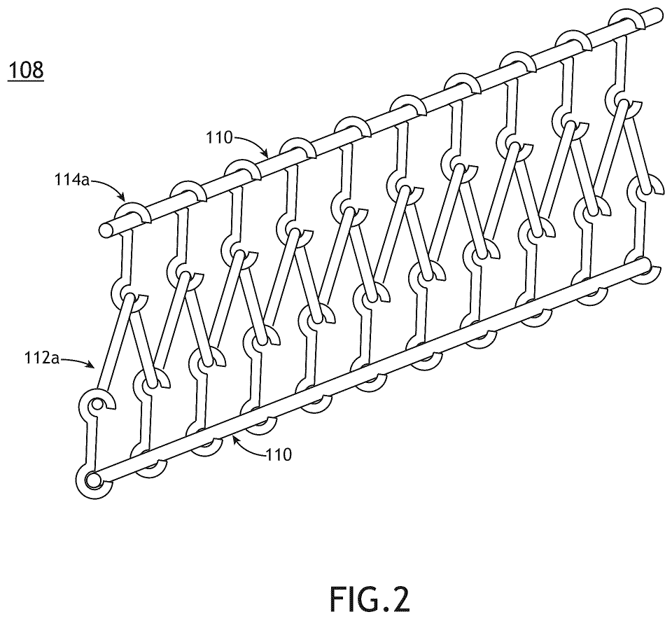

FIG. 2 depicts a perspective view of the trusses 108 with the continuous truss webs 112a and double-ended hook joints 114a, in accordance with one or more embodiments of the present disclosure.

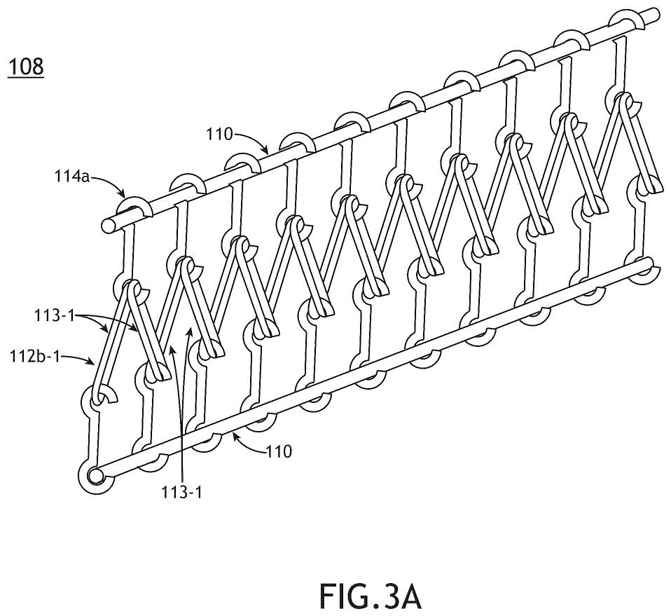

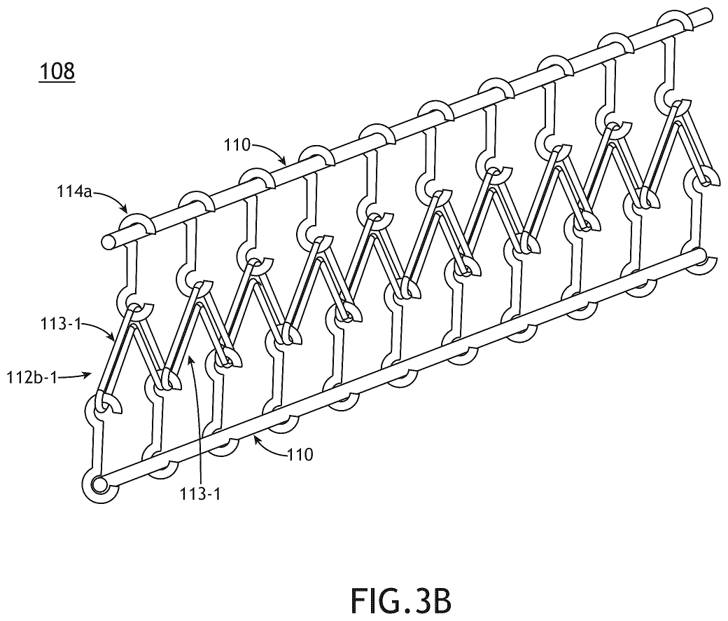

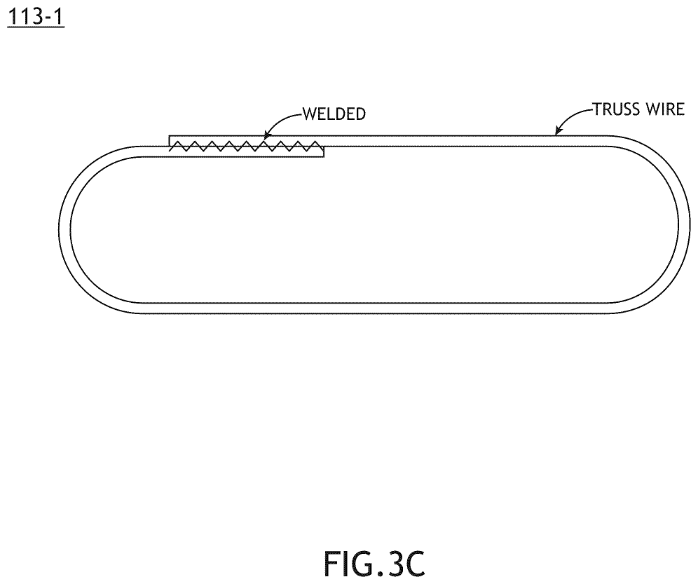

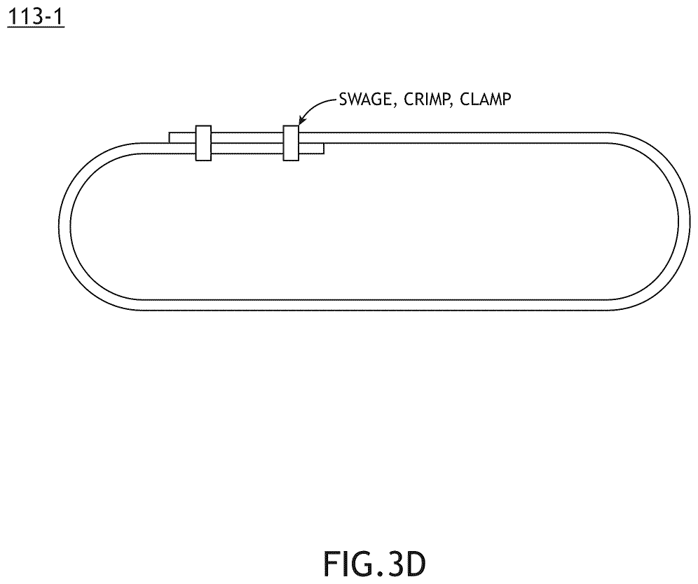

FIGS. 3A-3D depict the trusses 108 with the open-looped segmented truss webs 112b-1 and the double-ended hook joints 114a, in accordance with one or more embodiments of the present disclosure. In the example of FIG. 3A, the open-looped segments 113-1 of the open-looped segmented truss webs 112b-1 are joined to two of the double-ended hook joints 114a. In the example of FIG. 3B, the open-looped segments 113-1 of the open-looped segmented truss webs 112b-1 are joined to three of the double-ended hook joints 114a.

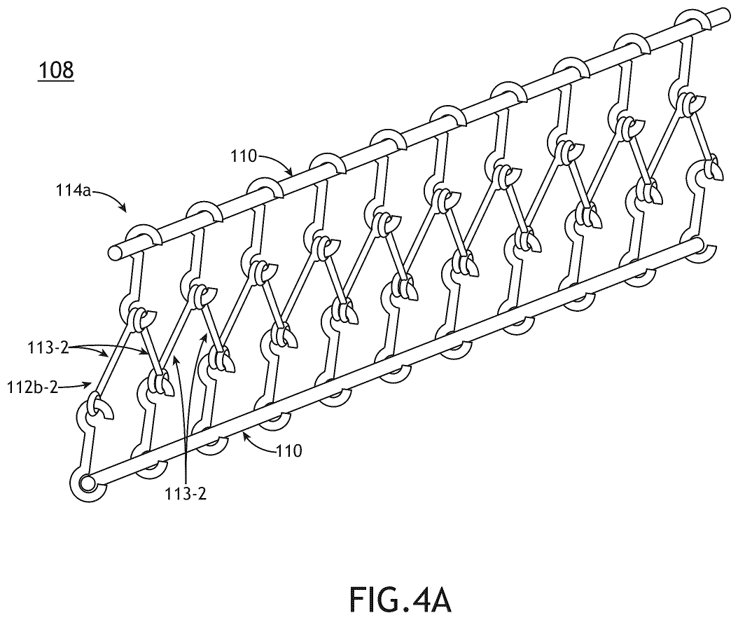

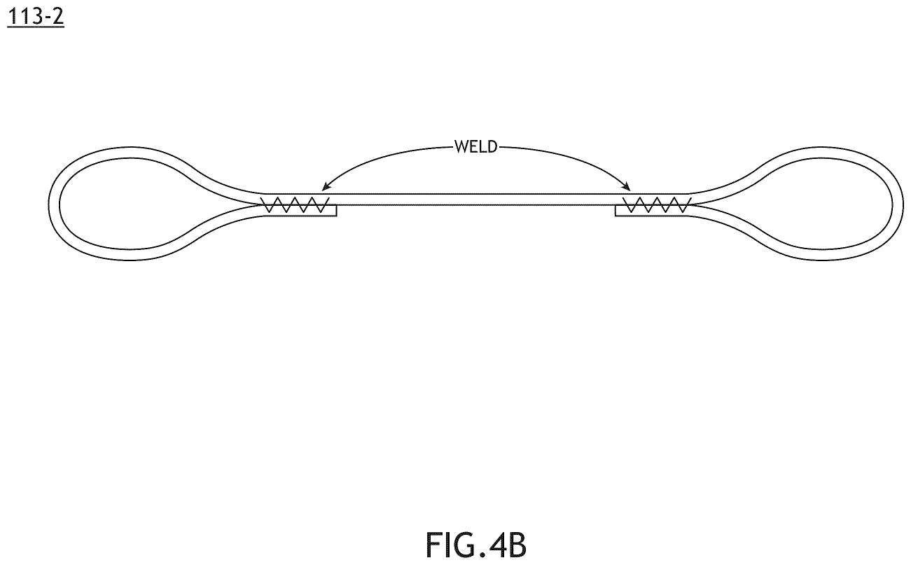

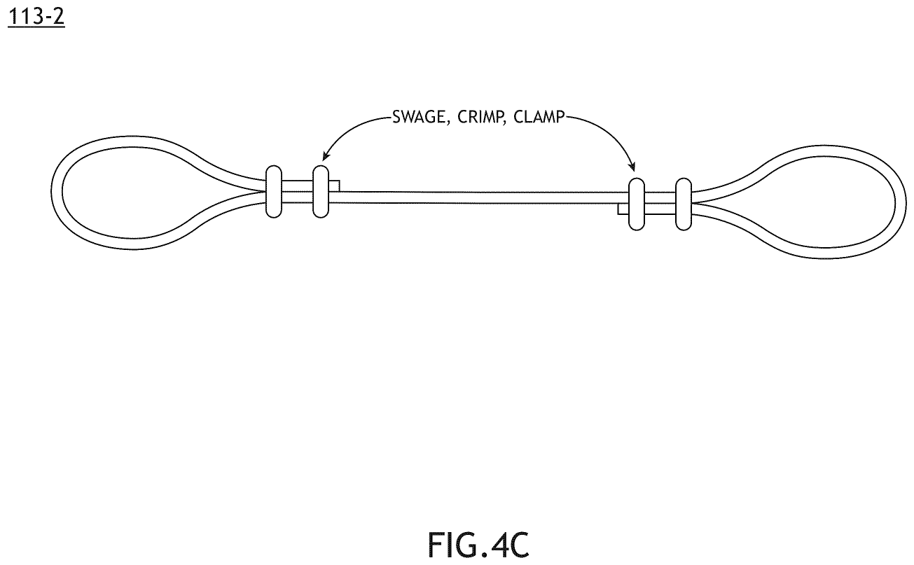

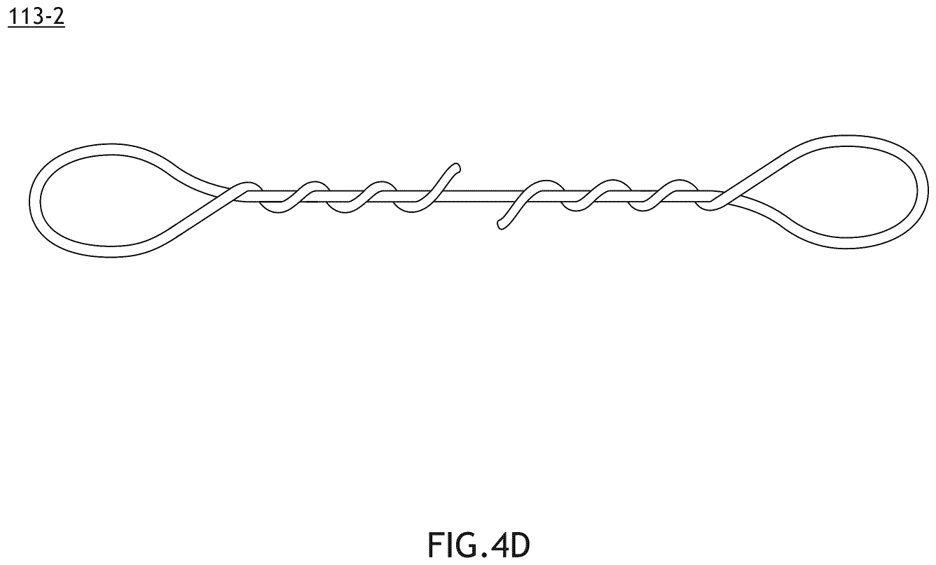

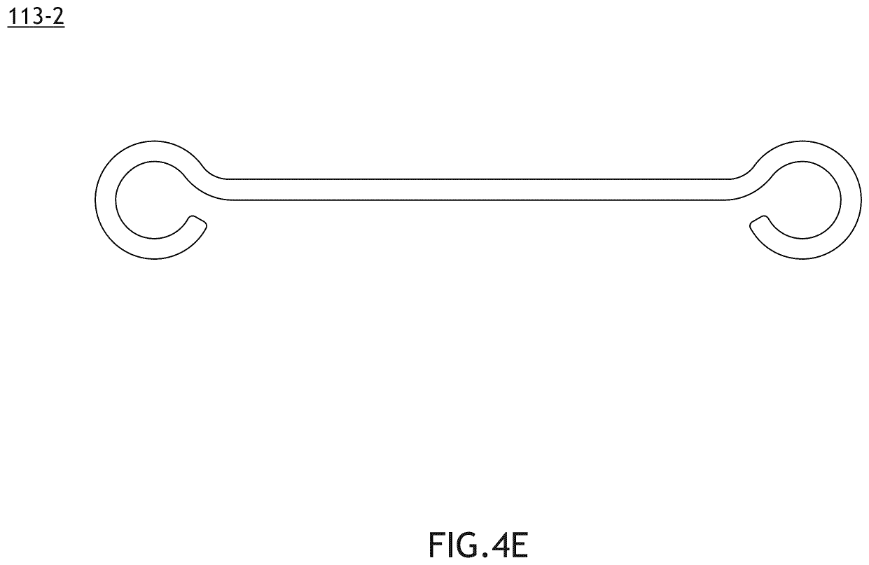

FIGS. 4A-4E depict the double-looped segmented truss webs 112b-2 with the double-ended hook joints 114a, in accordance with one or more embodiments of the present disclosure. In the example of FIG. 4A, the double-looped segments 113-2 of the double-looped segmented truss webs 112b-2 are joined to two of the double-ended hook joints 114a.

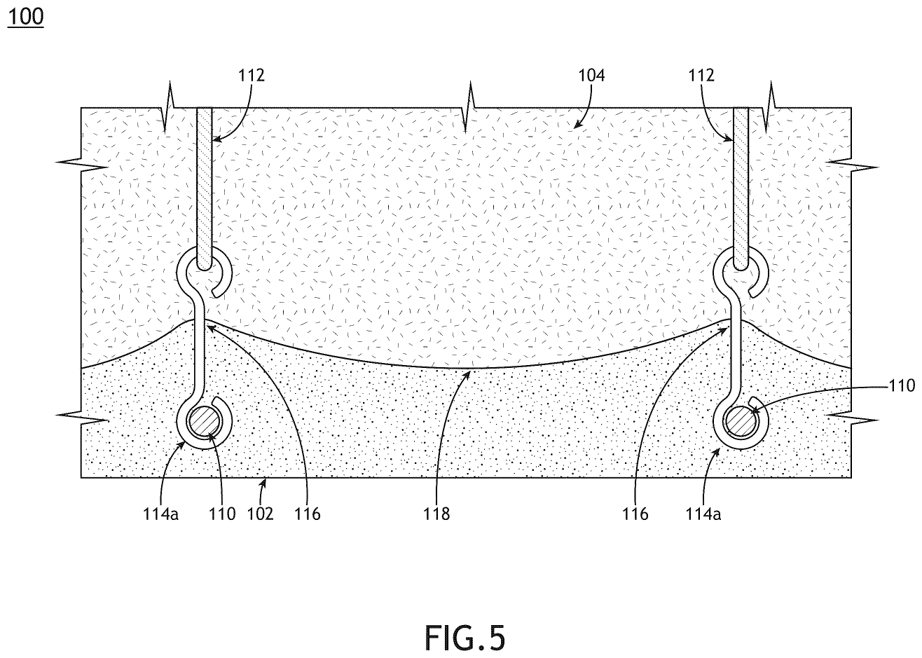

FIG. 5 depicts a partial cross-section along a width of the composite panels 100, in accordance with one or more embodiments of the present disclosure. In this configuration the ditch portions 118 of the bottom concrete layer 102 are round and the joints 114 may be the double-ended hook joints 114a with a ε-shape. The joints 114 may extend through the concrete layers into the middle insulation layer 104 and the truss webs 112 may be disposed in the middle insulation layer 104 and may not extend into the concrete layers.

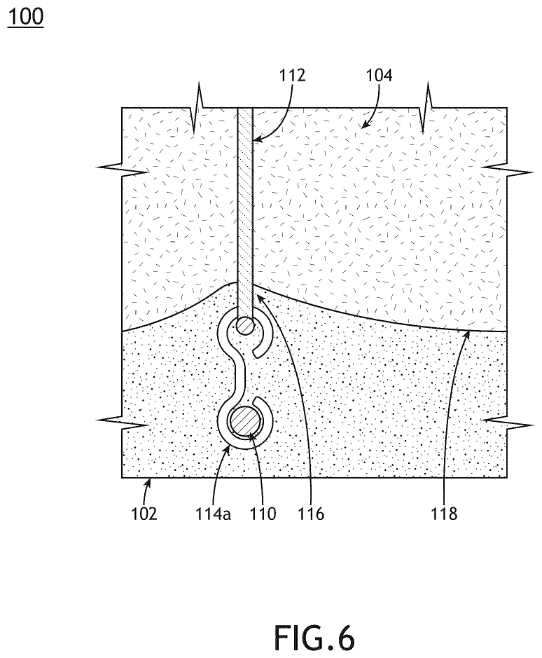

FIG. 6 depicts a partial cross-section along a width of the composite panels 100, in accordance with one or more embodiments of the present disclosure. In this configuration the ditch portions 118 of the bottom concrete layer 102 may be round and the joints 114 may be the double-ended hook joints 114a with a ε-shape. In this configuration, the joints 114 may be disposed in the concrete layers and may not extend into the middle insulation layer 104. The truss webs 112 may be disposed in the middle insulation layer 104 and may extend into the concrete layers.

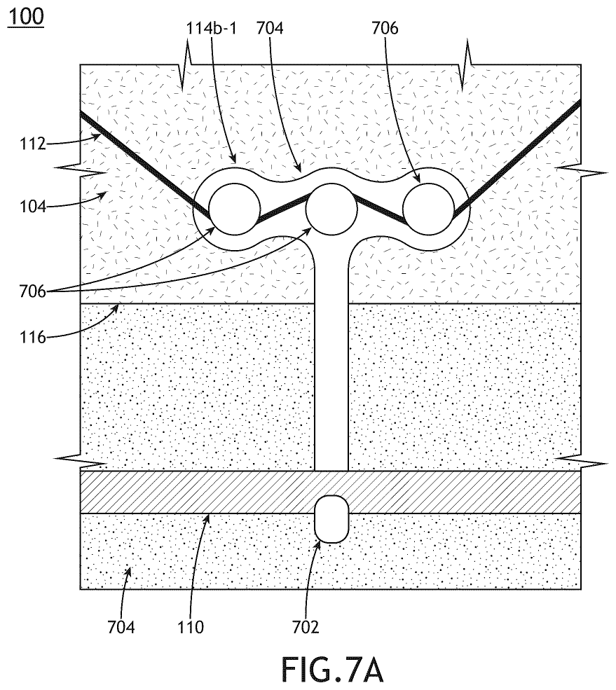

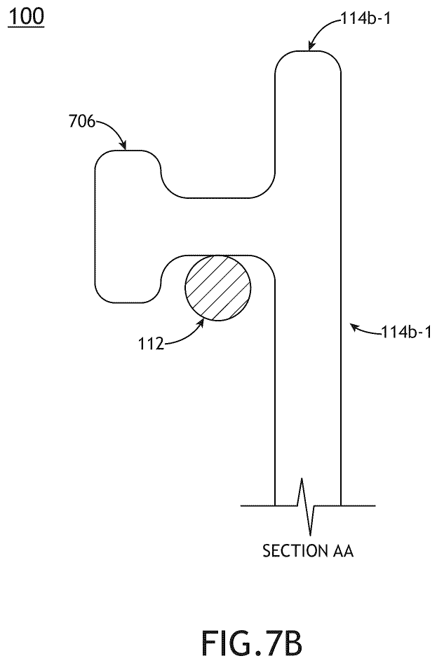

FIGS. 7A-7B depict the truss lock joints 114b-1, in accordance with one or more embodiments of the present disclosure. The truss lock joints 114b-1 extend into the middle insulation layer 104. In embodiments, the truss lock joints 114b-1 may include hook end 702 and a hub end 704. The hook end 702 may couple to the prestress strands 110. The hub end 704 may couple to the truss webs 112. For example, the hub end 704 may include hub-type members 706. The truss webs 112 may be passed over and under hub-type members 706 thereby cinching the truss webs 112 to the hub end 704. Thus, the truss lock joints 114b-1 may be locked to the truss webs 112.

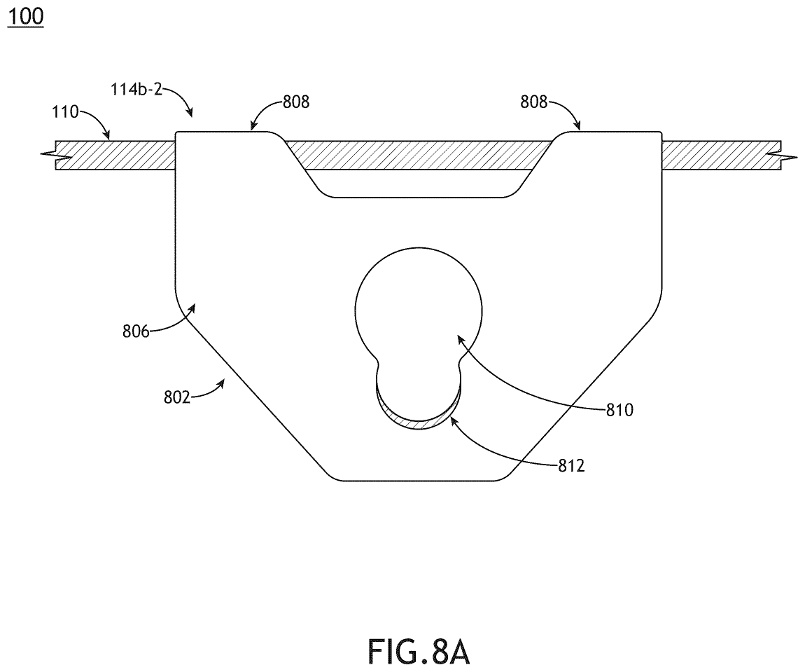

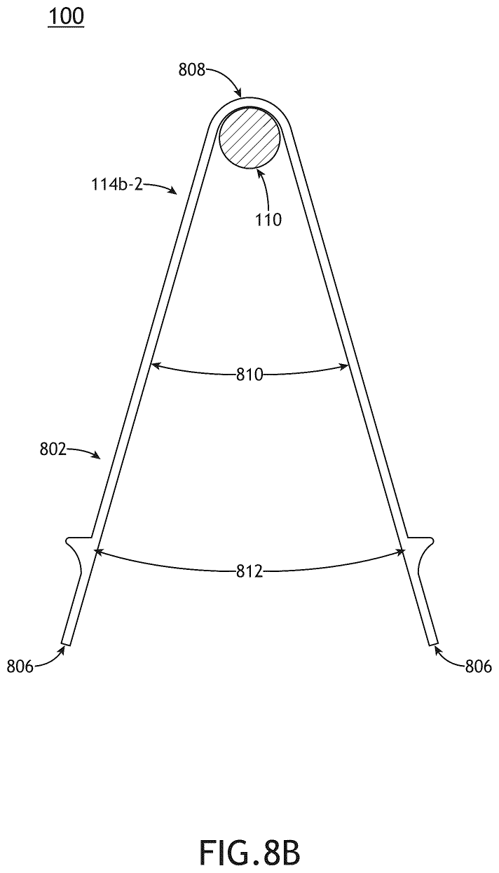

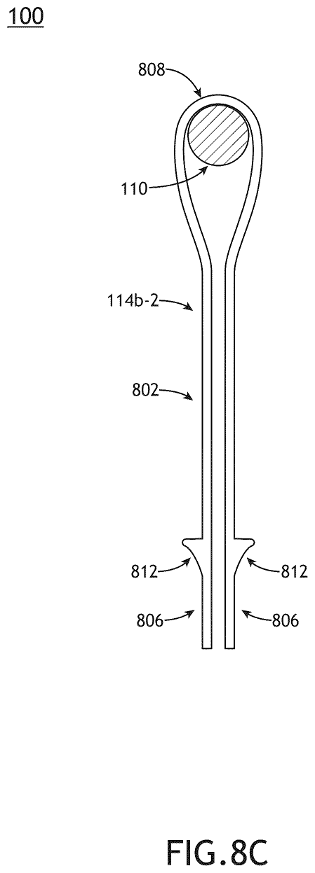

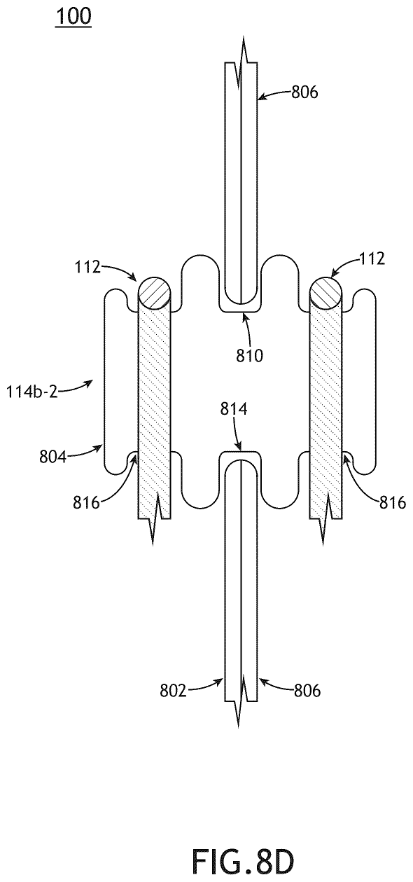

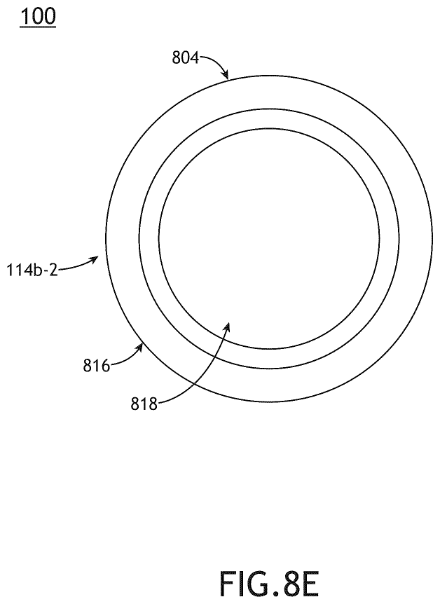

FIGS. 8A-8E depict the hanger lock joints 114b-2, in accordance with one or more embodiments of the present disclosure. The hanger lock joints 114b-2 may include a bracket 802 and hub 804. The bracket 802 may include a pair of plate portions 806 and bend portions 808. The bend portions 808 may extend between the pair of plate portions 806. The prestress strands 110 may be received by the bend portions 808 between the pair of plate portions 806. The hanger lock joints 114b-2 may then hang from the prestress strands 110. Where the bracket 802 is metal, the bracket 802 may be crimped to the prestress strands 110. Where the bracket 802 is a fiber impregnated resin material, the bracket 802 may be closed and locked with the use of a pin type lock or other method.

The pair of plate portions 806 may define a through hole 810. The hub 804 may be disposed in the through hole 810 of the pair of plate portions 806. The through hole 810 may be a notched through hole to enable inserting the hub 804 into the through hole 810 and resting the hub 804 in the notch. The pair of plate portions 806 may include a flange 812. The flange 812 may be aligned below the notch. The hub 804 may rest on the flange 812 to increase a bearing capacity of the hanger lock joints 114b-2.

The hub 804 may be made of steel, galvanized, stainless steel, resins, and the like. The hub 804 may include a center notch 814 and outer notches 816. The center notch 814 may mate to the pair of plate portions 806. For example, the center notch 814 may mate to the through hole 810 of the pair of plate portions 806. The center notch 814 may be disposed between the outer notches 816. The truss webs 112 may be wound around the hub 804 and held by the outer notches 816. The hub 818 may also define a hole in the center to lighten the hub 818 or aid in installation of the hub 818. The truss webs 112 may be bent over the hub 804 without fixing if the truss webs 112 are in tension. Thus, the hanger lock joints 114b-2 may be locked to the truss webs 112.

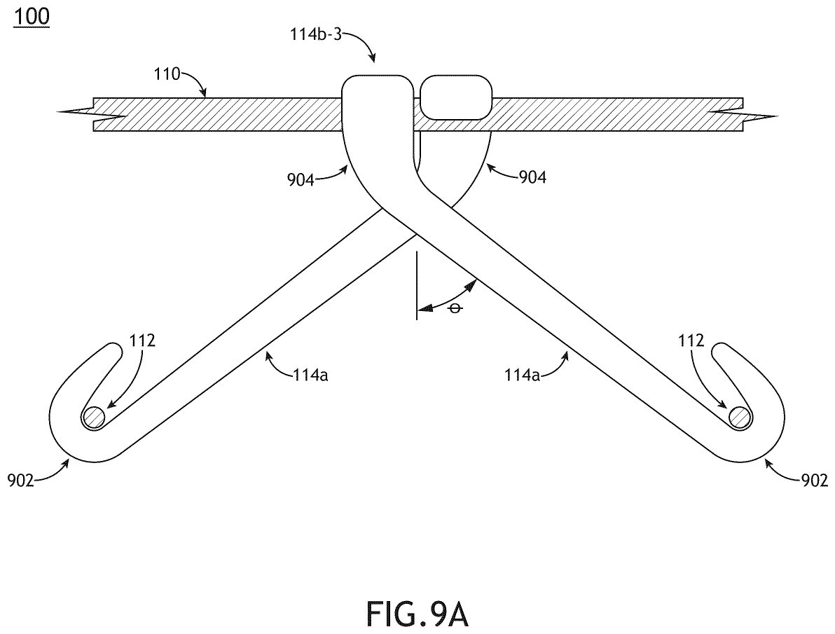

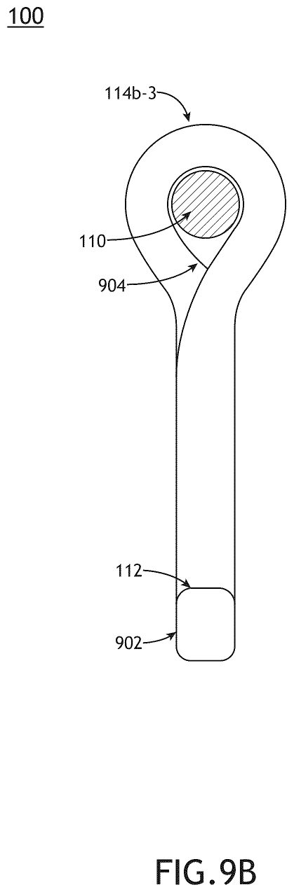

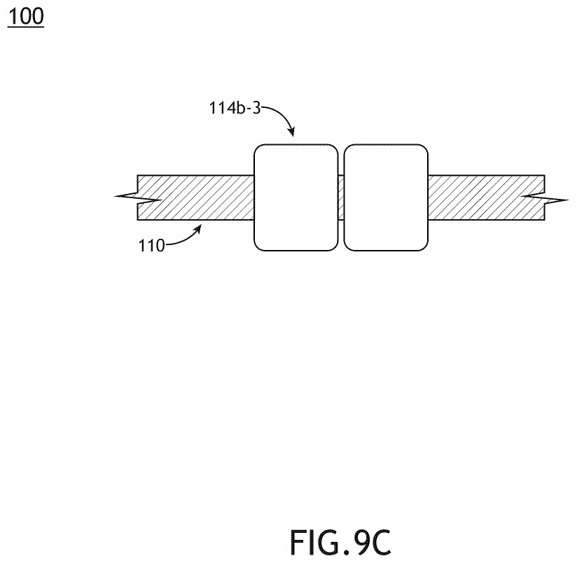

FIGS. 9A-9C depict the double-ended hook lock joints 114b-3, in accordance with one or more embodiments of the present disclosure. The double-ended hook lock joints 114b-3 may include a pair of the double-ended hook joints 114a. For example, each of the double-ended hook joints 114a may include hook ends 902 and an inside mating surface 904. The inside mating surface 904 may couple to the prestress strands 110. The inside mating surface 904 may be smooth, knurled or threaded to grip or lock onto the prestress strands 110. When the double-ended hook lock joints 114b-3 is made of metal, the double-ended hook lock joints 114b-3 may be crimped onto the prestress strands 110. The inside mating surface 904 may have a flat or nearly flat surface where a first of the double-ended hook joints 114a may abut with a second of the double-ended hook joints 114a. In this regard, the pair of double-ended hook joints 114a may abut on and/or below the prestress strands 110. The abutment between the double-ended hook joints 114a may allow the truss webs 112 on opposite sides to pull against each other and prevent or minimize movement.

The hook ends 902 may be set at an angle relative to the inside mating surface 904. For example, the hook ends 902 may be designed to have a specific angle, such as, but not limited to, be 0 degrees, 30 degrees, 45 degrees, 60 degrees, or an angle therebetween. The hook ends 902 may be set at the angle in opposing directions. The hook ends 902 may or may not include the same angle.

The hook ends 902 may couple to the truss webs 112. The hook ends 902 may include a notch that may include a radius, arc, or flat. The arc or radius may prevent the truss webs 112 from breaking. The truss webs 112 may be bent over the hook ends 902 without fixing or locking if the truss webs 112 are in tension.

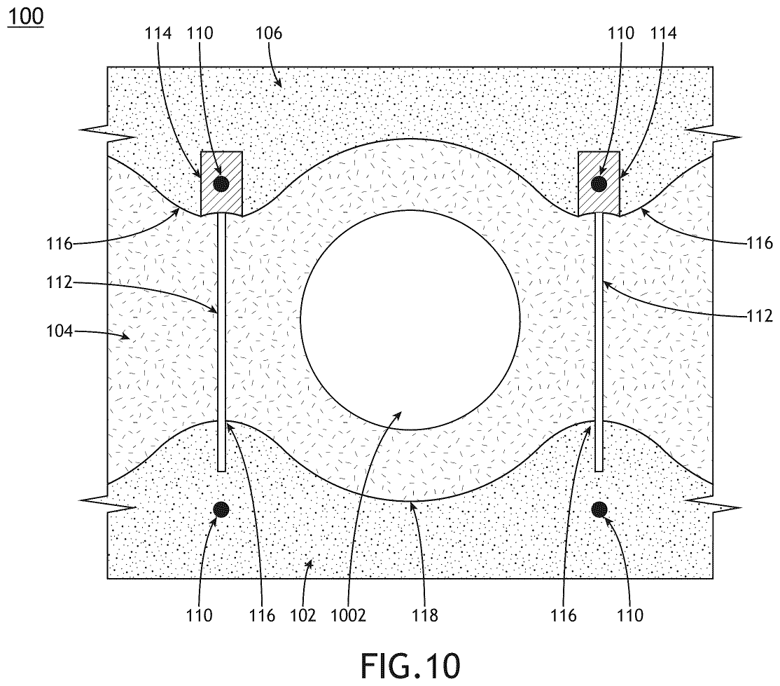

FIG. 10 depicts a partial cross-section of the composite panel 100 along a width of the composite panel 100, in accordance with one or more embodiments of the present disclosure. In embodiments, the middle insulation layer 104 may define a void space 1002. The void space 1002 may include a shape, such as, but not limited to, a circular, elliptical, or polygonal (e.g., hexagonal, octagonal, etc.). The void space 1002 may extend along the longitudinal span of the composite panel 100. The void space 1002 may define a negative, vacuum, or laminar flow air space created could be used to increase the thermal efficiency of the composite panel 100. The void space 1002 may lighten the composite panel 100. The void space 1002 may be used for creating conduits for electrical, plumbing, and other building systems. The void space 1002 may carry air for heating and ventilation purposes, insulation purposes, and the like. The void space 1002 may be sealed through chemical means (e.g., desifiers, polymer-based sealers or similar) or a pressure vessel-like form includes metal, plastic, or other similar materials suitable for pressure vessels.

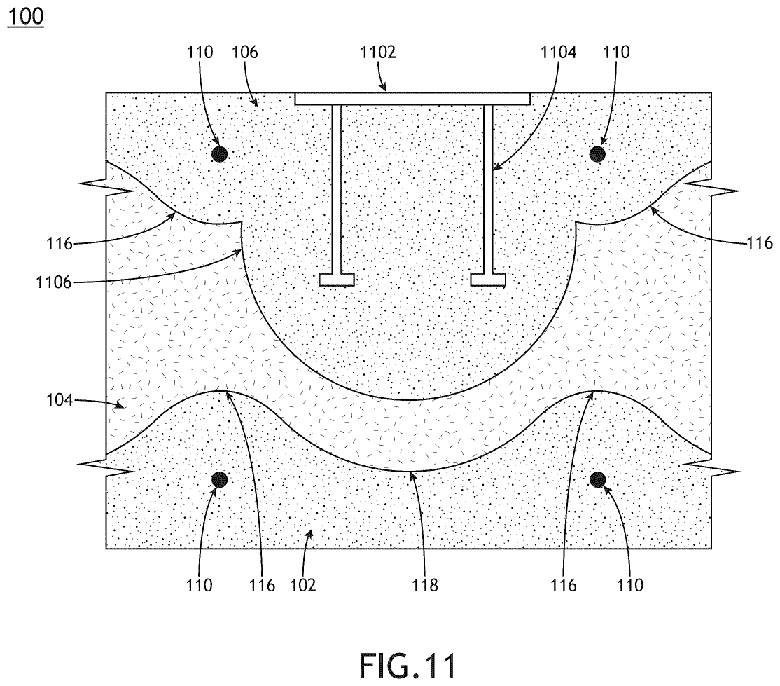

FIG. 11 depicts a partial cross-section of the composite panel 100 along a width of the composite panel 100, in accordance with one or more embodiments of the present disclosure. In embodiments, the composite panel 100 may include embed plate 1102 and headed studs 1104. A portion of the middle insulation layer 104 (with or without a void) may be removed and replaced a hump portion 1106 of the top concrete layer 106. A thickness of the top concrete layer 106 between the hump portion 1106 and the top surface may be thicker than the thickness between the ridge portion 116 and the top surface. The middle insulation layer 104 may be continuous between the bottom concrete layer 102 and the hump portion 1106 of the top concrete layer 106. The embed plate 1102 and the headed studs 1104 may be embedded into the hump portion 1106 of the top concrete layer 106. The embed plate 1102, headed studs 1104, and/or the hump portion 1106 may be disposed between a pair of the prestress strands 110.

Although the middle insulation layer 104 is described as continuous between the bottom concrete layer 102 and the hump portion 1106 of the top concrete layer 106, this is not intended as a limitation of the present disclosure. In embodiments, the middle insulation layer 104 may be removed and replaced with the hump portion 1106 (not depicted). An example where all the insulation may be removed is one where a canopy would be attached to the outside face of the building. The design loads, if high enough, may require removal of the insulation in certain locations.

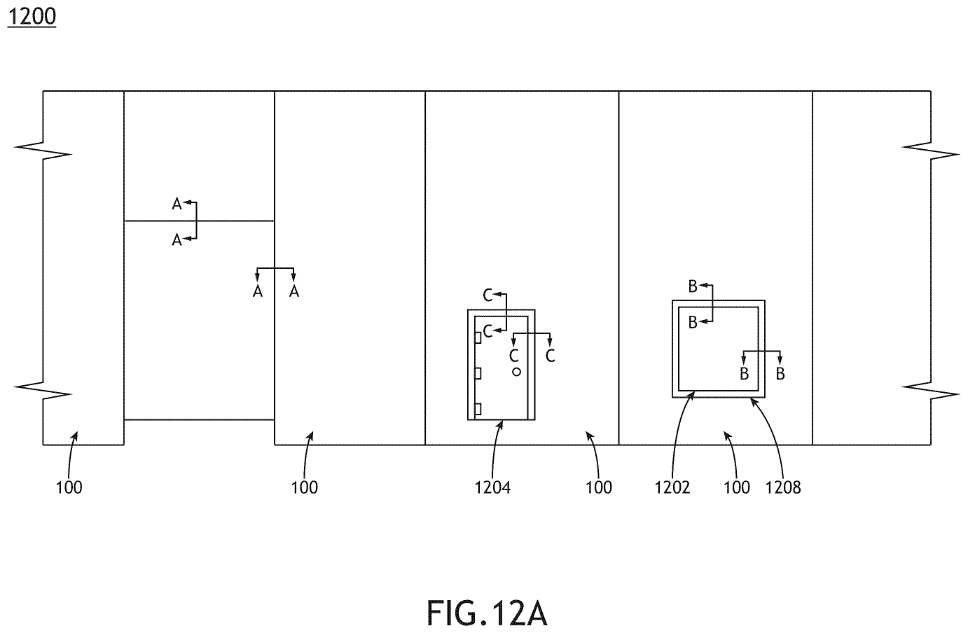

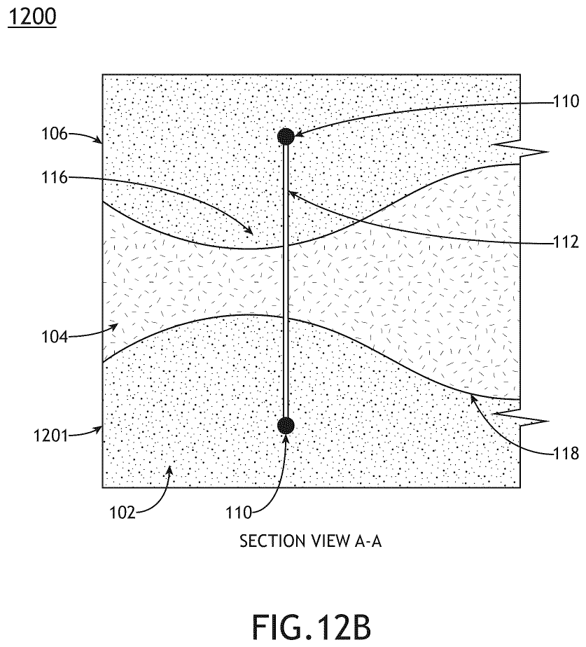

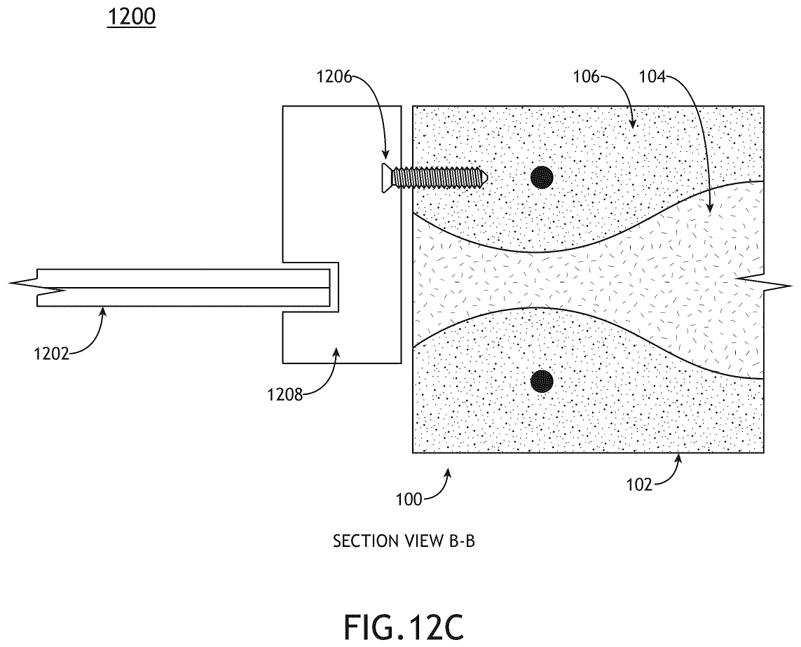

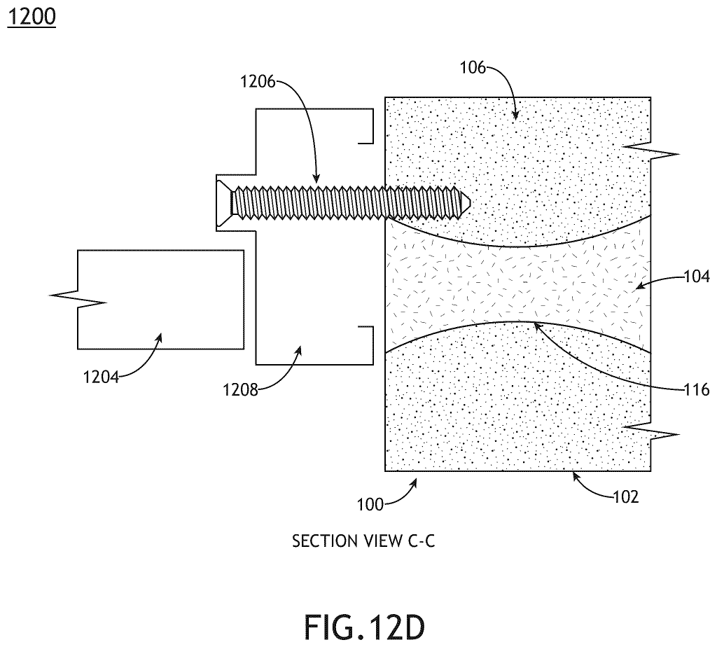

FIGS. 12A-12D depict a system 1200, in accordance with one or more embodiments of the present disclosure. In embodiments, the system 1200 may include the composite panels 100, windows 1202, doors 1204, fasteners 1206, frames 1208, and the like. The composite panels 100 may include an edge 1201. The edge 1201 may allow for coupling the window 1202 and door 1204 to the composite panel 100. The edge 1201 may include the bottom concrete layer 102, the middle insulation layer 104, and the top concrete layer 106. The middle insulation layer 104 may be maintained while allowing for the window 1202, door 1204, fasteners 1206, frames 1208, caulk, and the like.

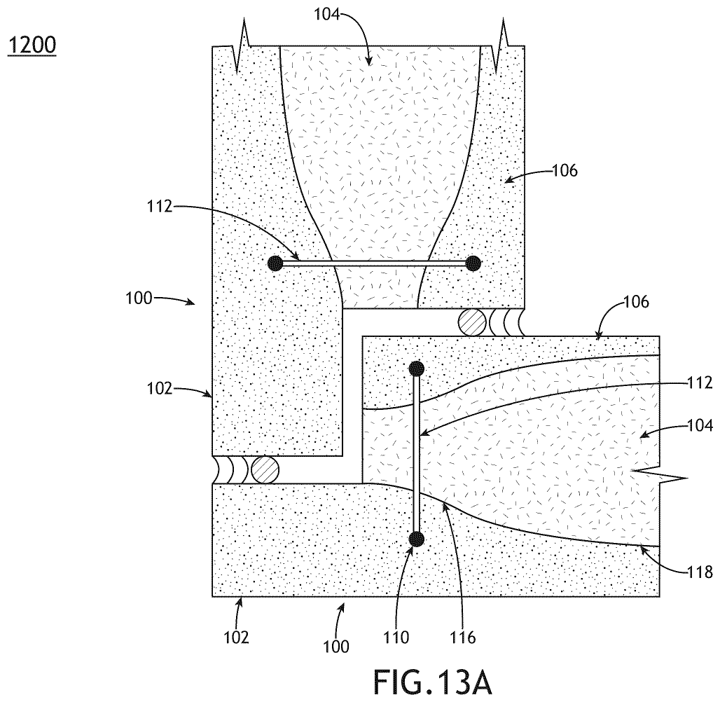

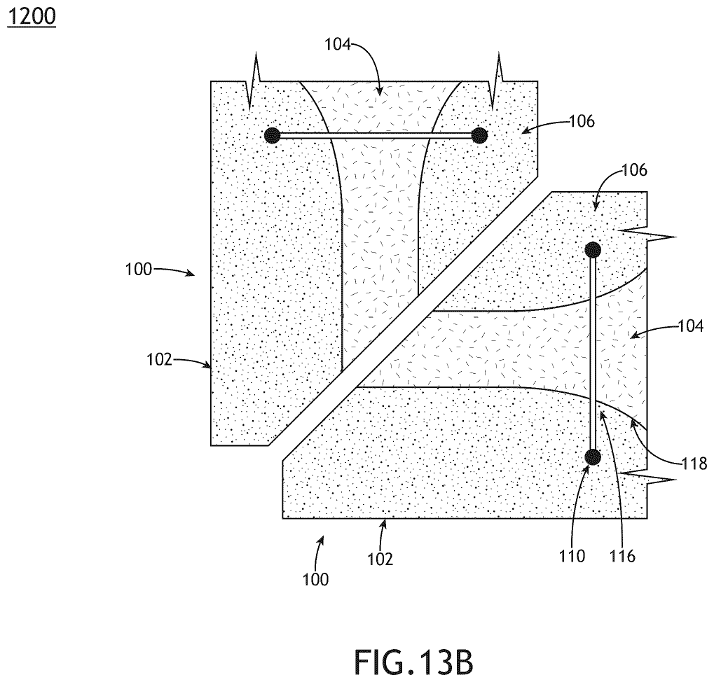

FIG. 13A-13B depict the system 1200, in accordance with one or more embodiments of the present disclosure. A first of the composite panels 100 may be orthogonal to a second of the composite panels 100. The composite panels 100 may include one or more corner joints. The corner joints may maintain the edge-to-edge insulation of the building envelope required per the code. The middle insulation layer 104 of a first of the composite panels 100 may be covered by the bottom concrete layer 102, the middle insulation layer 104, and/or the top concrete layer 106 of a second of the composite panels 100. The corner joints may be formed during casting or fabricated after by saw cutting. FIG. 13A depicts the corner joints of the composite panels 100 with a lap joint. FIG. 13B depicts the corner joints of the composite panels 100 with a mitered joint. The mitered joint may be advantageous to abut the middle insulation layers 104 of the composite panels 100.

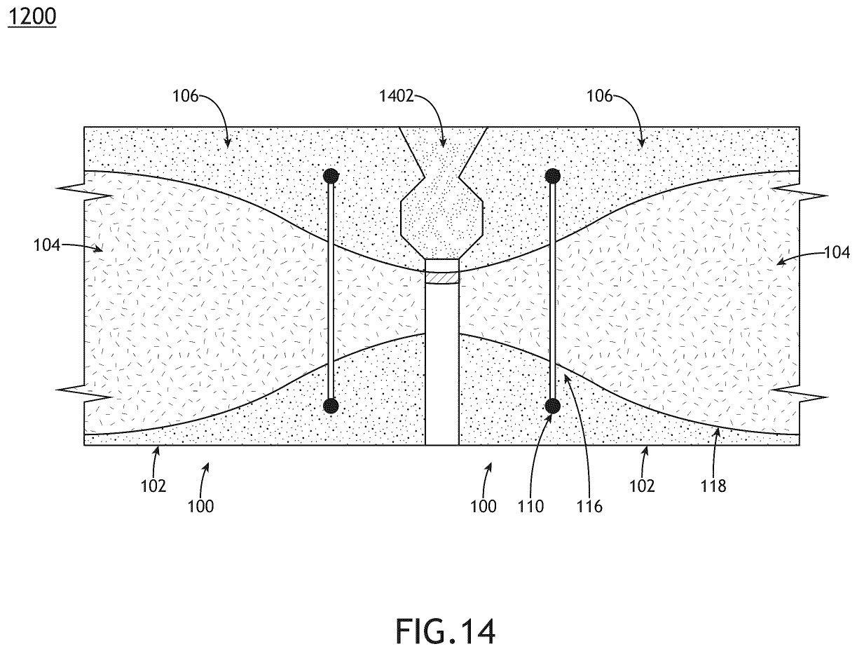

FIG. 14 depict the system 1200, in accordance with one or more embodiments of the present disclosure. A first of the composite panels 100 may be coincident to a second of the composite panels 100. The system 1200 may include a grout key 1402. The grout key 1402 may be disposed between the composite panels 100. The grout key 1402 may transfer shear between the composite panels 100. The grout key 1402 may include, but is not limited to a female-to-female configuration (as depicted) or a male-to-female configuration. The grout key 1402 may be coupled between the top concrete layers 106 of the composite panels 100. The location of the grout key 1402 in the top concrete layers 106 of the composite panels 100 may enable maintaining edge-to-edge insulation. For example, the middle insulation layers 104 of the composite panels 100 may abut and be disposed between the concrete layers.

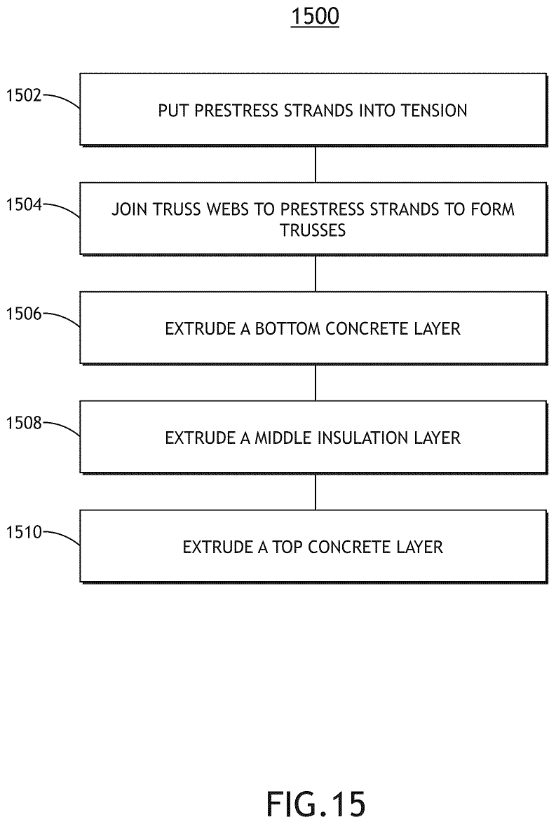

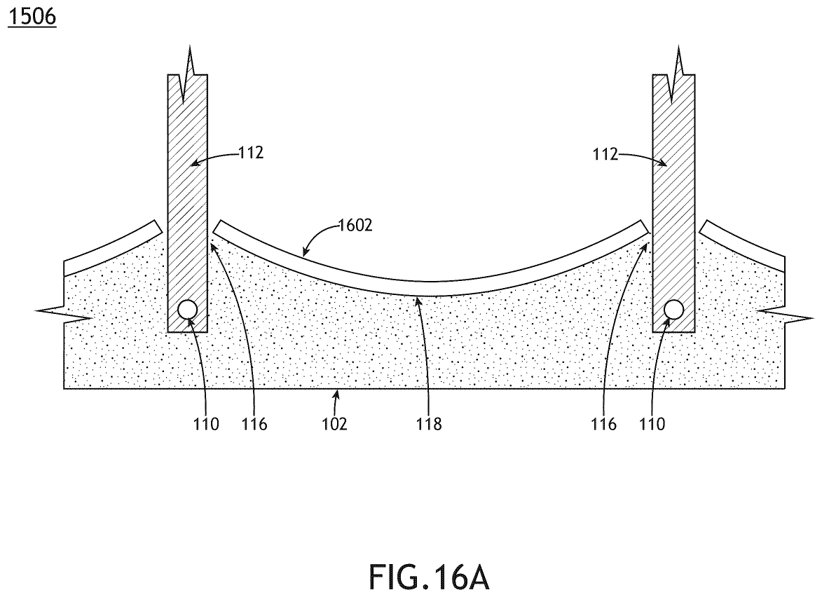

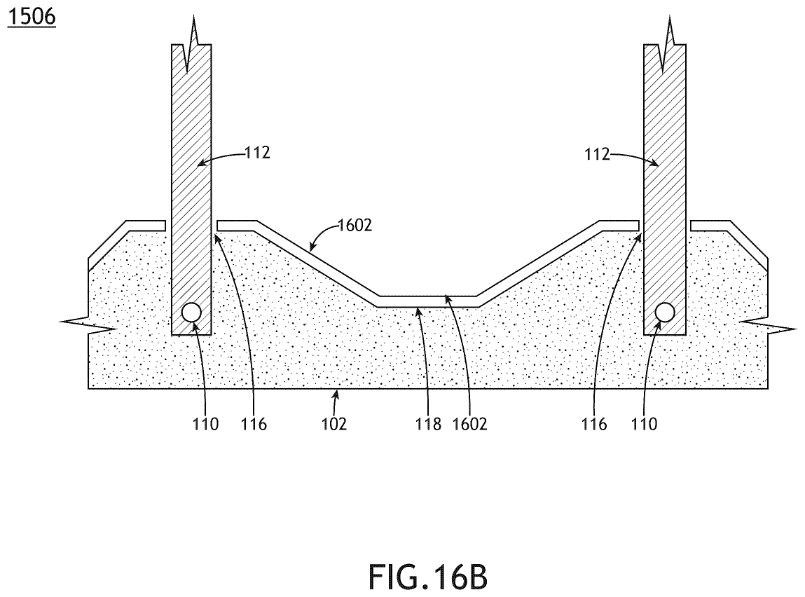

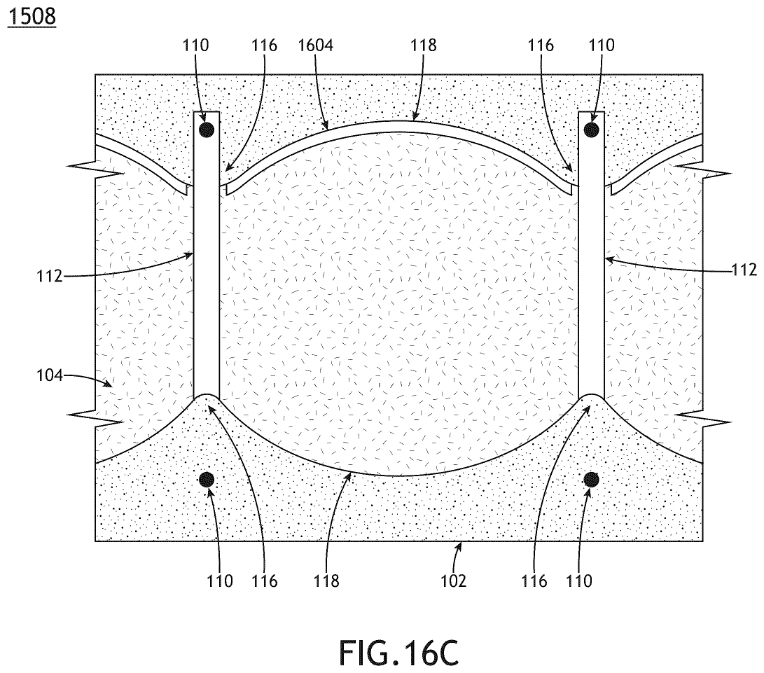

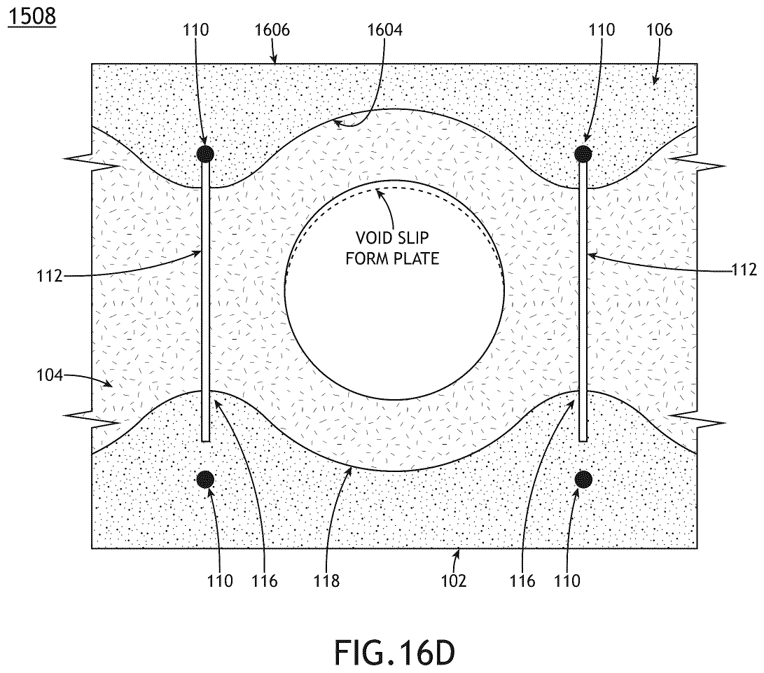

Referring now to FIG. 15, a method 1500 is described, in accordance with one or more embodiments of the present disclosure. The embodiments and the enabling technology described previously herein in the context of the composite panel 100 should be interpreted to extend to the method 1500. For example, the method 1500 may be a method of manufacturing the composite panel 100. It is further recognized, however, that the method 1500 is not limited to the composite panel 100. The method 1500 may include automatically or semi-automatically manufacturing the composite panel 100 using one or more pre-cast extrusion machines. The steps of the method 1500 may be further understood with reference to the examples provide in FIGS. 16A-16D.

In a step 1502, prestress strands may be put into tension. The prestress strands may include pairs of prestress strands which are arranged in linear arrays for a select length. For example, pairs of the prestress strands 110 may be put into tension along the length of the composite panel 100. Putting the prestress strands 110 into strain may include elongating the prestress strands 110.

In a step 1504, truss webs may be joined to the prestress strands using joints to form trusses. The joints may receive the truss webs and the prestress strands. For example, the truss webs 112 may be joined to the prestress strands 110 using the joints 114 to form the trusses 108. For instance, the continuous truss webs 112a and/or the segmented truss webs 112b may be joined to the prestress strands 110 using the double-ended hook joints 114a and/or the lock joints 114b to form the trusses 108. Thus, the trusses 108 may be put in place prior to the extruding of the bottom concrete layer 102, the middle insulation layer 104, and the top concrete layer 106.

In a step 1506, a bottom concrete layer may be extruded. For example, the bottom concrete layer 102 may be extruded. The bottom concrete layer 102 may be formed by bottom form plates 1602. The bottom form plates 1602 may define the ridge portions 116 and ditch portions 118 of the bottom concrete layer 102. For example, the bottom form plates 1602 may include a flat shape, an arc shape, a polygonal shape (e.g., trapezoid), or the like to define the ridge portions 116 and ditch portions 118. For instance, FIGS. 16A-16B depict shapes of the bottom form plates 1602. The bottom form plates 1602 may travel along the longitudinal span between the trusses 108 without interfering with the trusses 108 (e.g., without entering interference zones including the trusses 108). The bottom form plates 1602 may use pressure and/or vibration to compact the concrete material into the bottom concrete layer 102. The bottom concrete layer 102 may be extruded around the prestress strands 110, the truss webs 112, and/or the joints 114.

In a step 1508, a middle insulation layer may be extruded. For example, the middle insulation layer 104 may be extruded. The middle insulation layer 104 may be formed by middle form plates 1604. The middle form plates 1604 may define the ridge portions 116 and ditch portions 118 between the middle insulation layer 104 and the top concrete layer 106. For example, the middle form plates 1604 may include a flat shape, an arc shape, a polygonal shape (e.g., trapezoid), or the like to define the ridge portions 116 and ditch portions 118. For instance, FIG. 16C depict arc shapes of the middle form plates 1604. The middle form plates 1604 may travel along the longitudinal span between the trusses 108 without interfering with the trusses 108 (e.g., without entering interference zones including the trusses 108). The middle form plates 1604 may use pressure and/or vibration to compact the insulation material into the middle insulation layer 104. The middle insulation layer 104 may be extruded around the prestress strands 110, the truss webs 112, and/or the joints 114.

During the placement and consolidation of the middle insulation layer 104, the concrete material of the bottom concrete layer 102 may mix with the insulation material of the middle insulation layer 104. In embodiments, the bottom form plates 1602 may be used in combination with the middle form plates 1604 for part, or none of the slip form process. Using the bottom form plates 1602 may be utilized in combination with the middle form plates 1604 may reduce the mixing between the bottom concrete layer 102 and the middle insulation layer 104. For example, the bottom form plates 1602 may prevent disturbing the bottom concrete layer 102 when extruding the middle insulation layer 104 with the middle form plates 1604.

In a step 1510, a top concrete layer may be extruded. For example, the top concrete layer 106 may be extruded. The top concrete layer 106 may be formed by top form plates 1606. The top form plates 1606 may define the top surface of the top concrete layer 106. For example, the top form plates 1606 may include a flat shape. For instance, FIG. 16D depicts the flat shape of the top form plates 1606. The top form plates 1606 may use pressure and/or vibration to compact the concrete material into the top concrete layer 106. The top concrete layer 106 may be extruded around the prestress strands 110, the truss webs 112, and/or the joints 114.

During the placement and consolidation of the top concrete layer 106, the concrete material of the bottom concrete layer 102 may mix with the insulation material of the middle insulation layer 104 and/or the insulation material of the middle insulation layer 104 may mix with the concrete material of the top concrete layer 106. In embodiments, the bottom form plates 1602 and/or the middle form plates 1604 may be used in combination with the top form plates 1606 for part, or none of the slip form process. Using the bottom form plates 1602 and/or the middle form plates 1604 in combination with the top form plates 1606 may reduce the mixing between the bottom concrete layer 102, the middle insulation layer 104, and the top concrete layer 106. For example, the bottom form plates 1602 and middle form plates 1604 may prevent disturbing the bottom concrete layer 102 and middle insulation layer 104, respectively, when extruding the top concrete layer 106 with the top form plates 1606.

In embodiments, the void space 1002 may have all, some, or none of a void form plate to hold the insulation material in place while the top concrete layer 106 is being extruded. The void space 1002 may be formed at the same time as the middle insulation layer 104 and/or the top concrete layer 106 is being extruded and compressed. The void space 1002 could be plugged at the end after the composite panel 100 is cut to length and stripped.

In embodiments, the bottom concrete layer 102, the middle insulation layer 104, and/or the top concrete layer 106 may be manufactured in one long extrusion. For example, the steps of extruding the bottom concrete layer 102, the middle insulation layer 104, and/or the top concrete layer 106 may be simultaneous or near-simultaneous. In embodiments, a machine may simultaneously or near-simultaneously extrude the bottom concrete layer 102, the middle insulation layer 104, and/or the top concrete layer 106. Near-simultaneously may refer to beginning to extrude the bottom concrete layer 102, the middle insulation layer 104, and/or the top concrete layer 106 within several feet of each other, or less. To achieve the extrusion, the machine may include multiple hoppers containing the materials and distributing the materials into the layers. Alternatively, two or three of the machines may distribute the materials into the layers in succession to create the composite panel 100.

Although the step 1506, the step 1508, and the step 1510 are described as extruding the bottom concrete layer 102, the middle insulation layer 104, and the top concrete layer 106, respectively, this is not intended as a limitation of the present disclosure. It is contemplated that the step 1506, the step 1508, and the step 1510 may be replaced with pouring the bottom concrete layer 102, the middle insulation layer 104, and the top concrete layer 106, respectively. Where the bottom concrete layer 102, the middle insulation layer 104, and the top concrete layer 106, the concrete material of the bottom concrete layer 102, the middle insulation layer 104, and the top concrete layer 106 may be high-slump concrete which may be consolidated in formworks to form the bottom concrete layer 102, the middle insulation layer 104.

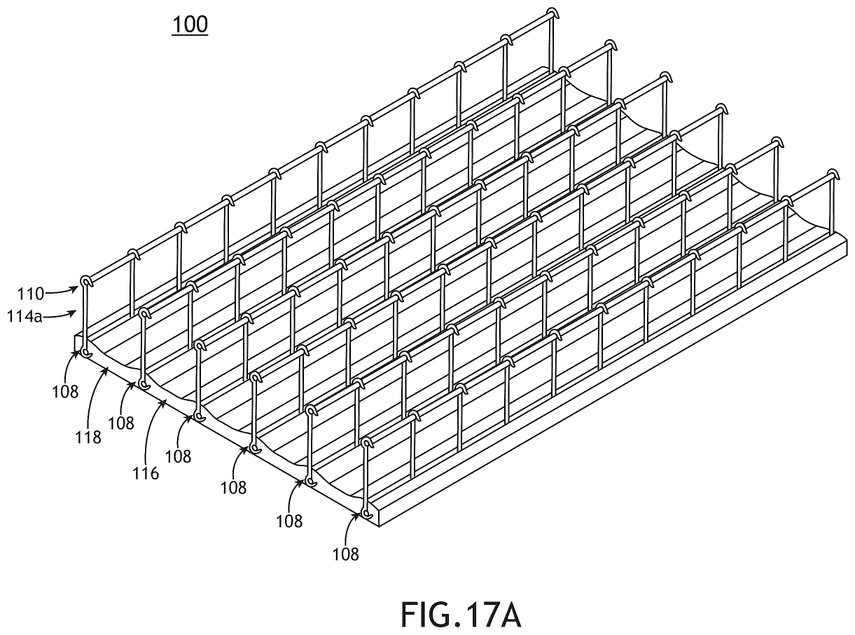

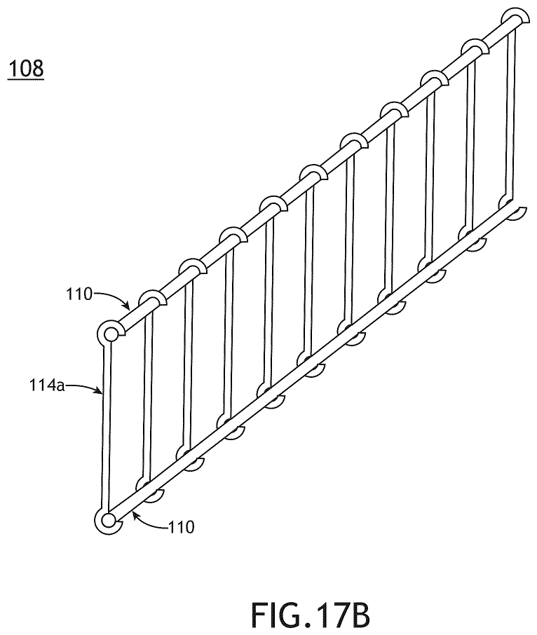

FIG. 17A-17B depicts the composite panel 100, in accordance with one or more embodiments of the present disclosure. Although the trusses 108 have been described as including the truss webs 112, this is not intended as a limitation of the present disclosure. In embodiments, the trusses 108 may include the prestress strands 110 and the joints 114. The joints 114 may couple directly between the prestress strands 110 in the bottom concrete layer 102 and the prestress strands 110 in the top concrete layer 106 through the middle insulation layer 104. In this regard, the joints 114 may extend from prestress strands 110 to prestress strands 110 without the truss webs 112. It is contemplated that any of the designs of the joints 114 may couple directly between the prestress strands 110 in the bottom concrete layer 102 and the prestress strands 110 in the top concrete layer 106. For example, the double-ended hook joints 114a may couple directly between the prestress strands 110 in the bottom concrete layer 102 and the prestress strands 110 in the top concrete layer 106. The lock joints 114b (e.g., the truss lock joints 114b-1, hanger lock joints 114b-2, double-ended hook lock joints 114b-3) may or may not be able to couple directly between the prestress strands 110 in the bottom concrete layer 102 and the prestress strands 110 in the top concrete layer 106.

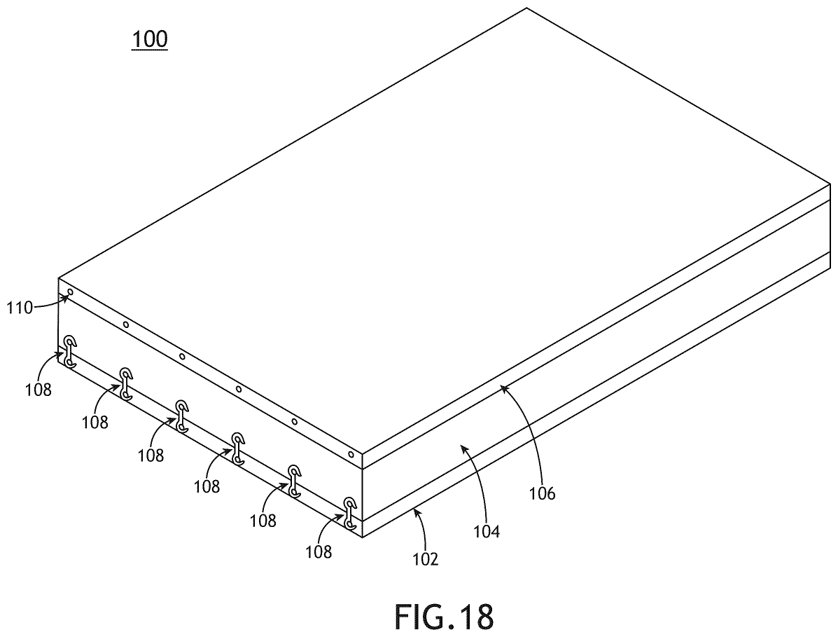

FIG. 18 depicts the composite panel 100, in accordance with one or more embodiments of the present disclosure. Although the top surface of the bottom concrete layer 102 and the bottom surface of the top concrete layer 106 are described as including the ridge portions 116 and/or ditch portions 118, this is not intended as a limitation of the present disclosure. For example, the top surface of the bottom concrete layer 102 and the bottom surface of the top concrete layer 106 may be flat. However, the addition of the ridge portions 116 and/or ditch portions 118 may be beneficial to reduce a weight and/or improve a strength of the composite panel 100. The top surface of the bottom concrete layer 102 and the bottom surface of the top concrete layer 106 being flat may be advantageous to enabling manufacturing the composite panel 100 by pouring, instead of slip-forming.

Referring generally again to the figures. The composite panel 100 may have the ability to carry loads from wind, snow, seismic and other live and environmental loads. The composite panel 100 may take dead loads imposed on the composite panel 100. The building code also includes provisions for thermal insulation of the building envelope. The composite panel 100 may be used as exterior walls and/or roof members and may include the insulation properties necessary to meet or exceed the code. The composite panel 100 may achieve the desired design and code requirements by varying the thickness of the bottom concrete layer 102, the middle insulation layer 104, and/or the top concrete layer 106, varying the number and size of the prestress strands 110, and/or varying the configuration of the trusses 108.

Although the composite panel 100 is described as including the prestress strands 110, this is not intended as a limitation of the present disclosure. The prestress strands 110 may be replaced with plain or non-prestressed reinforcement bars (rebar). However, the rebar may raise additional challenges in the manufacture of the composite panel 100.

Although much of the present disclosure has described the composite panels 100 as being formed by extrusion, this is not intended as a limitation of the present disclosure. For example, the bottom concrete layer 102, the middle insulation layer 104, and/or the top concrete layer 106 may be poured and cast. The bottom concrete layer 102, the middle insulation layer 104, and/or the top concrete layer 106 may be poured and cast at a manufacturing plant before transportation and/or at cast in-situ.

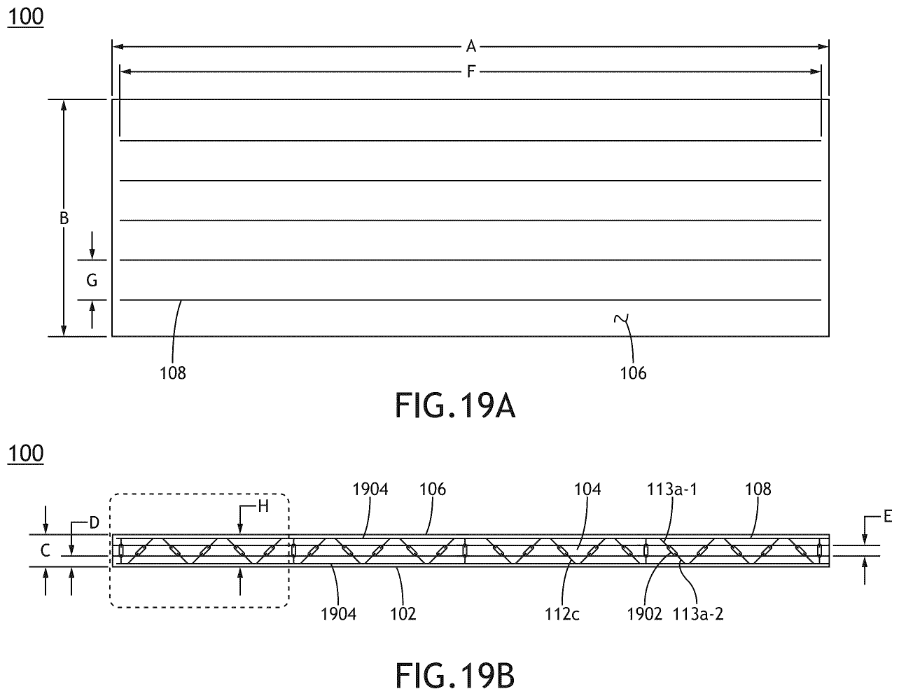

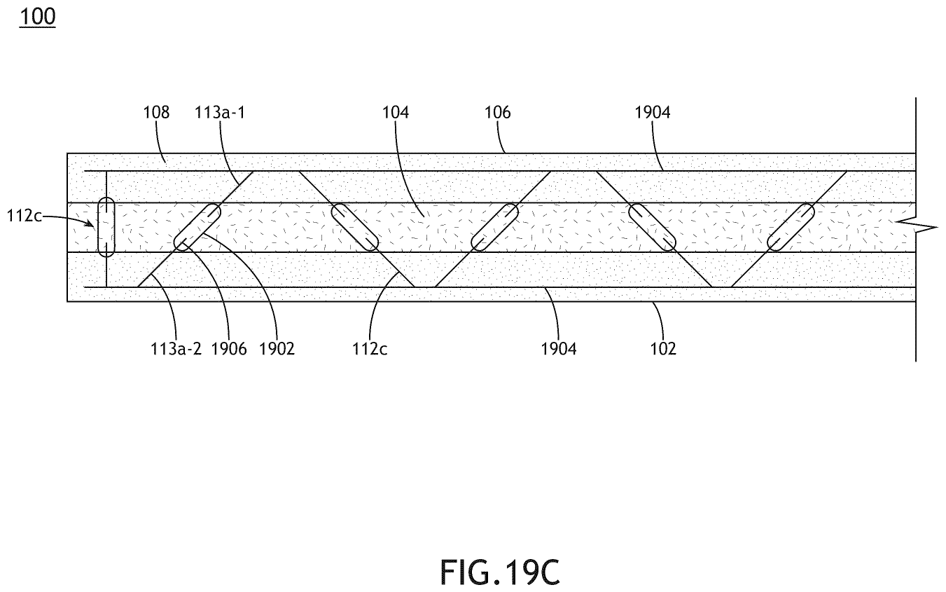

FIGS. 19A-25 further depict the composite panel 100, in accordance with one or more embodiments of the present disclosure. The composite panel 100 may be a composite slab panel, a composite wall panel, a composite roof slab, a slab-on-grade, a suspended slab, a roof panel, a wall panel, a reinforced concrete wall, a precast panel, a prestressed wall panel, an insulated concrete panel, an insulated concrete sandwich member, a slab, a sandwich member, a column, an internal pilaster, or the like. The composite panel 100 may include the trusses 108 which may be composite trusses. The trusses 108 may include the truss webs 112 and/or the joints 114. The trusses 108 may additionally include resin blocks 1902 and/or longitudinal reinforcement members 1904.

The bottom concrete layer 102 and the top concrete layer 106 may also be referred to as first and second concrete layers, as inside and outside concrete layers, and the like. The bottom concrete layer 102 and the top concrete layer 106 may include a concrete material. The concrete material may include any cementitious mixes which include and are not limited to ultra-high-performance concrete (UHPC), lightweight concrete, and the like. The bottom concrete layer 102 and the top concrete layer 106 may act as a diaphragm member which may transfer shear loads due to wind, seismic or other loads to shear walls, foundations, or other braced bays. The bottom concrete layer 102 and the top concrete layer 106 may be disposed on opposing sides of the middle insulation layer 104.

The middle insulation layer 104 may be disposed between the bottom concrete layer 102 and the top concrete layer 106. The middle insulation layer 104 may be pourable organic insulation, rigid foam insulation, blown-in insulation, urethane insulation or the like. The type of insulation material within the middle insulation layer 104 may be selected based on the application and performance requirements of the composite panel 100. The middle insulation layer 104 may fill all or some of the space between the bottom concrete layer 102 and the top concrete layer 106. The middle insulation layer 104 may include a lower thermal conductivity than the bottom concrete layer 102 and the top concrete layer 106. The middle insulation layer 104 may or may not withstand compression loads.

The trusses 108 may be a structural reinforcement in the composite panel 100. The trusses 108 may tie together the bottom concrete layer 102 and the top concrete layer 106 through the middle insulation layer 104.

The composite panel 100 may be further understood with reference to one or more dimensions. The Dimension A references the longitudinal length of the composite panel 100. The Dimension B references the width of the composite panel 100. The Dimension C references the thickness of the composite panel 100. The Dimension D references the thickness of the bottom concrete layer 102 and/or the top concrete layer 106. The Dimension E references the thickness of the middle insulation layer 104. The Dimension F references the length of the trusses 108. The Dimension G references the width between adjacent of the trusses 108. The Dimension H references the thickness between the longitudinal reinforcement members 1904.

The trusses 108 may be spaced along the length and across the width of the composite panel 100. The trusses 108 may be spaced along the longitudinal length Dimension A of the composite panel 100 and across the width Dimension B of the composite panel 100. The trusses 108 may be aligned along the longitudinal length of the composite panel 100. The Dimension G references the distance between trusses 108 and may be closely aligned with the longitudinal reinforcement members 1904. The trusses 108 may extend a select length (e.g., Dimension F) along the longitudinal length of the composite panel 100. For example, the trusses 108 may extend longitudinally from end-to-end of the composite panel 100. For instance, the truss webs 112 and/or the longitudinal reinforcement members 1904 of the trusses 108 may extend longitudinally from end-to-end of the composite panel 100. By way of another example, the trusses 108 may not individually span longitudinally from end-to-end of the composite panel 100 but which may cooperatively span longitudinally from end-to-end of the composite panel 100 with series of sections of the trusses 108 abutting or nearly abutting each other along the longitudinal span. For instance, the series of sections of the trusses 108 may each include the truss webs 112 and/or the longitudinal reinforcement members 1904.

The longitudinal reinforcement members 1904 may be metal members, composite members, prestress strands 110 (e.g., steel prestress strand), rebar (e.g., steel rebar, fiberglass rebar, basalt rebar), post-stress strands, wires, bars, tubes, plates, mesh, metal grids, or the like. The discussion of the prestress strands 110 is incorporated herein by reference in the entirety as to the longitudinal reinforcement members 1904. In embodiments, the prestress strands 110 are steel rebar.

The longitudinal reinforcement members 1904 may longitudinally reinforce the trusses 108. The longitudinal reinforcement members 1904 may be embedded within the bottom concrete layer 102 and the top concrete layer 106. For example, the longitudinal reinforcement members 1904 may be centered within a thickness of the bottom concrete layer 102 and the top concrete layer 106. The bottom concrete layer 102 and the top concrete layer 106 in combination with the longitudinal reinforcement members 1904 may act as a top and bottom chord member and/or inside and outside chord member of the trusses 108. The trusses 108 may act as tension elements and/or compression elements between the bottom concrete layer 102, the top concrete layer 106, and/or the longitudinal reinforcement members 1904.

The truss webs 112 may transversely reinforce the trusses 108. The truss webs 112 may be aligned with the longitudinal reinforcement members 1904 of the composite panel 100 in the bottom concrete layer 102 and the top concrete layer 106. In some cases, additional of the longitudinal reinforcement members 1904 may be disposed in the bottom concrete layer 102 and/or the top concrete layer 106 as needed for engineering design and load requirements. The longitudinal reinforcement members 1904 and the truss webs 112 may be in the same plane or different planes. The longitudinal reinforcement members 1904 and the truss webs 112 may be located above, below, inside, or outside each other. The longitudinal reinforcement members 1904 may be located near and parallel to the truss webs 112. The truss webs 112 may transversely extend between and couple the longitudinal reinforcement members 1904 disposed in the bottom concrete layer 102 and the top concrete layer 106.

The truss webs 112 may be aligned at one or more angles relative to the longitudinal reinforcement members 1904. The angle of the truss webs 112 relative to the longitudinal reinforcement members 1904 may be at any angle from 1 degree, to 90 degrees. Practically the angles could be 30 degrees, 45 degrees, 60 degrees, 90 degrees, but any angle or fraction thereof is possible. The truss webs 112 can be set at any angle to facilitate transferring the shear or delamination forces between the bottom concrete layer 102 and the top concrete layer 106. The truss webs 112 may be set at different angles to meet design requirements. For example, a first set of legs of the truss webs 112 may be set at 30 degrees relative to the longitudinal reinforcement members 1904 and a second set of legs of the truss webs 112 could be the same or set at a different angle such as 45 degrees, 90 degrees, or the like relative to the longitudinal reinforcement members 1904. Thus, the truss webs 112 may include diagonal web members and/or vertical web members. The angles of the truss webs 112 may define the configuration of the trusses 108. For example, the trusses 108 may be configured as a Howe truss, a Pratt truss, a Warren truss, a ladder truss, a Vierendeel truss, a Mansard truss, combinations thereof, or the like.

The truss webs 112 may be bisected truss webs 112c. The bisected truss webs 112c may include top segments 113a-1, bottom segments 113a-2, and resin blocks 1902. The bisected truss webs 112c may be considered bisected, by the resin blocks 1902 bisecting between the top segments 113a-1 and the bottom segments 113a-2. The truss webs 112 may carry tension loads, compression loads, and/or shear loads between the bottom concrete layer 102 and the top concrete layer 106 through the top segments 113a-1, the bottom segments 113a-2, and the resin blocks 1902.

The top segments 113a-1 and the bottom segments 113a-2 may each couple to the longitudinal reinforcement members 1904. The top segments 113a-1 may couple to the longitudinal reinforcement members 1904 disposed in the top concrete layer 106. The bottom segments 113a-2 may couple to the longitudinal reinforcement members 1904 disposed in the bottom concrete layer 102.

The truss webs 112 (e.g., top segments 113a-1 and the bottom segments 113a-2 of the truss webs 112) and the longitudinal reinforcement members 1904 may be coupled in any suitable manner. The truss webs 112 and the longitudinal reinforcement members 1904 may be coupled by a weld, by the concrete material in the bottom concrete layer 102 and the top concrete layer 106, and/or by the joints 114. For example, the truss webs 112 may mechanically attach to the longitudinal reinforcement members 1904 by the welds, by being embedded int eh concrete material, by the joints 114, or the like.

In embodiments, the truss webs 112 may couple with the longitudinal reinforcement members 1904 by mechanically attaching to the longitudinal reinforcement members 1904. The top segments 113a-1 and the bottom segments 113a-2 may be coupled to the longitudinal reinforcement members 1904 disposed in respective of the top concrete layer 106 and the bottom concrete layer 102 by being welded to the longitudinal reinforcement members 1904 disposed in respective of the top concrete layer 106 and the bottom concrete layer 102.

In embodiments, the truss webs 112 may couple with the longitudinal reinforcement members 1904 through the concrete material in the bottom concrete layer 102 and/or the top concrete layer 106. The concrete material may couple together the truss webs 112 and the longitudinal reinforcement members 1904. The top segments 113a-1 and the bottom segments 113a-2 may be coupled to the longitudinal reinforcement members 1904 disposed in respective of the top concrete layer 106 and the bottom concrete layer 102 by embedding the top segments 113a-1 and the bottom segments 113a-2 in respective of the top concrete layer 106 and the bottom concrete layer 102.

In embodiments, the joints 114 may join the truss webs 112 with the longitudinal reinforcement members 1904. The top segments 113a-1 and the bottom segments 113a-2 may be coupled to the longitudinal reinforcement members 1904 disposed in respective of the top concrete layer 106 and the bottom concrete layer 102 by the joints 114 joining the top segments 113a-1 and the bottom segments 113a-2 with the longitudinal reinforcement members 1904 disposed in respective of the top concrete layer 106 and the bottom concrete layer 102. The joints 114 may extend into the middle insulation layer 104, the bisected truss webs 112c do not extend into the bottom concrete layer 102 and/or the top concrete layer 106, the bisected truss webs 112c may be coupled to the joints 114 in the middle insulation layer 104, and/or a thermal conductivity of the joints 114 may be less than a thermal conductivity of the bisected truss webs 112c. The joints 114 may not extend into the middle insulation layer 104, the bisected truss webs 112c may extend into the bottom concrete layer 102 and the top concrete layer 106, the bisected truss webs 112c may be coupled to the joints 114 in the bottom concrete layer 102 and the top concrete layer 106, and/or a thermal conductivity of the bisected truss webs 112c may be less than a thermal conductivity of the joints 114. The joints 114 may be the double-ended hook joints 114a and/or the lock joints 114b. The lock joints 114b may be locked to at least one of the longitudinal reinforcement members 1904 or the bisected truss webs 112c. The lock joints 114b may be the truss lock joints 114b-1, the hanger lock joints 114b-2, and/or the double-ended hook lock joints 114b-3. In embodiments, lock joints 114b are the truss lock joints 114b-1. The hook end 702 of the truss lock joints 114b-1 may couple to the longitudinal reinforcement members 1904, the hub end 704 may couple to the bisected truss webs 112c, and/or the truss lock joints 114b-1 may be locked to the bisected truss webs 112c. In embodiments, lock joints 114b are the hanger lock joints 114b-2. The longitudinal reinforcement members 1904 may be by the bend portion of the hanger lock joints 114b-2 between the pair of plate portions 806, the bisected truss webs 112c may be wound around the hub 804, and/or the hanger lock joints 114b-2 may be locked to the bisected truss webs 112c. In embodiments, lock joints 114b are the double-ended hook lock joints 114b-3. The double-ended hook lock joints 114b-3 may be locked to the longitudinal reinforcement members 1904.

The top segments 113a-1 and the bottom segments 113a-2 of the bisected truss webs 112c may be made of steel, stainless steel, another metal, composites, or the like. For example, the top segments 113a-1 and the bottom segments 113a-2 may be tension wires, rebar (e.g., steel rebar, fiberglass rebar, basalt rebar), or the like. In embodiments, the top segments 113a-1 and the bottom segments 113a-2 may be tension wires which do not carry compressive forces between the bottom concrete layer 102, the resin blocks 1902, and the top concrete layer 106. In embodiments, the top segments 113a-1 and the bottom segments 113a-2 may be rebar which carries compressive forces between the bottom concrete layer 102, the resin blocks 1902, and the top concrete layer 106. The top segments 113a-1 and the bottom segments 113a-2 may have a round, square, rectangular, or other geometric cross-section. The top segments 113a-1 and a bottom segments 113a-2 may or may not be the same material. The material of the top segments 113a-1 and the bottom segments 113a-2 may be thermally conductive.

The top segments 113a-1 and the bottom segments 113a-2 may be embedded within the top concrete layer 106 and the bottom concrete layer 102, respectively, with at least one of the top segments 113a-1 or the bottom segments 113a-2 embedded within the middle insulation layer 104. For example, the top segments 113a-1 may be embedded within the top concrete layer 106 and the middle insulation layer 104. The top segments 113a-1 may thermally conduct between the top concrete layer 106 and the middle insulation layer up to the depth of the top segments 113a-1 in the middle insulation layer 104. By way of another example, the bottom segments 113a-2 may be embedded within the bottom concrete layer 102 and the middle insulation layer 104. The bottom segments 113a-2 may thermally conduct between the bottom concrete layer 102 and the middle insulation layer 104 up to the depth of the bottom segments 113a-2 in the middle insulation layer 104.

The resin blocks 1902 may bisect between and couple the top segments 113a-1 and the bottom segments 113a-2. The resin blocks 1902 may be formed over a portion of the top segments 113a-1 and the bottom segments 113a-2, to form the coupling.

The resin blocks 1902 may act as a thermal insulator and a structural tensile and/or compressive member of the bisected truss webs 112c. The resin blocks 1902 may be non-thermally conductive. The resin blocks 1902 may be non-conductive or low thermal conductivity. For example, thermal conductivities of the resin blocks 1902 may be less than thermal conductivities of the top segments 113a-1 and less than thermal conductivities of the bottom segments 113a-2.

The bisected truss webs 112c may define a gap within the resin blocks 1902 providing a thermal break between the end sections 1906 and/or the looped sections 1908 of the top segments 113a-1 and the bottom segments 113a-2. The gap may be filled with the resin blocks 1902. Filling the gap with the resin blocks 1902 may enable the coupling while providing the thermal discontinuity between the top segments 113a-1 and the bottom segments 113a-2. The bisected truss webs 112c may be thermally discontinuous between the bottom concrete layer 102 and the top concrete layer 106. For example, the top segments 113a-1 and the bottom segments 113a-2 may be separated by the resin blocks 1902. The resin blocks 1902 coupling the top segments 113a-1 and the bottom segments 113a-2 may cause the thermal discontinuity of the bisected truss webs 112c between the bottom concrete layer 102 and the top concrete layer 106. The thermal discontinuity may also be referred to as a thermal break. The resin blocks 1902 may reduce the thermal transfer of energy between the bottom concrete layer 102 and the top concrete layer 106. The distance between the top segments 113a-1 and the bottom segments 113a-2 and/or the length of the resin blocks 1902 may control the thermal resistance/efficiency of the trusses 108 and/or the composite panel 100. The distance may be increased to provide greater thermal resistance between the bottom concrete layer 102 and the top concrete layer 106, thereby increasing the thermal efficiency of the composite panel 100. The distance may be selected based on the amount of thermal resistance required for the use, code, location, and any other factors required of the composite panel 100.

The resin blocks 1902 may be disposed in the middle insulation layer 104 of the composite panel 100. The resin blocks 1902 may or may not be centered in the middle insulation layer 104. The resin blocks 1902 may be disposed completely within the middle insulation layer 104 or disposed partially within the middle insulation layer 104 and partially within the bottom concrete layer 102 and/or partially within the top concrete layer 106.

The resin blocks 1902 may also be referred to as resin pucks. The resin blocks 1902 may include a select shape. A cross-sectional shape of the resin blocks 1902 may be round, square, rectangular, elliptical, spherical or others as needed to attach to the top segments 113a-1 and the bottom segments 113a-2, while providing the thermal discontinuity. The ends of the resin blocks 1902 may be rounded, squared off, chamfered, spherical as needed to facilitate molding of the resin blocks 1902.

The resin blocks 1902 may include a resin material. The resin material may include a low thermal conductivity. The resin material may be a thermoset or thermoplastic resin. For example, the resin blocks 1902 may include any suitable resin material, such as, but not limited to, vinyl ester resin, polyester resin, phenolic resins, nylon resin, polypropylene, polyethylene, thermoplastic polyurethane, and/or other resins. It is contemplated that the resin material being the thermoset may be beneficial to ensure the resin material does not turn elastic when the bottom concrete layer 102, the middle insulation layer 104, and/or the top concrete layer 106 exhibit an exothermic reaction when curing.

The resin blocks 1902 may also include fibers which are disposed in the resin material and separate from the top segments 113a-1 and the bottom segments 113a-2. The fibers may reinforce the resin material. The fibers may be may be any suitable fibers, such as, but not limited to, glass fibers, carbon fibers, basalt fibers, aramid fibers (e.g., Kevlar™), organic fibers such as hemp, a combination thereof, or other reinforcing fibers. In embodiments, the fibers may be glass-fibers and the resin blocks 1902 may be a glass-fiber-reinforced resin.

The top segments 113a-1 and the bottom segments 113a-2 may include end sections 1906 and/or looped sections 1908. The end sections 1906 may be the end of the members defining the top segments 113a-1 and the bottom segments 113a-2. The looped sections 1908 may be along the middle of the members defining the top segments 113a-1 and the bottom segments 113a-2.

The top segments 113a-1 and the bottom segments 113a-2 may couple with the resin blocks 1902 using the end sections 1906 and/or looped sections 1908. The end sections 1906 and/or the looped sections 1908 may mechanically bond with the resin blocks 1902. The mechanical bond between the resin blocks 1902 and one of the end sections 1906 or the looped sections 1908 may provide the coupling between the resin blocks 1902 and the top segments 113a-1 and/or between the resin blocks 1902 and the bottom segments 113a-2. The length, diameter, and/or shape of the end sections 1906 and/or the looped sections 1908 may be selected based on the dimensions of the truss webs 112, the loads on the truss webs 112, factors of safety, and the like.

The composite panel 100 with the bisected truss webs 112c may have a failure mode through yielding of the top segments 113a-1 and bottom segments 113a-2, and not have a failure mode of yielding of the resin blocks 1902, the end sections 1906, and/or the looped sections 1908. In this regard, tensile and compressive strengths of the top segments 113a-1 and the bottom segments 113a-2 may be less than respective of the tensile and compressive strengths of the resin blocks 1902, the end sections 1906, and/or the looped sections 1908. The failure mode through yielding of the top segments 113a-1 and bottom segments 113a-2 may make the bisected truss webs 112c more reliable and ductile, a key design feature engineers in high load conditions look for such as FEMA shelters, coastal hurricane resistance and seismic design. The trusses 108 may offer a ductile metal yielding failure mode while being thermally nonconductive.

The layers may include various thicknesses. The thickness of the composite panel 100 is Dimensioned C. The thickness of the composite panel 100 may be between 15 cm and 150 cm (e.g., between approximately 6″ and 60″), or greater. For example, the thickness of the composite panel 100 may be between 60 cm and 120 cm (e.g., between approximately 24″ and 48″). The thickness of the bottom concrete layer 102 and the top concrete layer 106 are dimensioned D. The thickness of the bottom concrete layer 102 and the top concrete layer 106 may be the same on both sides of middle insulation layer 104 or may be different. Similarly, the thickness of the middle insulation layer 104 may be the same or different than the thickness of the bottom concrete layer 102 and the top concrete layer 106. The thicknesses of the bottom concrete layer 102, the middle insulation layer 104, and/or the top concrete layer 106 may be between 2 cm and 140 cm (e.g., between approximately 1″ and 56″), or greater. The bisected truss webs 112c embedded within the bottom concrete layer 102, the middle insulation layer 104, and the top concrete layer 106 may enable increasing the thickness of the middle insulation layer 104 relative to the bottom concrete layer 102 and relative to the top concrete layer 106. For example, the thickness of the middle insulation layer 104 may be between 15 cm and 106 cm (e.g., between approximately 6″ and 42″). For instance, the middle insulation layer 104 may be between 15 cm and 30 cm (e.g., between approximately 6″ and 12″). By way of another instance, the thickness of the middle insulation layer 104 may be between 45 cm and 106 cm (e.g., between approximately 18″ and 42″).

The middle insulation layer 104 may include U-Values and/or R-values per unit area. For example, the middle insulation layer 104 may include U-Values per unit area (heat transfer coefficient) between 0.033 W/m²K and 0.01 W/m²K and/or R-Values per unit area (thermal resistance) of between 30 m²·K/W and 100 m²·K/W.

The bisected truss webs 112c embedded within the bottom concrete layer 102, the middle insulation layer 104, and the top concrete layer 106 may enable increasing the longitudinal span of the composite panel 100. For example, longitudinal span of the composite panel 100 may be between 15 m and 30 m (e.g., between approximately 50 ft and 100 ft).

FIGS. 19A-19C depicts the composite panel 100, in accordance with one or more embodiments of the present disclosure. In this example, the composite panel 100 includes the trusses 108 which extend longitudinally from end-to-end of the composite panel 100. Further in this example, the composite panel 100 includes the top segments 113a-1 and the bottom segments 113a-2 with the end sections 1906 by which the top segments 113a-1 and the bottom segments 113a-2 couple with the resin blocks 1902. Further in this example, the bottom concrete layer 102 and the top concrete layer 106 are the same thickness. This configuration with the same thickness may be used in a horizontal application but would more likely be used as a vertical wall member. Further in this example, the trusses 108 are configured as a Warren truss, although this is not intended to be limiting.

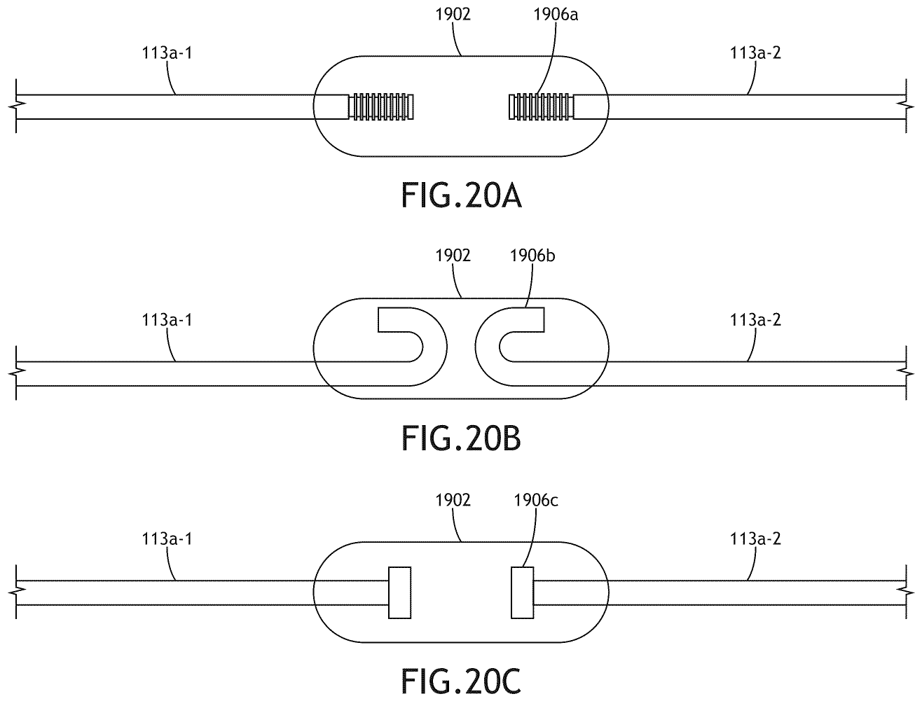

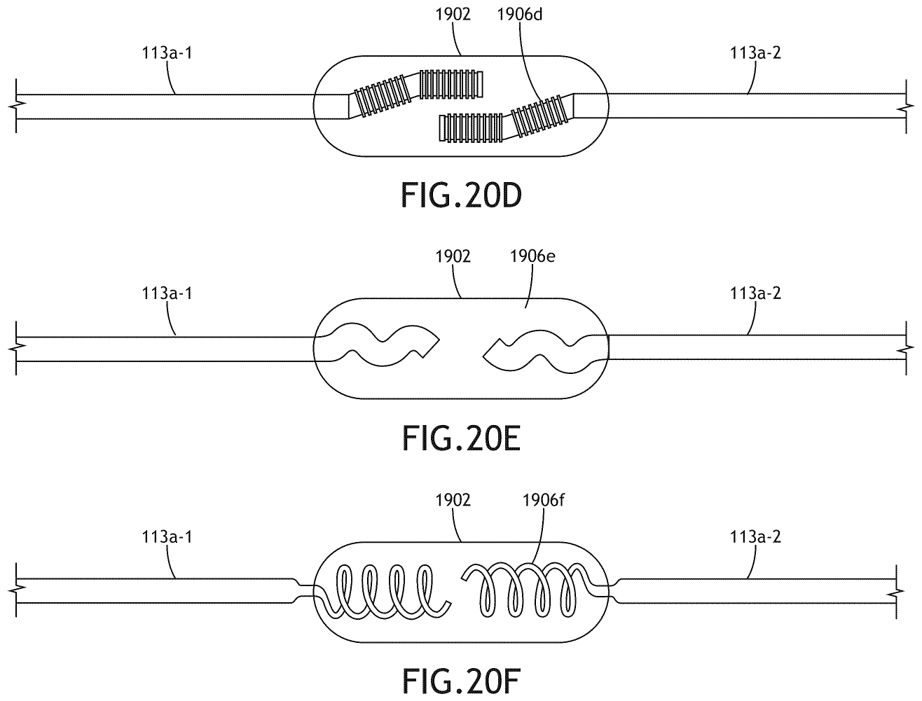

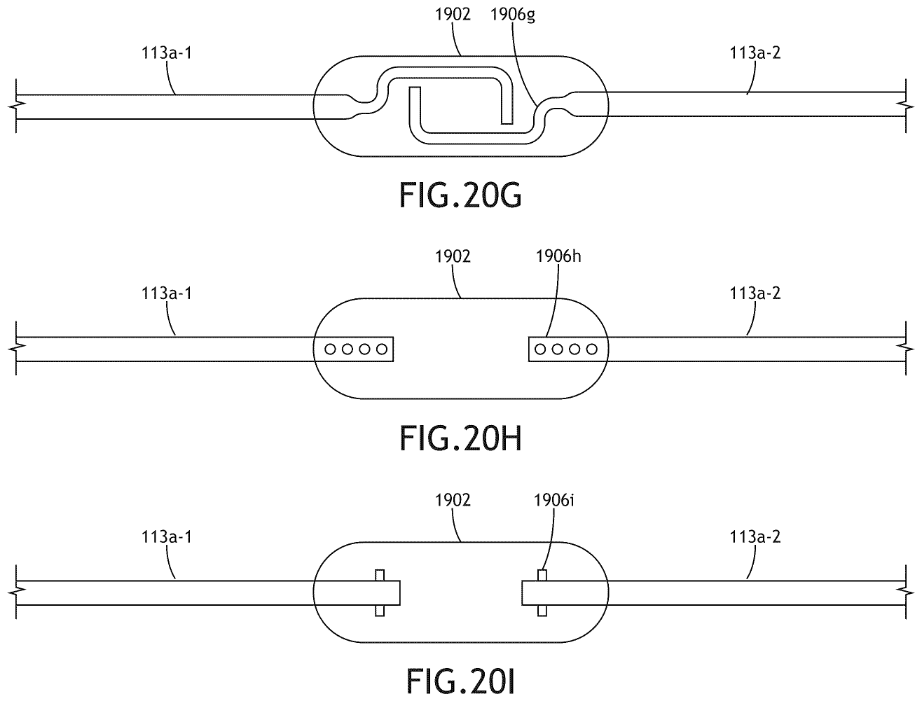

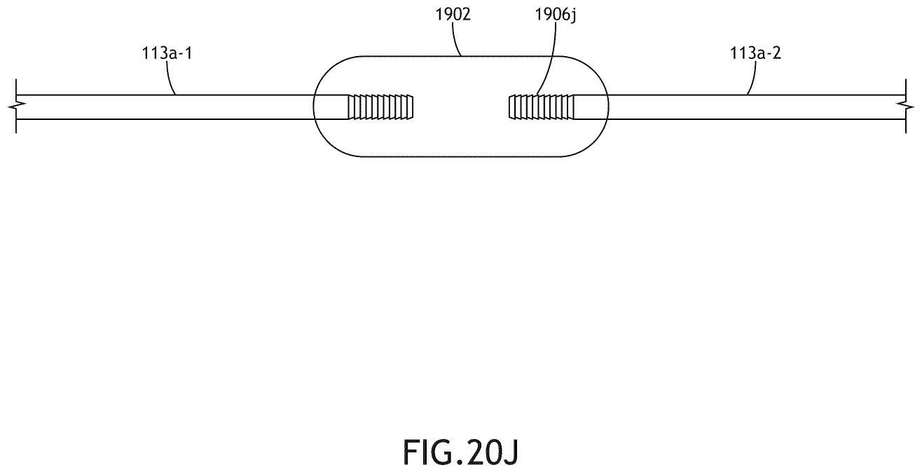

FIGS. 20A-20J depict the end sections 1906, in accordance with one or more embodiments of the present disclosure. The end sections 1906 may include any shape, such as, but not limited to, roughened end sections 1906a, hooked end sections 1906b, mushroom-headed end sections 1906c, offset-bent end sections 1906d, zigzag end sections 1906e, twisted end sections 1906f, C-shaped end sections 1906g, perforated end sections 1906h, T-shaped end sections 1906i, barbed end sections 1906j, or the like. The end sections 1906 may be bent, deformed, hooked, studded, pressed, rolled, or undergo another manufacturing process to form any of the various shapes.

Any of the various shapes (e.g., the roughened end sections 1906a, hooked end sections 1906b, mushroom-headed end sections 1906c, offset-bent end sections 1906d, zigzag end sections 1906e, twisted end sections 1906f, C-shaped end sections 1906g, perforated end sections 1906h, T-shaped end sections 1906i, barbed end sections 1906j) of the end sections 1906 may be combined. Combinations of the shapes may add to the mechanical bond between the end sections 1906 and the resin blocks 1902. The tension and/or compression capacity of the trusses 108 may therefore be increased. Various permutations are contemplated. For example, the end sections 1906 may include a combination of the roughened end sections 1906a with any of the hooked end sections 1906b, zigzag end sections 1906e, twisted end sections 1906f, C-shaped end sections 1906g, or the like. By way of another example, the end sections 1906 may include a combination of the hooked end sections 1906b and the zigzag end sections 1906e. By way of another example, the end sections 1906 may include a combination of the mushroom-headed end sections 1906c with any of the offset-bent end sections 1906d, zigzag end sections 1906e, or the like.

FIG. 20A depicts the roughened end sections 1906a, in accordance with one or more embodiments of the present disclosure. The roughened end sections 1906a may be a deformed end where grooves are cut or compressed into the end sections 1906. The roughened end sections 1906a may be roughened by any suitable process. For example, the roughened end sections 1906a may be roughened by cutting or pressing grooves, threads, knurling, deformations, or other means to roughen the roughened end sections 1906a.

FIG. 20B depicts the hooked end sections 1906b, in accordance with one or more embodiments of the present disclosure. The hooked end sections 1906b may be a hook bent into the end sections 1906. The hooked end sections 1906b may include a J-shape. The hooked end sections 1906b may be bent such that the end of the hooked end sections 1906b are parallel to and/or touching the segments 113.

FIG. 20C depicts the mushroom-headed end sections 1906c, in accordance with one or more embodiments of the present disclosure. The mushroom-headed end sections 1906c may be formed into a mushroom, button, or headed stud shape. The mushroom-headed end sections 1906c may be cylindrical headed, conical headed, or the like.

FIG. 20D depicts the offset-bent end sections 1906d, in accordance with one or more embodiments of the present disclosure. The offset-bent end sections 1906d may be roughened by cutting or pressing grooves, threads, knurling, deformations, or other means to roughen the end sections 1906. The offset-bent end sections 1906d provides an area to create bond between the end sections 1906 and the resin blocks 1902.

FIG. 20E depicts the zigzag end sections 1906e, in accordance with one or more embodiments of the present disclosure. The zigzag end sections 1906e may be bent to form the zigzag shape. The zigzag shape may be in-plane of the resin blocks 1902.

FIG. 20F depicts the twisted end sections 1906f, in accordance with one or more embodiments of the present disclosure. The twisted end sections 1906f may be bent to form a corkscrew shape. The corkscrew shape may be out-of-plane of the resin blocks 1902. The corkscrew shape may also be referred to as a spiral shape. The corkscrew shape may have a select handedness. The handedness of the twisted end sections 1906f of the top segments 113a-1 and the bottom segments 113a-2 may or may not be the same.

FIG. 20G depicts the C-shaped end sections 1906g, in accordance with one or more embodiments of the present disclosure. The C-shaped end sections 1906g may be a double “C” hook bend. Some, all, or none of the C-shaped end sections 1906g may be roughened by cutting or pressing grooves, threads, knurling, deformations, or other means to roughen the end allowing for a mechanical bond between the end sections 1906 and the resin blocks 1902.

FIG. 20H depicts the perforated end sections 1906h, in accordance with one or more embodiments of the present disclosure. The perforated end sections 1906h may include a series of openings cut in the perforated end sections 1906h providing a mechanical bond to the resin blocks 1902. The perforated end sections 1906h may be perforated with round, square, or other geometrically shaped holes.

FIG. 20I depicts the T-shaped end sections 1906i, barbed end sections 1906j, in accordance with one or more embodiments of the present disclosure. The T-shaped end sections 1906i may include a “T” shape. The T-shape may extend laterally from the 1906 into the resin blocks 1902.

FIG. 20J depicts the barbed end sections 1906j, in accordance with one or more embodiments of the present disclosure. The barbed end sections 1906j may include a barbed shape.

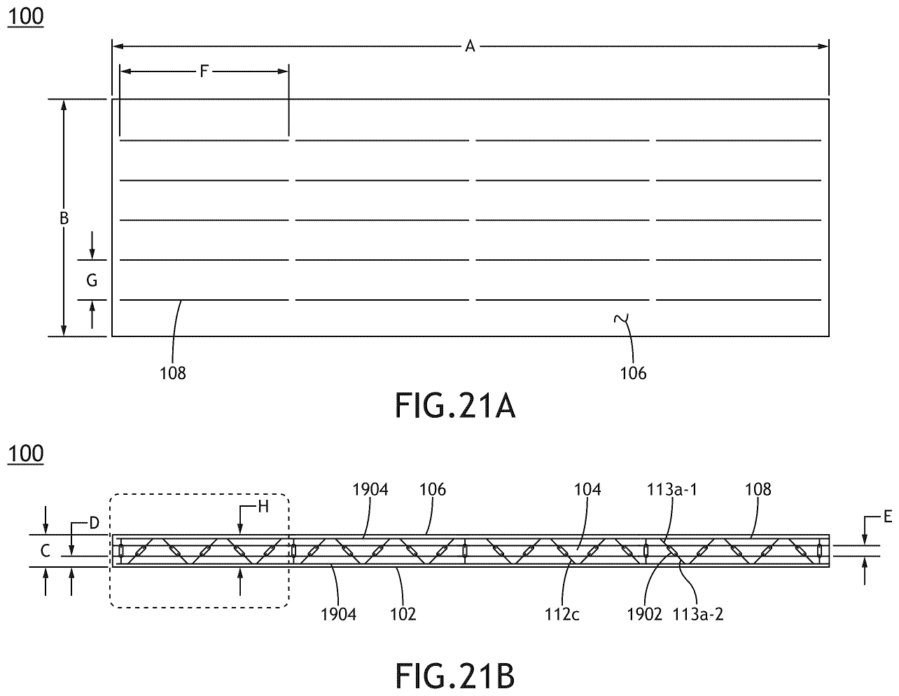

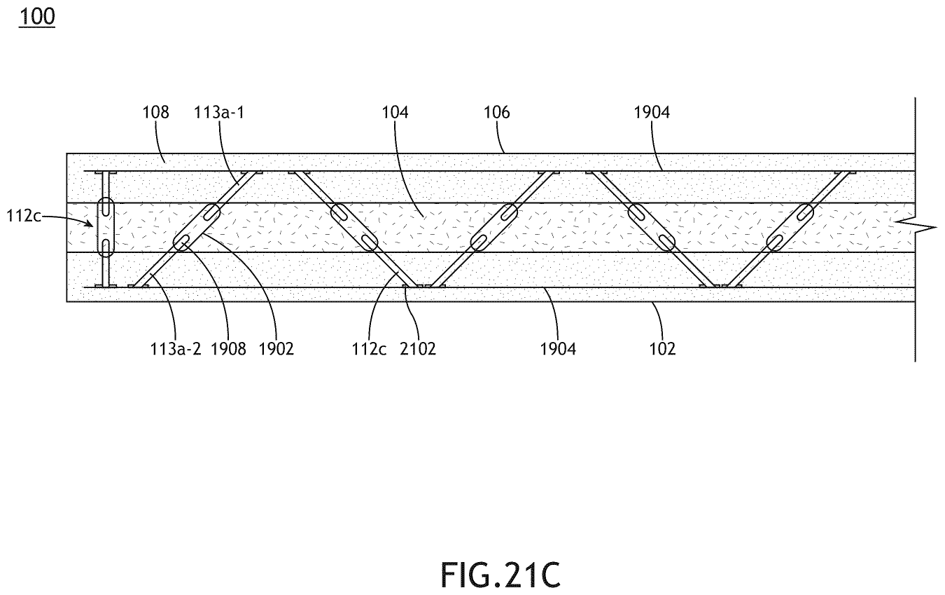

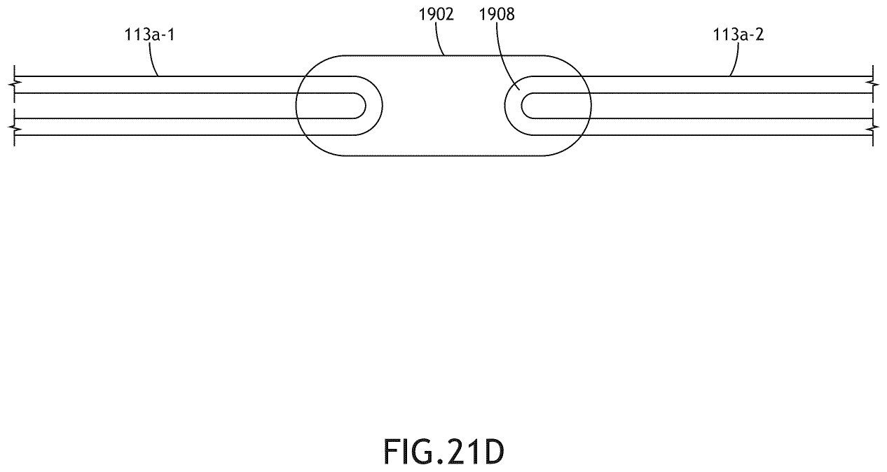

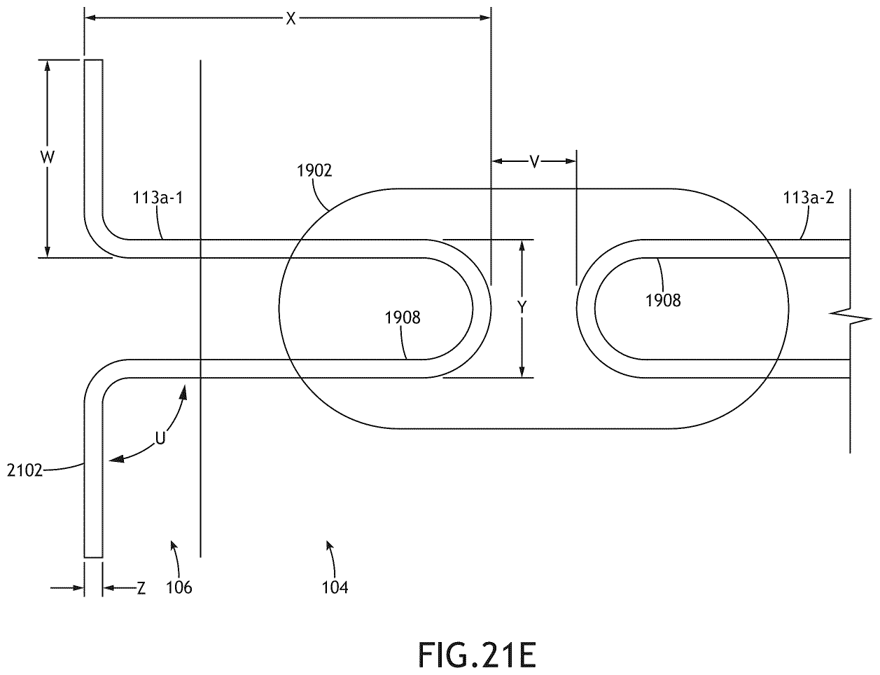

FIGS. 21A-21E depict the composite panel 100, in accordance with one or more embodiments of the present disclosure. In this example, the composite panel 100 includes the trusses 108 may be made in sections which cooperatively span the longitudinal length of the composite panel 100. Further in this example, the composite panel 100 includes the top segments 113a-1 and the bottom segments 113a-2 with the looped sections 1908 by which the top segments 113a-1 and the bottom segments 113a-2 couple with the resin blocks 1902. The looped sections 1908 may also be referred to as a double wire with a “U” bend, a bight, or the like. The looped sections 1908 may be bend back within the resin blocks 1902, to extend from the resin blocks 1902 in a same direction in which the looped sections 1908 enter the resin blocks 1902. The top segments 113a-1 may be doubled over themselves within the resin blocks 1902, the middle insulation layer 104, and the top concrete layer 106 using the looped sections 1908. Similarly, the bottom segments 113a-2 may be doubled over themselves within the resin blocks 1902, the middle insulation layer 104, and the bottom concrete layer 102 using the looped sections 1908. Doubling over the top segments 113a-1 within the resin blocks 1902 and the top concrete layer 106 and doubling over the bottom segments 113a-2 within the resin blocks 1902 and the bottom concrete layer 102 may double the effective tensile/compressive capacity of the trusses 108, as compared to the trusses 108 with the end sections 1906.

The top segments 113a-1 and/or the bottom segments 113a-2 may also include tail sections 2102. The tail sections 2102 may extend from opposing ends of the looped sections 1908. The tail sections 2102 may be aligned with and/or attached to the longitudinal reinforcement members 1904. The tail sections 2102 may also be aligned with and/or attached to adjacent of the tail sections 2102 in the trusses 108.

The tail sections 2102 may be bent relative to the looped sections 1908 into any configuration or angle 90 degrees, 45 degrees, 60 degrees or other as necessary to align or closely align with the longitudinal reinforcement members 1904. The tail sections 2102 may be bent at an Angle U, relative to the looped sections 1908. The Angle U is depicted as 90 degrees, although this is not intended to be limiting, but could also be any acute or obtuse angle as needed to properly embed the tail sections 2102 within the bottom concrete layer 102 and/or the top concrete layer 106. The tail sections 2102 may include a longitudinal length which is Dimensioned W and/or a cross-sectional width which is Dimensioned Z. The looped sections 1908 may include a length extend from the tail sections 2102 which is Dimensioned X. The looped sections 1908 may include a width between the two halves forming the looped sections 1908 which is Dimensioned Y. The looped sections 1908 may separate the bisected truss webs 112c by the gap which is Dimensioned V.

The looped sections 1908 and/or the tail sections 2102 may also be combined with any of the end sections 1906. For example, the looped sections 1908 may be roughened.

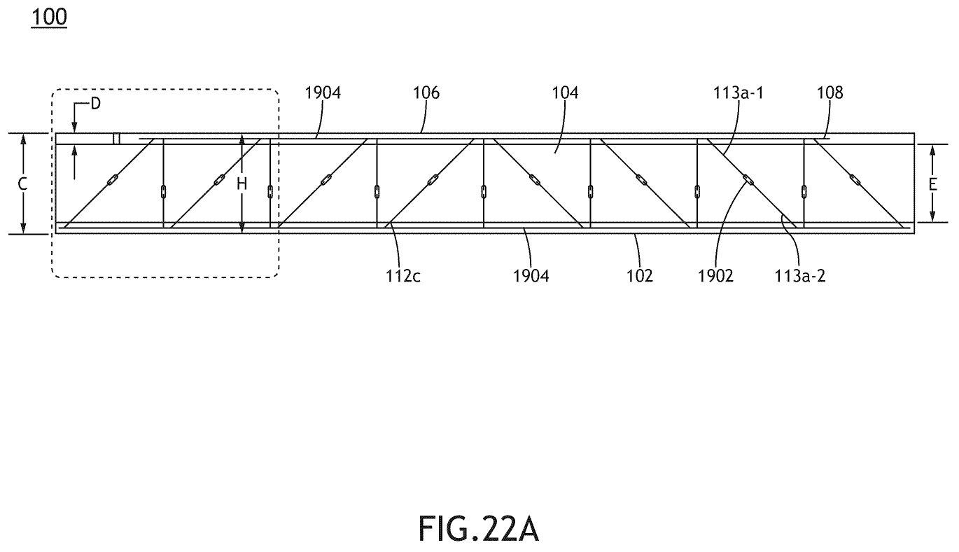

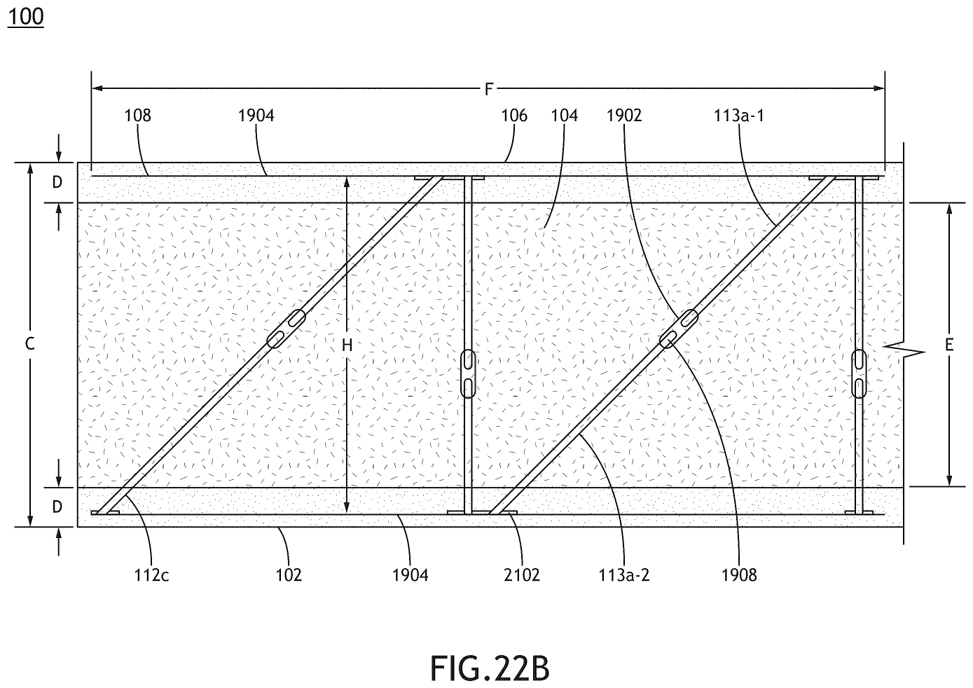

FIGS. 22A-22B depict the composite panel 100, in accordance with one or more embodiments of the present disclosure. In this example, the composite panel 100 is thicker than the composite panel 100 of the previous figures. The middle insulation layer 104 is depicted as much thicker than the bottom concrete layer 102 and the top concrete layer 106. This configuration of relatively thin layers of the bottom concrete layer 102 and the top concrete layer 106 and relatively thicker layer of the middle insulation layer 104 may be used in a horizontal application but a vertical wall member is also possible. The orientation of the drawing is not intended to suggest that the member could only be used in a perfectly horizontal plane, in many cases the roof member could be sloped to allow drainage of rain to collect or be directed over the wall. Further in this example, the trusses 108 are configured as a Howe truss, although this is not intended to be limiting.

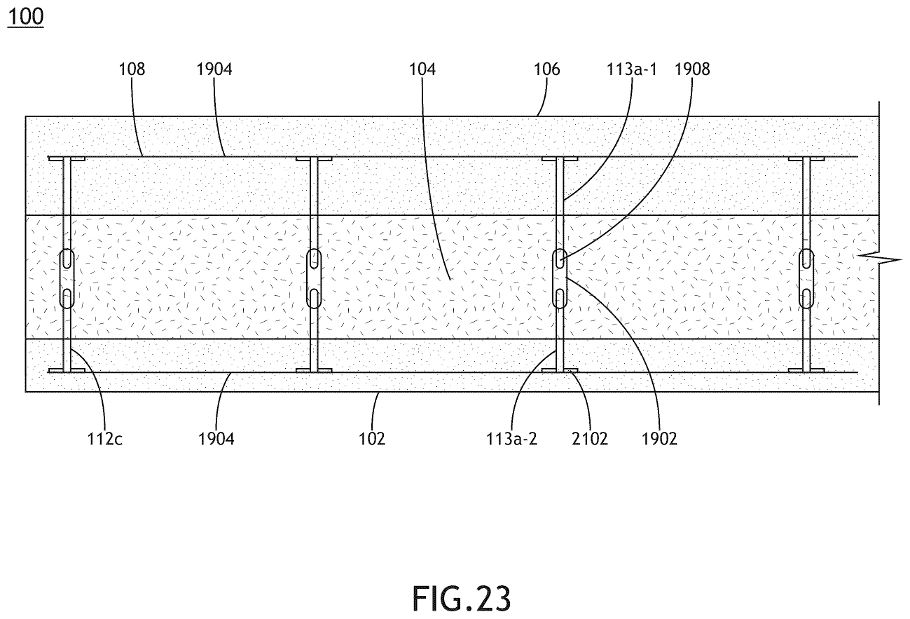

FIG. 23 depicts the composite panel 100, in accordance with one or more embodiments of the present disclosure. In this example, the trusses 108 are configured as a ladder truss. The angle of the truss webs 112 may perpendicular to the longitudinal reinforcement members 1904.

The bottom concrete layer 102 and the top concrete layer 106 may not transfer, or may minimally transfer, shear loading between the bottom concrete layer 102 and the top concrete layer 106. The top concrete layer 106 may resolve loads from wind, dead, live, seismic and the like, while the bottom concrete layer 102 transfers the wind load compression or suction to the top concrete layer 106. The top concrete layer 106 may resolve wind, dead, live, and other loads to the structure (footings, roof structure, floor structure, columns, and beams). The bisected truss webs 112c in the ladder truss may only resolve delamination or compression loading caused by wind suction and pressure on the composite panel 100. The bisected truss webs 112c may bend slightly in shear from thermal movement and the associated thermal loading.

Further in this example, the top concrete layer 106 may be thicker than the bottom concrete layer 102. For instance, the top concrete layer 106 may be at least twice as thick as the bottom concrete layer 102. The top concrete layer 106 may be thicker than the bottom concrete layer 102 to transfer loads from wind, seismic, dead, and live loads to the foundation and structure.

The middle insulation layer 104 may also be thicker than the bottom concrete layer 102 and the top concrete layer 106. This configuration of the composite panel 100 may be used in structures where the thermal gradient is extremely high between the bottom concrete layer 102 and the top concrete layer 106. An example would be refrigerated or freezer building. The middle insulation layer 104 may be much thicker and therefore reduce energy consumption, and eliminate, or reduce the need for a building within a building design, associated with freezer buildings. Thermal movements and associated loads caused by the different temperatures on opposite sides of the composite panel 100 would be minimally transferred between the bottom concrete layer 102 and the top concrete layer 106. This configuration of the composite panel 100 may be ideal for a freezer building where the difference in temperature may reach 40 degrees Celsius (e.g., about 104 degrees Fahrenheit) or more and the thermal movement of the middle insulation layer 104 relative to the bottom concrete layer 102 and/or the top concrete layer 106 may be 75 millimeters (e.g., about 3 inches) or more. Large thermal movements with a Howe truss or a Pratt truss would create extreme bowing and could lead to truss failure. The ladder type truss would minimize the bowing and over stressing of the bisected truss webs 112c.

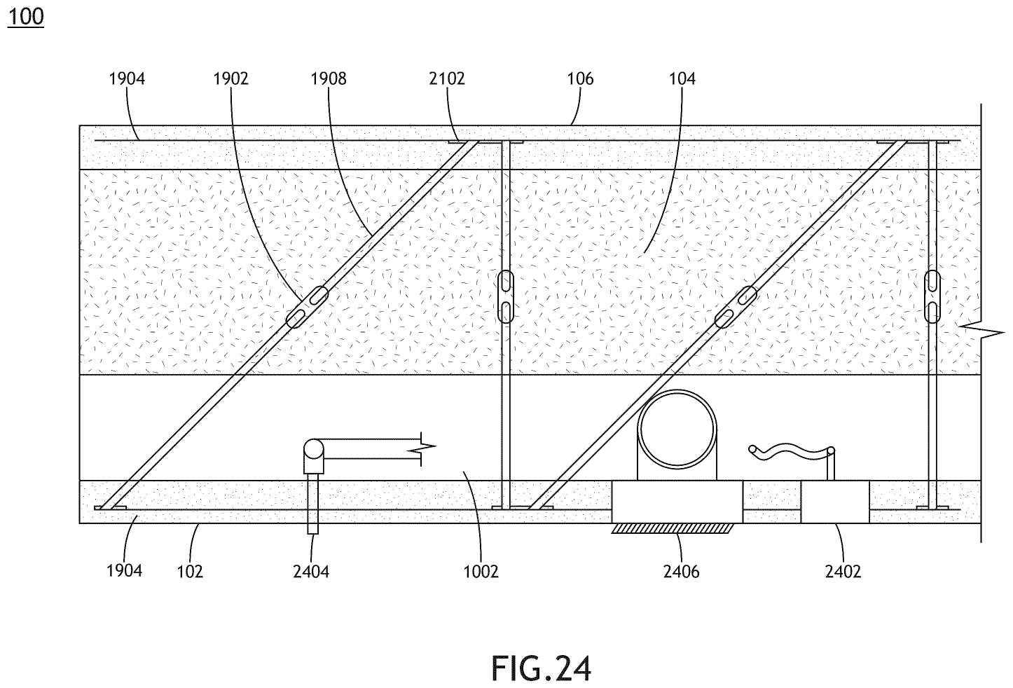

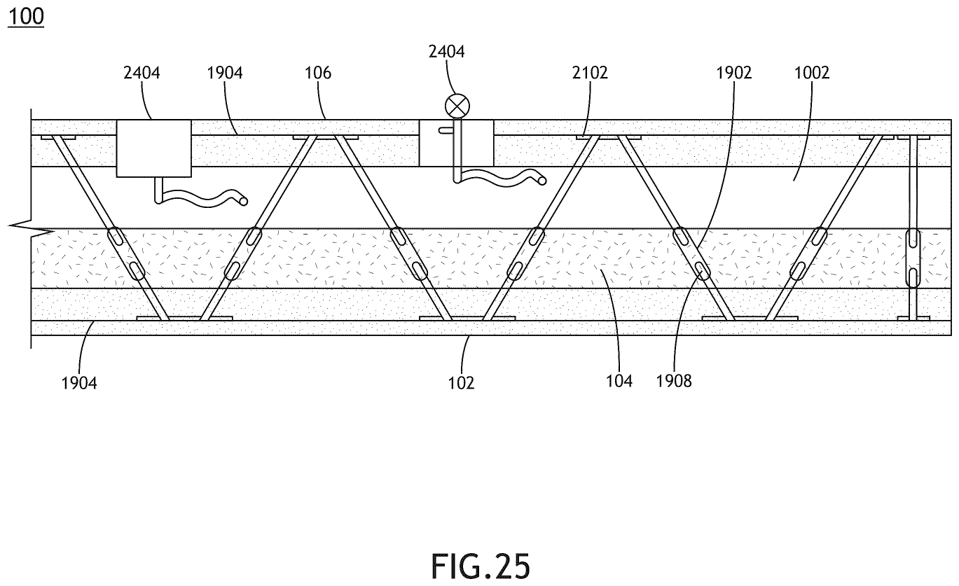

FIGS. 24-25 depict the composite panel 100, in accordance with one or more embodiments of the present disclosure. The composite panel 100 may also be referred to as a composite cavity panel. In embodiments, the composite panel 100 may define the void space 1002. The void space 1002 may be defined between the bottom concrete layer 102 and the top concrete layer 106, between the bottom concrete layer 102 and the middle insulation layer 104, and/or between the middle insulation layer 104 and the top concrete layer 106. The middle insulation layer 104 may be disposed between the void space 1002 and the bottom concrete layer 102 and/or between the top concrete layer 106 and the void space 1002.

The trusses 108 may transversely couple between the bottom concrete layer 102 and the top concrete layer 106 through the void space 1002 and/or the middle insulation layer 104. The resin blocks 1902 may be disposed in the middle insulation layer 104 and/or the void space 1002.

The middle insulation layer 104 may partially fill the volume between the bottom concrete layer 102 and the top concrete layer 106, with the remainder being the void space 1002. The relative thickness of the middle insulation layer 104 to the void space 1002 may shallow, half, or mostly filled depending on the application and use of the composite panel 100. For example, the middle insulation layer 104 may fill 25% of the void space 1002, 50% of the void space 1002, 75% of the void space 1002, or any amount as necessary to meet the demands of the composite panel 100. Furthermore, the composite panel 100 may or may not include the middle insulation layer 104.

The composite panel 100 may also include electrical fixtures 2402, plumbing fixtures 2404, air-handling fixtures 2406, and the like. The electrical fixtures 2402 may include electrical boxes, electrical panels, or the like. The plumbing fixtures 2404 may include sprinklers, water valves, or the like. The air-handling fixtures 2406 may include louvers, ventilation, or the like.

The electrical fixtures 2402, the plumbing fixtures 2404, and/or the air-handling fixtures 2406 may be disposed in the void space 1002 and affixed to one of the bottom concrete layer 102 or the top concrete layer 106. The electrical fixtures 2402, the plumbing fixtures 2404, and/or the air-handling fixtures 2406 may be considered fixtures by being affixed to the bottom concrete layer 102 and/or the top concrete layer 106. The void space 1002 may be beneficial for installing the electrical fixtures 2402, the plumbing fixtures 2404, and/or the air-handling fixtures 2406 after the bottom concrete layer 102, the middle insulation layer 104, and/or the top concrete layer 106 are cured. The advantage of pouring a double layer panel with the void space 1002 is that the electrical fixtures 2402, the plumbing fixtures 2404, and/or the air-handling fixtures 2406 may be added after erection and installation of the composite panel 100. The pulling of electrical wiring from panel-to-panel across the ceiling or floor is an advantage versus the current method of conduit precast in the composite panel 100 where changes and additions are nearly impossible. Furthermore, the insulation material in the middle insulation layer 104 may be added to the composite panel 100 after the composite panel 100 is installed in the system 1200 and the electrical fixtures 2402, the plumbing fixtures 2404, and/or the air-handling fixtures 2406 are installed in the composite panel 100.

The composite panel 100 may also include removable access panels (not depicted). The removable access panels may be defined through the thickness of the bottom concrete layer 102 and/or the top concrete layer 106 to the void space 1002. The removable access panels may enable installation of the electrical fixtures 2402, the plumbing fixtures 2404, and/or the air-handling fixtures 2406.

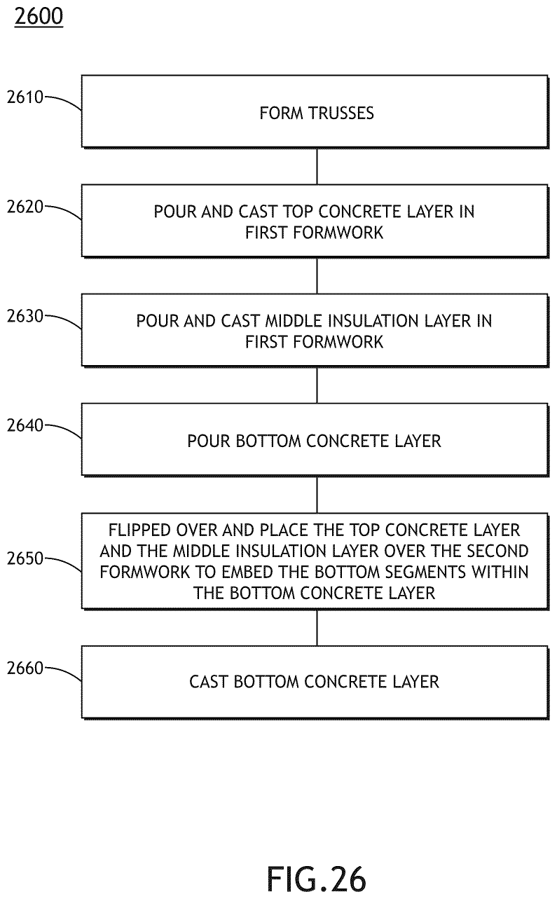

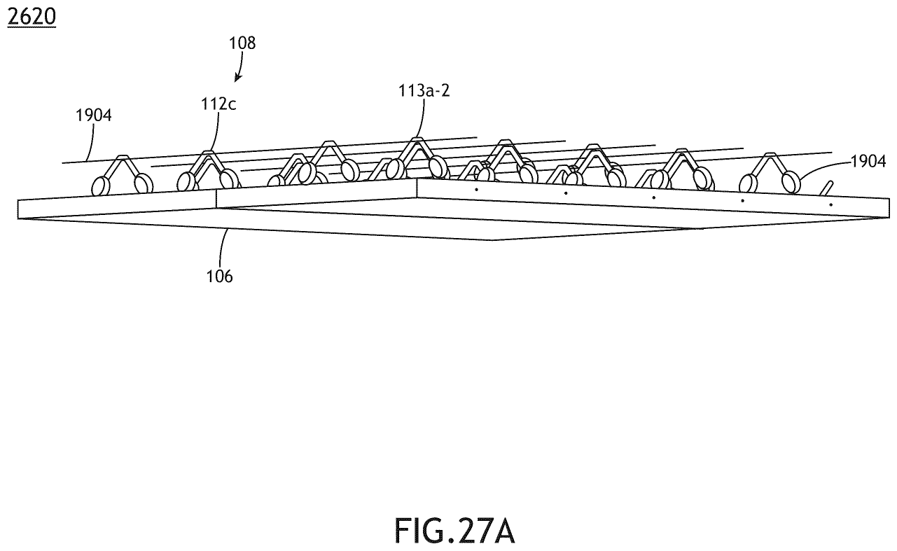

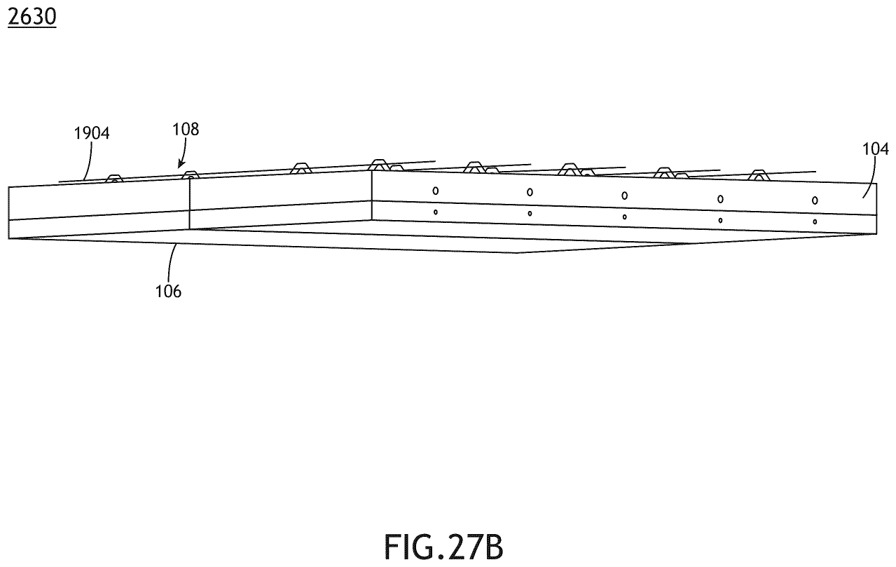

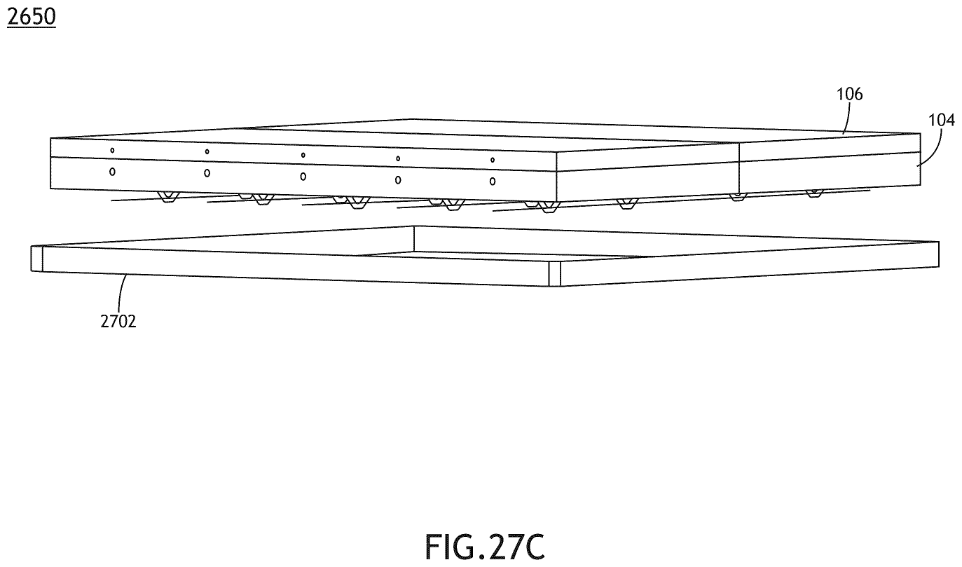

FIG. 26 depicts a flow diagram of a method 2600, in accordance with one or more embodiments of the present disclosure. The embodiments and the enabling technology described previously herein in the context of the composite panel 100 should be interpreted to extend to the method 2600. For example, the method 2600 may be a method of manufacturing the composite panel 100. It is further recognized, however, that the method 2600 is not limited to the composite panel 100. The method 2600 may be further understood with reference to FIGS. 27A-27C.

In a step 2610, trusses may be formed by coupling bisected truss webs and longitudinal reinforcement members. For example, the trusses 108 may be formed by coupling the bisected truss webs 112c and the longitudinal reinforcement members 1904. The top segments 113a-1 and the bottom segments 113a-2 of the bisected truss webs 112c may be welded to the longitudinal reinforcement members 1904. The bisected truss webs 112c may also be formed by coupling the top segments 113a-1 and the bottom segments 113a-2 by the resin blocks 1902. The resin blocks 1902 may be formed by casting resin over the end sections 1906 and/or the 1908 looped sections 1908 of the top segments 113a-1 and the bottom segments 113a-2 in a mold. The longitudinal reinforcement members 1904 being rebar may be beneficial when forming the trusses 108 during the assembly of the composite panel 100 before the concrete layers are cast.

In a step 2620, a top concrete layer may be poured and cast. For example, the top concrete layer 106 may be poured and cast. The top segments 113a-1 of the bisected truss web 112c may be embedded within the top concrete layer 106 as the top concrete layer 106 is poured and cast. The resin blocks 1902 and the bottom segments 113a-2 of the bisected truss webs 112c may be disposed above the top surface of the top concrete layer 106.

In an optional step 2630, a middle insulation layer may be poured onto the top concrete layer and cast. For example, the middle insulation layer 104 may be poured onto the top concrete layer 106 and cast. The resin blocks 1902 of the bisected truss webs 112c may be embedded in the middle insulation layer 104. The middle insulation layer 104 may also be poured such that the void space 1002 is defined and/or the resin blocks 1902 are embedded in the void space 1002.

The top concrete layer 106 and the middle insulation layer 104 may be cast in a first formwork. The top concrete layer 106 and the middle insulation layer 104 may be cast in the formwork in an orientation which is upside down with the orientation in which the top concrete layer 106 is adjoined to the bottom concrete layer 102. The first formwork may define the sides and/or bottom surface of the top concrete layer 106 with the top surface uncovered by the first formwork when casting the top concrete layer 106. The first formwork may define the sides the middle insulation layer 104, the top surface of the top concrete layer 106 may abut the bottom surface of the middle insulation layer 104, and the top surface uncovered by the first formwork when casting the middle insulation layer 104.

In a step 2640, a bottom concrete layer may be poured in a second formwork. For example, the bottom concrete layer 102 may be poured in a second formwork 2702.

In a step 2650, the top concrete layer and the middle insulation layer may be removed from the first formwork, flipped over, and placed over the second formwork to embed the bottom segments within the bottom concrete layer. For example, the top concrete layer 106 and the middle insulation layer 104 may be removed from the first formwork, flipped over, and placed over the second formwork 2702 to embed the bottom segments 113a-2 of the bisected truss web 112c within the bottom concrete layer 102. The top concrete layer 106 and the middle insulation layer 104 may be positioned over the second formwork 2702 using a crane, a vacuum lift system, or the like.

In a step 2660, the bottom concrete layer may be cast in the second formwork. For example, the bottom concrete layer 102 may be cast in the second formwork 2702. The second formwork 2702 may include edge supports (not depicted). The edge supports may support the middle insulation layer 104 and/or the top concrete layer 106 in a fixed position as the bottom concrete layer 102 is cast.

Optionally, the void space 1002 may be defined between the bottom concrete layer 102 and the middle insulation layer 104 by positioning the middle insulation layer 104 at a height above the second formwork as the bottom concrete layer 102 is cast.

Optionally, the void space 1002 may be defined between the bottom concrete layer 102 and the top concrete layer 106 by not casting the middle insulation layer 104 on the top concrete layer 106 in the optional step 2630.

The bottom concrete layer 102, the middle insulation layer 104, and the top concrete layer 106 may each include a select cure time for casting. The formworks may be flat formworks and/or tilting formworks.

Referring generally again to the figures. Any of the various permutations of the composite panels 100 and/or the systems 1200 may include the bottom concrete layers 102, the middle insulation layers 104, the top concrete layers 106, the trusses 108, the prestress strands 110, the truss webs 112, the continuous truss webs 112a, the segmented truss webs 112b, the bisected truss webs 112c, the segments 113, the open-looped segments 113-1, the double-looped segments 113-2, the top segments 113a-1, the bottom segments 113a-2, the joints 114, the double-ended hook joints 114a, the lock joints 114b, the truss lock joints 114b-1, the hanger lock joints 114b-2, the double-ended hook lock joints 114b-3, the windows 1202, the doors 1204, the fasteners 1206, the frames 1208, the grout key 1402, the bottom form plates 1602, the middle form plates 1604, the top form plates 1606, the resin blocks 1902, the longitudinal reinforcement members 1904, the end sections 1906, the roughened end sections 1906a, the hooked end sections 1906b, the mushroom-headed end sections 1906c, the offset-bent end sections 1906d, the zigzag end sections 1906e, the twisted end sections 1906f, the C-shaped end sections 1906g, the perforated end sections 1906h, the T-shaped end sections 1906i, the barbed end sections 1906j, the looped sections 1908, the tail sections 2102, the electrical fixtures 2402, the plumbing fixtures 2404, and/or the air-handling fixtures 2406 which may be used together or independently.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A composite panel comprising:
a bottom concrete layer;
a top concrete layer;
a middle insulation layer, wherein the middle insulation layer is disposed between the bottom concrete layer and the top concrete layer, wherein the bottom concrete layer, the middle insulation layer, and the top concrete layer extend along a longitudinal span of the composite panel; and
a plurality of trusses, wherein the plurality of trusses comprise:
a plurality of longitudinal reinforcement members, wherein the plurality of longitudinal reinforcement members are disposed in the bottom concrete layer and the top concrete layer; and
a plurality of bisected truss webs, wherein the plurality of bisected truss webs transversely extend between the bottom concrete layer and the top concrete layer, wherein the plurality of bisected truss webs comprise:
a plurality of top segments;
a plurality of bottom segments, wherein the plurality of top segments and the plurality of bottom segments couple to the plurality of longitudinal reinforcement members disposed in respective of the top concrete layer and the bottom concrete layer; and
a plurality of resin blocks, wherein the plurality of resin blocks are disposed in the middle insulation layer and couple the plurality of top segments and the plurality of bottom segments.

2. The composite panel of claim 1, wherein the composite panel is at least one of a composite slab panel, a composite wall panel, a composite roof slab, a slab-on-grade, or a suspended slab.

3. The composite panel of claim 1, wherein a density of the middle insulation layer is less than densities of the bottom concrete layer and the top concrete layer, wherein an R-value per unit length of the middle insulation layer is more than R-values per unit length of the bottom concrete layer and the top concrete layer, wherein a compressive strength of the middle insulation layer is less than compressive strengths of the bottom concrete layer and the top concrete layer.

4. The composite panel of claim 1, wherein the middle insulation layer is made of an insulation material, wherein a space between the plurality of bisected truss webs is filled with the insulation material of the middle insulation layer.

5. The composite panel of claim 4, wherein a composition of the insulation material includes cementitious material.

6. The composite panel of claim 5, wherein the insulation material includes one of a hemp-based insulation material, an aerated zero-slump concrete, a cellular concrete, a pervious concrete, or a Styrofoam aggregate concrete.

7. The composite panel of claim 1, wherein the middle insulation layer comprises at least one of pourable organic insulation, rigid foam insulation, blown-in insulation, or urethane insulation.

8. The composite panel of claim 1, wherein the plurality of top segments and the plurality of bottom segments comprise tension wires, wherein the tension wires do not carry compressive forces between the bottom concrete layer, the plurality of resin blocks, and the top concrete layer, wherein the compressive forces are transferred between the bottom concrete layer and the top concrete layer via the middle insulation layer.

9. The composite panel of claim 1, wherein the plurality of top segments and the plurality of bottom segments comprise rebar, wherein the rebar carries compressive forces between the bottom concrete layer, the plurality of resin blocks, and the top concrete layer.

10. The composite panel of claim 1, wherein at least one of the plurality of longitudinal reinforcement members, the plurality of top segments, or the plurality of bottom segments comprise rebar.

11. The composite panel of claim 10, wherein the rebar comprises one of steel rebar, fiberglass rebar, or basalt rebar.

12. The composite panel of claim 1, wherein the plurality of top segments and the plurality of bottom segments are coupled to the plurality of longitudinal reinforcement members disposed in respective of the top concrete layer and the bottom concrete layer by being welded to the plurality of longitudinal reinforcement members disposed in respective of the top concrete layer and the bottom concrete layer.

13. The composite panel of claim 1, wherein the plurality of top segments and the plurality of bottom segments are coupled to the plurality of longitudinal reinforcement members disposed in respective of the top concrete layer and the bottom concrete layer by embedding the plurality of top segments and the plurality of bottom segments in respective of the top concrete layer and the bottom concrete layer.

14. The composite panel of claim 1, wherein the plurality of trusses comprise a plurality of joints, wherein the plurality of top segments and the plurality of bottom segments are coupled to the plurality of longitudinal reinforcement members disposed in respective of the top concrete layer and the bottom concrete layer by the plurality of joints.

15. The composite panel of claim 14, wherein the plurality of joints extend into the middle insulation layer, wherein the plurality of bisected truss webs do not extend into the bottom concrete layer and the top concrete layer, wherein the plurality of bisected truss webs are coupled to the plurality of joints in the middle insulation layer, wherein a thermal conductivity of the plurality of joints is less than a thermal conductivity of the plurality of bisected truss webs.

16. The composite panel of claim 14, wherein the plurality of joints do not extend into the middle insulation layer, wherein the plurality of bisected truss webs extend into the bottom concrete layer and the top concrete layer, wherein the plurality of bisected truss webs are coupled to the plurality of joints in the bottom concrete layer and the top concrete layer, wherein a thermal conductivity of the plurality of bisected truss webs is less than a thermal conductivity of the plurality of joints.

17. The composite panel of claim 14, wherein the plurality of joints comprise double-ended hook joints.

18. The composite panel of claim 14, wherein the plurality of joints comprise lock joints, wherein the lock joints are locked to at least one of the plurality of longitudinal reinforcement members or the plurality of bisected truss webs.

19. The composite panel of claim 18, wherein the lock joints include truss lock joints, wherein the truss lock joints include a hook end and a hub end, wherein the hook end couples to the plurality of longitudinal reinforcement members, wherein the hub end couples to the plurality of bisected truss webs, wherein the truss lock joints are locked to the plurality of bisected truss webs.

20. The composite panel of claim 18, wherein the lock joints include hanger lock joints, wherein the hanger lock joints include a bracket and a hub, wherein the bracket includes a pair of plate portions and a bend portion, wherein the bend portion extends between the pair of plate portions, wherein the plurality of longitudinal reinforcement members are received by the bend portion between the pair of plate portions, wherein the pair of plate portions define a through hole, wherein the hub is disposed in the through hole, wherein the plurality of bisected truss webs are wound around the hub, wherein the hanger lock joints are locked to the plurality of bisected truss webs.

21. The composite panel of claim 20, wherein the lock joints include double-ended hook lock joints, wherein the double-ended hook lock joints are locked to the plurality of longitudinal reinforcement members.

22. The composite panel of claim 1, wherein a top surface of the bottom concrete layer and a bottom surface of the top concrete layer include ridge portions and ditch portions, wherein the ridge portions and the ditch portions extend along the longitudinal span of the composite panel, wherein the ditch portions connect between the ridge portions, wherein the bottom concrete layer and the top concrete layer are thicker along the ridge portions than along the ditch portions.

23. The composite panel of claim 1, wherein a top surface of the bottom concrete layer and a bottom surface of the top concrete layer are flat.

24. The composite panel of claim 1, wherein the middle insulation layer defines a void space, wherein the void space extends along the longitudinal span.

25. The composite panel of claim 1, comprising an embed plate and headed studs, wherein the embed plate and the headed studs are embedded in the top concrete layer.

26. The composite panel of claim 1, wherein thermal conductivities of the plurality of resin blocks is less than thermal conductivities of the plurality of top segments and less than thermal conductivities of the plurality of bottom segments.

27. The composite panel of claim 1, wherein the plurality of resin blocks comprise a resin material, wherein the resin material is a thermoset or thermoplastic resin.

28. The composite panel of claim 27, wherein the resin material comprises at least one of a vinyl ester resin, a polyester resin, a phenolic resin, a nylon resin, polypropylene, polyethylene, or thermoplastic polyurethane.

29. The composite panel of claim 27, wherein the plurality of resin blocks comprise fibers, wherein the fibers are disposed in the resin material and separate from the plurality of top segments and the plurality of bottom segments.

30. The composite panel of claim 29, wherein the fibers comprise at least one of glass fibers, carbon fibers, basalt fibers, aramid fibers, or organic fibers.

31. The composite panel of claim 1, wherein the plurality of top segments and the plurality of bottom segments comprise a plurality of end sections, wherein the plurality of top segments and the plurality of bottom segments couple with the plurality of resin blocks using the plurality of end sections.

32. The composite panel of claim 31, wherein the plurality of end sections comprise at least one of roughened end sections, hooked end sections, mushroom-headed end sections, offset-bent end sections, zigzag end sections, twisted end sections, C-shaped end sections, perforated end sections, T-shaped end sections, or barbed end sections.

33. The composite panel of claim 1, wherein the plurality of top segments and the plurality of bottom segments comprise a plurality of looped sections, wherein the plurality of top segments and the plurality of bottom segments couple with the plurality of resin blocks using the plurality of looped sections.

34. The composite panel of claim 33, wherein the plurality of looped sections bend back within the plurality of resin blocks, to extend from the plurality of resin blocks in a same direction in which the plurality of looped sections enter the plurality of resin blocks.

35. The composite panel of claim 33, wherein the plurality of top segments and the plurality of bottom segments comprise a plurality of tail sections, wherein the plurality of tail sections extend from opposing ends of the plurality of looped sections, wherein the plurality of tail sections are aligned with and attached to the plurality of longitudinal reinforcement members.

36. The composite panel of claim 1, wherein tensile strengths of the plurality of top segments and tensile strengths of the plurality of bottom segments are less than tensile strengths of the plurality of resin blocks, wherein compressive strengths of the plurality of top segments and compressive strengths of the plurality of bottom segments are less than compressive strengths of the plurality of resin blocks.

37. The composite panel of claim 1, wherein the plurality of top segments are embedded within the top concrete layer, wherein the plurality of bottom segments are embedded within the bottom concrete layer.

38. The composite panel of claim 37, wherein at least the plurality of top segments or the plurality of bottom segments are embedded within the middle insulation layer.

39. The composite panel of claim 1, wherein the plurality of trusses extend longitudinally from end-to-end of the composite panel.

40. The composite panel of claim 1, wherein the plurality of trusses cooperatively span longitudinally from end-to-end of the composite panel with a series of sections of the plurality of trusses abutting or nearly abutting each other along the longitudinal span.

41. The composite panel of claim 1, wherein a thickness of the middle insulation layer is between 15 cm and 106 cm.

42. The composite panel of claim 1, wherein the plurality of trusses are configured as one of a Howe truss, a Pratt truss, a Warren truss, a ladder truss, a Vierendeel truss, or a Mansard truss.

43. The composite panel of claim 42, wherein the plurality of trusses are configured as the Warren truss.

44. The composite panel of claim 42, wherein the plurality of trusses are configured as the ladder truss, wherein the top concrete layer is thicker than the bottom concrete layer.

45. The composite panel of claim 1, wherein the composite panel defines a void space, wherein the void space is defined between at least one of the bottom concrete layer and the middle insulation layer or between the middle insulation layer and the top concrete layer, wherein the plurality of trusses transversely couple between the bottom concrete layer and the top concrete layer through the void space and the middle insulation layer.

46. The composite panel of claim 45, wherein the composite panel comprises at least one of an electrical fixture, a plumbing fixture, or an air-handling fixture, wherein at least one of the electrical fixture, the plumbing fixture, or the air-handling fixture is disposed in the void space and affixed to at least one of the bottom concrete layer or the top concrete layer.

47. The composite panel of claim 1, wherein a top surface of the bottom concrete layer and a bottom surface of the top concrete layer are flat.

48. The composite panel of claim 1, wherein the plurality of trusses extend along the longitudinal span of the composite panel.

49. A system comprising:
a first composite panel and a second composite panel, wherein the first composite panel and the second composite panel comprise:
a bottom concrete layer;
a top concrete layer;
a middle insulation layer, wherein the middle insulation layer is disposed between the bottom concrete layer and the top concrete layer, wherein the bottom concrete layer, the middle insulation layer, and the top concrete layer extend along a longitudinal span; and
a plurality of trusses, wherein the plurality of trusses comprise:
a plurality of longitudinal reinforcement members, wherein the plurality of longitudinal reinforcement members are disposed in the bottom concrete layer and the top concrete layer; and
a plurality of bisected truss webs, wherein the plurality of bisected truss webs transversely extend between the bottom concrete layer and the top concrete layer, wherein the plurality of bisected truss webs comprise:
a plurality of top segments;
a plurality of bottom segments, wherein the plurality of top segments and the plurality of bottom segments couple to the plurality of longitudinal reinforcement members disposed in respective of the top concrete layer and the bottom concrete layer; and
a plurality of resin blocks, wherein the plurality of resin blocks are disposed in the middle insulation layer and couple the plurality of top segments and the plurality of bottom segments.

50. The system of claim 49, wherein the first composite panel is orthogonal to the second composite panel, wherein the first composite panel and the second composite panel include a mitered joint, wherein the middle insulation layer of the first composite panel abuts the middle insulation layer of the second composite panel.

51. The system of claim 49, wherein the first composite panel is coincident to the second composite panel, wherein the middle insulation layer of the first composite panel abuts the middle insulation layer of the second composite panel.

52. A truss for a composite panel, the truss comprising:
a first longitudinal reinforcement member;
a second longitudinal reinforcement member; and
a bisected truss web, wherein the bisected truss web transversely extend between the first longitudinal reinforcement member and the second longitudinal reinforcement member, wherein the bisected truss web comprises:
at least one top segment;
at least one bottom segment, wherein the at least one top segment and the at least one bottom segment couple to respective of the first longitudinal reinforcement member and the second longitudinal reinforcement member; and
a plurality of resin blocks, wherein the plurality of resin blocks couple the at least one top segment and the at least one bottom segment.

53. A method of manufacturing a composite panel, the method comprising:
forming a plurality of trusses by coupling a plurality of bisected truss webs and a plurality of longitudinal reinforcement members, wherein the plurality of trusses comprise:
the plurality of longitudinal reinforcement members; and
the plurality of bisected truss webs, wherein the plurality of bisected truss webs comprise:
a plurality of top segments;
a plurality of bottom segments; and
a plurality of resin blocks,
pouring and casting a top concrete layer in a first formwork to embed the plurality of top segments within the top concrete layer;
pouring and casting a middle insulation layer in the first formwork;
pouring a bottom concrete layer in a second formwork;
flipping over and placing the top concrete layer and the middle insulation layer over the second formwork to embed the plurality of bottom segments within the bottom concrete layer; and
casting the bottom concrete layer, wherein the composite panel comprises:
the bottom concrete layer;
the top concrete layer;
the middle insulation layer, wherein the middle insulation layer is disposed between the bottom concrete layer and the top concrete layer, wherein the bottom concrete layer, the middle insulation layer, and the top concrete layer extend along a longitudinal span of the composite panel; and
the plurality of trusses, wherein the plurality of longitudinal reinforcement members are disposed in the bottom concrete layer and the top concrete layer, wherein the plurality of bisected truss webs transversely extend between the bottom concrete layer and the top concrete layer, wherein the plurality of top segments and the plurality of bottom segments couple to the plurality of longitudinal reinforcement members disposed in respective of the top concrete layer and the bottom concrete layer, wherein the plurality of resin blocks are disposed in the middle insulation layer and couple the plurality of top segments and the plurality of bottom segments.
